(19) United States
(12) Patent Application Publication
(10) Pub. No.: US 2012/0237228 A1
(43) Pub. Date: Sep. 20, 2012

(54) IMAGE FORMING APPARATUS AND IMAGE FORMING METHOD

(76) Inventor: Hidetoshi KAMI, Shizuoka (JP)

(21) Appl. No.: 13/416,556

(22) Filed: Mar. 9, 2012

(30) Foreign Application Priority Data
Mar. 16, 2011 (JP) 2011-058214
Dec. 26, 2011 (JP) 2011-283157

(51) Int. Cl. G03G 15/02

(52) U.S. Cl. 399/31; 399/168

(57) ABSTRACT

An image forming apparatus having a rotatable image bearing member including an electroconductive substrate on which a photosensitive layer, a sub-surface layer, and a circulating surface layer are sequentially laminated, the image bearing member rotatably driven in a predetermined direction, a charger, an irradiator, a development device, a transfer device, a cleaner to clean the surface of the image bearing member after the toner image is transferred to the recording medium, and an applicator arranged downstream from the cleaner and upstream from the charger relative to the rotation driving direction of the image bearing member and in contact with the image bearing member, the applicator including a circulating material, an application brush, and an application blade to apply the circulating material to form the circulating surface layer.

### CROSS-REFERENCE TO RELATED APPLICATIONS

This patent application is based on and claims priority pursuant to 35 U.S.C. §119 to Japanese Patent Applications Nos. 2011-058214 and 2011-283157, filed on Mar. 16, 2011, and Dec. 26, 2011, respectively, the entire disclosures of which are hereby incorporated by reference herein.

### BACKGROUND OF THE INVENTION

1. Field of the Invention

The present invention relates to an image forming apparatus and an image forming method.

2. Description of the Related Art

Photoreceptors for use in photocopiers, laser printers, etc. typically contained inorganic compounds such as selenium, zinc oxide, and cadmium sulfide. However, organic photoconductors (OPC) are currently dominant because the organic photoconductors (photoreceptors) are more advantageous than such inorganic photoreceptors in terms of burden on the global environment, cost, and freedom of design. Currently, organic photoconductors account for close to 100% of all photoreceptor production. Increasing concern for protecting the global environment has of late led to increasing demand to switch organic photoreceptors from being consumables to being a constituent part of the machine.

A number of attempts have been made to manufacture longer-lasting organic image bearing members having good durability. For example, Japanese patent application publication no. 2000-66424 (JP-2000-66424-A) describes film forming of a cross-linked resin layer on the surface of an image bearing member (photoreceptor). JP-2000-171990-A describes film forming of a sol-gel cured layer on the surface of an image bearing member. The former has the advantage that cracking rarely occurs even when charge transport components are blended in the layer, thereby improving production yield.

Among these, using polymerizable acrylic resins is advantageous to produce durable image bearing members with good sensitivity. In this approach, in which a cross-linking structure is formed, since the film is formed by multiple chemical bonds, abrasion does not immediately occur even when some of the chemical bonds are severed under stress.

In recent years, pressure to regulate emissions of carbon dioxide in an effort to protect the global environment has grown. In this context, image bearing members have been required to become part of the machines in which they are installed, and furthermore, to be recyclable. Although image bearing members have until now been serving as mechanical parts, the working life including recycling of the image bearing members is not as long as the working life of the machines in which they are installed.

By forming a resin layer having a three-dimensional structure on the surface of an image bearing member, production of highly durable image bearing members becomes more practical. In addition, methods of applying a lubricant to the surface of an image bearing member are used in particular to improve the cleaning property of polymerized toner. In addition, by these methods, the image bearing member is protected from charging hazard, thereby prolonging the working life thereof.

However, although these technologies are used in combination, the image bearing members still need replacement before the image forming apparatus does. This is because the surface property of the image bearing member is altered, which leads to production of defective images and deterioration of cleaning performance.

Under these conditions, with regard to the whole life cycle of the image forming apparatus, from the discovery and exploitation of natural resources to disposal and recycling, nothing changes from the typical framework. As a result, image forming still requires a huge amount of energy and causes a massive amount of carbon dioxide emissions.

The mechanical strength of the image bearing members has almost reached its peak under the weight of cumulative technological advances. Therefore, usage technology is the key to stabilize the surface property of the image bearing member. Among such usage technology, application of a lubricant to the surface of an image bearing member is an extremely advantageous method. But control of the input (supply) and output (removal) of the lubricant is not satisfactory, resulting in the lubricant contaminating the area of the image bearing member in most cases. This is actually another factor leading to a prematurely shortened service life of the image forming apparatus.

### SUMMARY OF THE INVENTION

In view of the foregoing, the present invention provides an image forming apparatus including a rotatable image bearing member having an electroconductive substrate on which a photosensitive layer, a sub-surface layer, and a circulating surface layer are sequentially laminated, the image bearing member rotatably driven in a predetermined direction, a charger to charge the surface of the image bearing member, an irradiator to irradiate the surface of the image bearing member to form a latent electrostatic image thereon, a development device to develop the latent electrostatic image with a development agent containing toner to obtain a toner image, a transfer device to transfer the toner image from the image bearing member to a transfer medium, a cleaner to clean the surface of the image bearing member after the toner image is transferred to the recording medium, and an applicator arranged downstream from the cleaner and upstream from the charger relative to a rotation driving direction of the image bearing member and in contact with the image bearing member, the applicator comprising a circulating material, an application brush, and an application blade to apply the circulating material to form the circulating surface layer thereof, wherein the circulating surface layer of the circulating material has a mass layer thickness of from one molecule to less than three molecules with a film deficiency of the circulating material of less than 10%, and wherein the application amount of the circulating material by the applicator per cycle of image forming in the image forming apparatus is equal to or less than the removal amount of the circulating material removed from the surface of the image bearing member by the time the applicator begins to apply the circulating material in the following image forming.

It is preferred that, in the image forming apparatus mentioned above, the sub-surface layer of the image bearing member has no folding point in the bandwidth of from LLL to LHL and a folding point in the bandwidth of from LHL to HMH in the curve obtained by: (I) forming a single dimension data arrangement by measuring the sub-surface layer by a surface texture and contour measuring instrument; (II) conducting a wavelet conversion by multi-resolution analysis for the single dimension data arrangement to make separation into six frequency components from a high frequency component to a low frequency component; (III) thinning out the lowest frequency component among the six frequency components in such a manner that the number of a single dimension data arrangement for the lowest frequency component is reduced to 1/10 to 1/100 to obtain a single dimension data arrangement; (IV) furthermore conducting a wavelet conversion by multi-resolution analysis to make separation into additional six frequency components from the high frequency component to the low frequency component; and (V) linking logarithms of eleven arithmetical mean roughnesses of from WRa (LLL) to WRa (HHH) excluding WRa (HLL) of the frequency components obtained in (II) and (IV), and WRa (LLH) is less than 0.04 μm, and WRa (HLH) is less than 0.005 μm, where the arithmetical mean roughnesses of the frequency components are: WRa (HHH): Ra in the bandwidth having a cycle length of convexoconcave of from 0.3 μm to 3 μm, WRa (HHL): Ra in the bandwidth having a cycle length of convexoconcave of from 1 μm to 6 μm, WRa (HMH): Ra in the bandwidth having a cycle length of convexoconcave of from 2 μm to 13 μm, WRa (HML): Ra in the bandwidth having a cycle length of convexoconcave of from 4 μm to 25 μm, WRa (HLH): Ra in the bandwidth having a cycle length of convexoconcave of from 10 μm to 50 μm, WRa (HLL): Ra in the bandwidth having a cycle length of convexoconcave of from 24 μm to 99 μm, WRa (LHH): Ra in the bandwidth having a cycle length of convexoconcave of from 26 μm to 106 μm, WRa (LHL): Ra in the bandwidth having a cycle length of convexoconcave of from 53 μm to 183 μm, WRa (LMH): Ra in the bandwidth having a cycle length of convexoconcave of from 106 μm to 318 μm, WRa (LML): Ra in the bandwidth having a cycle length of convexoconcave of from 214 μm to 551 μm, WRa (LLH): Ra in the bandwidth having a cycle length of convexoconcave of from 431 μm to 954 μm, and WRa (LLL): Ra in the bandwidth having a cycle length of convexoconcave of from 867 μm to 1,654 μm.

It is still further preferred that, in the image forming apparatus mentioned above, the sub-surface layer contains a resin having a three dimensional cross-linking structure.

It is still further preferred that, in the image forming apparatus mentioned above, the sub-surface layer contains α-alumina having an average primary particle diameter of from 0.2 μm to 0.5 μm.

It is still further preferred that, in the image forming apparatus mentioned above, the circulating surface layer has a compound having a lamellar structure.

It is still further preferred that, in the image forming apparatus mentioned above, the circulating surface layer contains zinc stearate.

It is still further preferred that, in the image forming apparatus mentioned above, the mass layer thicknesses obtained when the circulating material is applied to the image bearing member 2,500 times and 25,000 times and the number of application times of the circulating material satisfy the following relationship 1:

τ=fα+β Relationship 1

where τ represents the mass layer thickness (nm) of the circulating material, α represents the number of application times of the circulating material, β is an arbitrary constant, and f is a proportionality factor of from −0.1 to 0.

As another aspect of the present invention, an image forming method is provided which includes charging the surface of an image bearing member including an electroconductive substrate on which a photosensitive layer, a sub-surface layer, and a circulating surface layer are sequentially laminated, irradiating the surface of the image bearing member with light to form a latent electrostatic image thereon, developing the latent electrostatic image with a development agent containing toner to obtain a toner image, transferring the toner image from the image bearing member to a transfer medium, cleaning the surface of the image bearing member after the toner image is transferred to the transfer medium, and applying a circulating material to the surface of the image bearing member after the step of cleaning and before the step of charging to form a circulating surface layer of the circulating material thereon having a mass layer thickness of from a thickness corresponding to one molecule to a thickness corresponding to less than three molecules with a film deficiency of the circulating material of less than 10%, using an applicator having g the circulating material, an application brush, and an application blade while in contact with the surface of the image bearing member, wherein the application amount of the circulating material per cycle of image forming in the image forming apparatus is equal to or less than the removal amount of the circulating material removed from the surface of the image bearing member by the time the applicator begins to apply the circulating material in the following image forming.

It is preferred that, in the image forming method mentioned above, the sub-surface layer of the image bearing member has no folding point in the bandwidth of from LLL to LHL and a folding point in the bandwidth of from LHL to HMH in the curve obtained by (I) forming a single dimension data arrangement by measuring the sub-surface layer by a surface texture and contour measuring instrument; (II) conducting a wavelet conversion by multi-resolution analysis for the single dimension data arrangement to make separation into six frequency components from the high frequency component to the low frequency component; (III) thinning out the lowest frequency component among the six frequency components in such a manner that the number of a single dimension data arrangement for the lowest frequency component is reduced to 1/10 to 1/100 to obtain a single dimension data arrangement; (IV) furthermore conducting a wavelet conversion by multi-resolution analysis to make separation into additional six frequency components from the high frequency component to the low frequency component; and (V) linking logarithms of eleven arithmetical mean roughnesses of from WRa (LLL) to WRa (HHH) excluding WRa (HLL) of the frequency components obtained in (II) and (IV), and WRa (LLH) is less than 0.04 μm, and WRa (HLH) is less than 0.005 μm, where the arithmetical mean roughnesses of the frequency components are: WRa (HHH): Ra in the bandwidth having a cycle length of convexoconcave of from 0.3 μm to 3 μm, WRa (HHL): Ra in the bandwidth having a cycle length of convexoconcave of from 1 μm to 6 μm, WRa (HMH): Ra in the bandwidth having a cycle length of convexoconcave of from 2 μm to 13 μm, WRa (HML): Ra in the bandwidth having a cycle length of convexoconcave of from 4 μm to 25 μm, WRa (HLH): Ra in the bandwidth having a cycle length of convexoconcave of from 10 μm to 50 μm, WRa (HLL): Ra in the bandwidth having a cycle length of convexoconcave of from 24 μm to 99 μm, WRa (LHH): Ra in the bandwidth having a cycle length of convexoconcave of from 26 μm to 106 μm, WRa (LHL): Ra in the bandwidth having a cycle length of convexoconcave of from 53 μm to 183 μm, WRa (LMH): Ra in the bandwidth having a cycle length of convexoconcave of from 106 μm to 318 μm, WRa (LML): Ra in the bandwidth having a cycle length of convexoconcave of from 214 μm to 551 μm, WRa (LLH): Ra in the bandwidth having a cycle length of convexoconcave of from 431 μm to 954 μm, and WRa (LLL): Ra in the bandwidth having a cycle length of convexoconcave of from 867 μm to 1,654 μm.

It is still further preferred that, in the image forming method mentioned above, the sub-surface layer contains a resin having a three dimensional cross-linking structure.

It is still further preferred that, in the image forming method mentioned above, the sub-surface layer contains α-alumina having an average primary particle diameter of from 0.2 μm to 0.5 μm.

It is still further preferred that, in the image forming method mentioned above, the circulating surface layer contains a compound having a lamellar structure.

It is still further preferred that, in the image forming method mentioned above, the circulating surface layer contains zinc stearate.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic cross section illustrating an example of an image forming apparatus according to the present disclosure;

FIG. 2 is a schematic cross section illustrating another example of the image forming apparatus according to the present disclosure;

FIG. 3 is a schematic cross section illustrating another example of the image forming apparatus according to the present disclosure;

FIG. 4 is a schematic cross section illustrating another example of the image forming apparatus according to the present disclosure;

FIG. 5 is a schematic cross section illustrating another example of the image forming apparatus according to the present disclosure;

FIG. 6 is a schematic cross section illustrating another example of the image forming apparatus according to the present disclosure;

FIG. 7 is a schematic cross section illustrating an example of the image forming apparatus for use in Comparative Example described later;

FIG. 8 is a schematic cross section illustrating another example of the image forming apparatus according to the present disclosure;

FIG. 9 is a schematic cross section illustrating a device supplying a circulating material to an image bearing member;

FIG. 10 is a cross section illustrating an example of the layer structure of the image bearing member of the present disclosure;

FIG. 11 is a cross section illustrating another example of the layer structure of the image bearing member of the present disclosure;

FIG. 12 is a diagram illustrating a surface roughness and contour form measuring system;

FIG. 13 is a diagram illustrating an example of the result of multi-resolution analysis by wavelet conversion;

FIG. 14 is a diagram illustrating separation of the bandwidth of the frequency by multi-resolution analysis for the first time;

FIG. 15 is a graph of the lowest frequency data in multi-resolution analysis for the first time;

FIG. 16 is a diagram illustrating separation of the bandwidth of the frequency by multi-resolution analysis for the second time;

FIG. 17 is a diagram illustrating an example of the roughness spectrum;

FIG. 18 is a diagram illustrating another example of the roughness spectrum;

FIG. 19 is a diagram illustrating another example of the roughness spectrum;

FIG. 20 is a diagram illustrating another example of the roughness spectrum;

FIG. 21 is a diagram illustrating another example of the roughness spectrum;

FIG. 22 is a diagram illustrating another example of the roughness spectrum;

FIG. 23 is a diagram illustrating another example of the roughness spectrum;

FIG. 24 is a diagram illustrating another example of the roughness spectrum;

FIG. 25 is a diagram illustrating another example of the roughness spectrum;

FIG. 26 is a diagram illustrating another example of the roughness spectrum;

FIG. 27 is a diagram illustrating an example of the folding point and the angle θ in the folding point in the roughness spectrum;

FIG. 28 is a diagram illustrating another example of the roughness spectrum;

FIG. 29 is a diagram illustrating another example of the roughness spectrum; and

FIG. 30 is a diagram illustrating another example of the roughness spectrum.

### DETAILED DESCRIPTION OF THE INVENTION

An image forming apparatus according to the present disclosure includes an image bearing member (photoreceptor) 11 rotationally driven in a predetermined direction, a charger 12 to charge the surface of the image bearing member 11, an irradiator 13 to form a latent electrostatic image by irradiating the image bearing member 11 with beams of light, a development device 14 to develop the latent electrostatic image with a development agent containing toner to form a toner image, a transfer device 16 to transfer the toner image from the image bearing member 11 to a transfer medium, a cleaner 17 to clean the surface of the image bearing member 11 after the toner image is transferred to the transfer medium, and an applicator 3 arranged in contact with the image bearing member 11 and downstream from the cleaner 17 and upstream from the charger 12 relative to the rotation direction of the image bearing member 11 to form a film of a circulating material 3A on the surface of the image bearing member 11.

The applicator 3 includes an application brush 3B and an application blade 3C. The film deficiency of the circulating material 3A on the image bearing member 11 is less than 10%. The film on the image bearing member 11 forms a circulating surface layer having a thickness of from one molecule to less than three molecules.

The application amount of the circulating material 3A by the applicator 3 in a single image forming cycle by the image forming apparatus is equal to or less than the amount of the circulating material 3A removed from the surface of the image bearing member 11 by the time just before the applicator 3 applies the circulating material 3A in the next image forming cycle.

The image forming apparatus according to the present disclosure is described with reference to the accompanying drawings. It is to be noted that the embodiments described below are preferred embodiments, and the present invention is not limited thereto unless otherwise described.

Typically, the image bearing member is frequently replaced as a consumable. However, in the present disclosure, since an applicator to coat the surface of the image bearing member with a film is built into the image forming apparatus, the image bearing member is not actually abraded, making frequent replacement unnecessary.

Thus, it is not necessary to newly manufacture or collect the image bearing member from the image forming apparatus in the present disclosure, which is extremely advantageous in terms of reducing the burden on the environment by conserving resources. Typically, the image bearing members are collected and thereafter recycled. This typical usage method is far below the embodiments of the present disclosure in terms of recycling cost per sheet.

The image forming by the image forming apparatus of the present disclosure includes a process of applying a material (hereinafter referred to as circulating material) to form a circulating surface layer on a sub-surface layer of the image bearing member in an amount equal to or less than the amount of the circulating material removed by cleaning by the cleaner by the time the next coating process is initiated.

This is a requisite to continue forming a circulating surface layer on the surface of the image bearing member. The mass balance of the circulating material in (supplied to) and out of (removed from) the image bearing member, etc. acquires equivalence by coating of the circulating material in proportion to the amount removed.

The circulating material is considered to be removed mainly by a cleaner. In addition, the contacts between the image bearing member and the development agent and between the image bearing member and the intermediate transfer belt also effect removal of the circulating material.

In the present disclosure, the removing process of the circulating material is conducted between successive applications of the circulating material, that is, from immediately after the circulating material is applied one time to immediately before the circulating material is applied the next time.

When more circulating material is applied after some circulating material is removed, the circulating material is immediately applied in the application process thereof even if the circulating material is completely removed from the surface of the image bearing member. Since the circulating material accumulates on the surface of the image bearing member until it is removed, the circulating material on the surface of the image bearing member is not completely depleted with repeated removal and reapplication of the circulating material.

To be specific, for example, if 10% of the circulating material is applied after 100% is removed, the state in which 10% of the circulating material is applied is kept until the next removal. Thereafter, after the circulating material is completely removed in the removal process, 10% of the circulating material is applied again. That is, in the present disclosure, the circulating material on the surface of the image bearing member is not completely depleted because of this repetitive process.

In the present disclosure the circulating surface layer is laminated on the surface of the image bearing member. By contrast, the typical system has no such design concept. In the typical system, the lubricant is just supplied to the image bearing member from outside to the surface of the image bearing member just to protect the surface of the image bearing member or lower the friction factor of the surface of the image bearing member to a predetermined level.

In the case in which the lubricant is supplied from outside to the surface of the image bearing member, it is observed that lubricant particles are attached to the surface of the image bearing member. Such lubricant particles cause contamination inside the device.

In the present disclosure, the amount of the circulating material removed by cleaning can be calculated from the concentration of the circulating material contained in the collected toner.

The concentration is monitored by Inductivity Coupled Plasma (ICP) analysis or X-ray Fluorescence (XRF) analysis as described in detail later. Thus, it is possible to achieve a balance between the amount of circulating material removed and the application amount thereof in the present disclosure by preliminarily calculating the disappearance speed (total amount of the consumption) of the circulating material.

Next, the method of determining an application amount of the circulating material that is equal to or less than the amount removed per cycle of image forming is described.

The consumption amount of the circulating material consumed during image formation is determined by multiplying the coating efficiency of the circulating material to the image bearing member by the compensation for the loss occurring in the image forming process.

The loss deriving from the image forming process is measured by collecting powder accumulating around the circulating material applicator, which is taken as the amount of the circulating material that is not applied to the surface of the image bearing member because the circulating material molded to powder by a brush falls and scatters. In addition, the component of the circulating material removed from the surface of the image bearing member is calculated from the collected amount of the circulating material remaining after the cleaner does its job, taken generally in the path to a waste toner bottle.

When toner is contained in the collected powder, the total amount thereof is obtained to analyze the concentration of the circulating material, thereby obtaining the mass of the circulating material removed from the surface of the image bearing member.

When there is a difference between the loss of the circulating material in the above-described process as against the total consumption amount, on the one hand, and the removal amount from the surface of the image bearing member on the other, the difference is regarded as the amount of the contamination of other modules and units such as the charger, etc.

The coating efficiency of the circulating material on the surface of the image bearing member is determined by how closely disposed are the image bearing member and an application blade or the like that applies the circulating material to the image bearing member. When the circulating material is thinly and uniformly applied to the surface of the image bearing member while covering the entire thereof by the application blade, the efficiency is not good if the application blade is so strongly pressed against the surface of the image bearing member that it completely dams the circulating material. In short, forming a suitable gap and preventing vibration of the application blade are requisites for good coating efficiency.

When the application of the circulating material onto the surface of the image bearing member is conducted in parallel to the image forming process with its many various disturbances, it is necessary to compensate for the loss ascribable to the process and the loss ascribable to contamination of the sub-surface layer on which the circulating surface layer is formed. The loss is calculated from the difference in the coating efficiency of the circulating material between when there is no disturbance and when there is any disturbance.

In the case of an image forming apparatus in which the circulating surface layer is formed, it is possible to identify the point where the circulating surface layer is made possible by evaluating the level of the film deficiency of the circulating material and the level of filming on the surface of the image bearing member by simply increasing and decreasing the consumption amount of the circulating material.

In the present disclosure, whether or not the conditions described above are satisfied can be determined from variations in the mass layer thickness of the circulating surface layer formed of the circulating material in the durability test.

So long as the supply amount of the circulating material supplied to the sub-surface layer of the image bearing member does not exceed the removal amount thereof, the circulating surface layer does not become thicker. For a fresh image bearing member, this determination can be made by comparing the thickness of the circulating surface layer at a relatively early stage with the mass layer thickness after the image bearing member that has been in use for a while.

In the present disclosure, as a specific method, it is assumed that the number of rotations of the image bearing member is equal to the number of applications of the circulating material, and the dependency of the mass layer thickness on the number of applications is evaluated by calculating the mass layer thickness of the applied circulating material after the image bearing member rotates 2,500 times and 25,000 times (the number of rotations of the drum when the image bearing member has a drum form) using ICP analysis or XRF analysis.

The number of rotations of the drum is calculated by dividing the total traveling distance of the image bearing member by the circumference of the drum.

The 2,500 rotations are used to eliminate non-repeatable erroneous readings for the mass layer thickness of the circulating material generated by using an extremely small number of rotations.

The 25,000 rotations are thought to be used a sufficient condition to evaluate variations in the mass layer thickness. The present disclosure is not limited to those numbers of rotations, and the number of rotations deviating from those numbers in some degree is within the scope of the present disclosure.

To stabilize the surface, a proportionality factor f of the mass layer thickness to the number of applications is preferably equal to or less than zero, and more preferable when satisfying the following relationship:

τ=fα+β Relationship 1

(−0.1≦f≦0)

τ=mass layer thickness (mm) of the circulating material

α: number of application (drum rotation number when an image bearing drum is used)

β: arbitrary constant

The upper limit of the proportionality factor f is required in order that the supplying amount of the circulating material to the surface of the image bearing member does not surpass the removal amount. The lower limit of the proportionality factor f is advantageous to secure the stability of the surface.

In the image forming apparatus of the present disclosure, the circulating material is coated on the sub-surface layer of the image bearing member. To secure forming a good film, the applied surface of the sub-surface layer is preferably clean and prevented from modification even when the image forming apparatus is used for an extended period of time.

To eliminate toner which contaminates the applied surface, it is suitable to arrange the applicator of the circulating surface layer downstream from the cleaner relative to the moving direction of the surface of the image bearing member.

Furthermore, with regard to the modification, it is particularly suitable to prevent deformation of the sub-surface layer which has an adverse impact on the fit-in between the image bearing member and the member that contacts the image bearing member.

To prevent the sub-surface layer from being directly exposed to charging hazard, it is suitable to arrange the applicator upstream from the charger relative to the moving direction of the surface of the image bearing member to suitably apply the circulating surface layer.

The uppermost surface layer of the image bearing member according to the present disclosure is the circulating surface layer and the film deficiency of the film is at least less than 10% and the mass layer thickness of the circulating surface layer is from one molecular to less than three molecules.

The mass layer thickness is calculated by the ICP analysis or a simple XRF analysis. ICP analysis is described in JP-2008-122870-A and in the XRF analysis, the attachment amount is calculated from the standard curve obtained by the ICP analysis result.

The mass layer thickness is calculated referring to a non-patent document (Fact of fluorescent X ray analysis, 154-161, authored by Izumi Nakai, published in 2005 by Asakura Publishing Co., Ltd.).

In addition, the deficiency of the circulating surface layer coated on the sub-surface layer of the image bearing member is calculated by subtracting the covering ratio from 100%. The covering ratio is obtained from XPS analysis based on the method described in JP-2008-122870-A mentioned above.

The mass layer thickness is determined as the length obtained by dividing the surface density (g/cm²) with the density (g/cm³) as described in the non-patent document mentioned above.

With regard to zinc stearate used in Examples described later, the number of accumulated molecules of zinc stearate having a molecule thickness of 5 nm is used to represent the mass layer thickness. This thickness is based on the paragraph [0021] of JP-2006-91047-A mentioned above.

The relationship between the removal amount of the circulating material and the attachment amount is disregarded only when the circulating material is provided to the surface of a fresh image bearing member. This is because the circulating material is not utterly applied if the application amount of the circulating material is equal to or less than the removal amount when the circulating material is not present at all on the surface of the image bearing member.

The state of providing the circulating material means the non-constant state in which the image bearing drum is installed on the image forming apparatus and adjusted to be ready for printing. To be specific, this means equal to or less than initial 1,000 printouts after a fresh image bearing member is installed on the image forming apparatus.

The circulating material is provided to the surface of the image bearing member by accumulating the circulating material on the surface of the image bearing member while the cleaning performance of the image forming apparatus is insufficient because the circulating material has not been sufficiently applied to the surface of the image bearing member yet or preliminarily applying setting powder, etc.

The circulating surface layer of the surface of the image bearing member is defined as described above. However, it is not easy to continue forming the circulating surface layer inside the image forming apparatus or during the image forming process.

This is because, in the image forming process, the physical property of the sub-surface layer of the image bearing member incessantly reflects and accumulates the history.

In the middle of the image forming process, toner is used to form images in addition to coating the sub-surface layer of the image bearing member with the circulating material.

When the circulating surface layer is coated at the same time images are formed, if coating of the circulating material is not sufficient, paper dust of toner components causes filming (having a rice-fish form, etc.) on the sub-surface layer of the image bearing member.

Such filming makes it more difficult to apply the circulating material every time the image forming cycle is repeated. In addition, if the circulating material does not sufficiently cover the surface of the image bearing member so that forming the film of the circulating material doe not catch up with the supply of the circulating material, the layer of the circulating material may become rough.

In addition, if the circulating material accumulates on or slips through a member that contacts the image bearing member, the surface of the image bearing member makes a state of attachment as if gravel were sprinkled. Consequently, the circulating material contaminates members (e.g., a charger, an irradiator, a developing device, and a transfer device) arranged around the image bearing member, resulting in a shorter working life.

Alternatively, the circulating material mingles into the developing device, thereby degrading charging of toner. These are problems when the image forming apparatus are used for an extended period of time.

Although such a rough surface is not completely unacceptable at all, the roughness standard to avoid such problems is that the area ratio of such a rough surface portion in an area of about 2 mm×about 2 mm is less than 0.05% and preferably less than 0.03% when the surface of the image bearing member is observed.

The area ratio of such a rough surface is calculated by using an image analysis software such as image J (manufactured by National Institutes of Health) and Image-Pro® Plus (manufactured by MediaCyabernetics, Inc.).

Currently, when a known lubricant is applied inside an image forming apparatus, the covering ratio of the lubricant is about 85% in most cases and the attachment amount thereof is from about two molecules to about four molecules. Although depending on print patterns, the rough surface is from about 0.1% to about 2.5%.

As a result, defect images are produced when the image forming apparatus is used for an extended period of time, thereby causing exchange of the image bearing member. Therefore, the circulating surface layer is not formed in fact.

To the contrary, in the present disclosure, the problem of the working life of the image bearing member shortened by filming or contamination on members is overcome and the working life length is toward endless.

In addition, a typical lubricant applicator can be used as the applicator of the circulating surface layer for use in the image forming apparatus of the present disclosure. Therefore, the image forming apparatus of the present disclosure is advantageous in terms of economy.

With regard to the image forming apparatus described above, to continue forming the circulating surface layer having a mass layer thickness of from one molecule to less than three molecules with a film deficiency of less than 10% by applying the circulating material to the sub-surface layer of the image bearing member in an application amount equal to or less than the amount of the circulating material removed until the end of cleaning by the cleaner, total application of the circulating material covering the entire of the sub-surface layer of the image bearing member is a key.

Improving the application capability requires control of the abrasion status between the image bearing member and the application blade. To be simple, a process to make these fitted in better is required.

According to the intensive study by the present inventors, it is found that the wearing-down of the application blade changes depending on the form of the sub-surface layer of the image bearing member when an image forming apparatus having the same configuration as the present disclosure is used to observe the portion of the application blade abraded by the image bearing member. The blade is observed from above the mirror surface of the blade in a viewing field of 180 μm×180 μm by a confocal microscope with a magnification power of 100.

In addition, the application blade is used in the trailing position against the image bearing member. The wearing-down of the application blade is measured for an area having a length of 180 μm and a width of 90 μm in the vertical direction from the edge of the cut surface of the application blade and calculated from the surface roughness Ra of the area and the average pitch Sm between the local peaks of the convexoconcave portions.

In an attempt to classify the degree of the wearing-down from mapping the sizes of Ra and Sm, it is found that the degree of the wearing-down (roughness) is small when the roughness about the low frequency component is small and the roughness about the middle-range frequency component is moderately high about the cross section curve of the sub-surface layer of the image bearing member. Furthermore, it is also found that the degree of the roughness of the circulating surface layer tends to increase as the degree of the roughness of the application blade increases after the long period of use.

The roughness of the application blade is observed by a confocal microscope (OPTELICS H-1200, manufactured by Lasertec Corporation) and its attached software (LMeye) to obtain the surface roughness Ra. The sample difference is obtained from 0.3 μm to 0.6 μm. In addition, with regard to the average pitch Sm between the local peaks, the sample difference obtained is from 2.5 μm to 5.5 μm. The wearing-down of the application blade after the long period of use is considered to be a record reflecting the degree of the fit-in between the application blade and the surface of the image bearing member.

In the present disclosure, the image bearing member includes an electroconductive substrate on which a photosensitive layer, the sub-surface layer, and the circulating surface layer are laminated in this order. The form of the sub-surface layer of the image bearing member which reduces the wearing-down of the application blade is measured by a surface texture and contour measuring instrument to form a single dimension data arrangement. The single dimension data arrangement is subjected to wavelet conversion by multi-resolution analysis to separate the results into six frequency components from the high frequency component to the low frequency component. Thereafter, among the obtained six frequency components, the single-dimension data arrangement for the lowest frequency component is thinned out to reduce the number of the single dimension data arrangement to 1/10 to 1/100 to obtain a single dimension data arrangement.

Furthermore, subsequent to another wavelet conversion by the multi-resolution analysis, the single dimension data arrangement is separated into additional six frequency components from the high frequency component to the low frequency component. The form has the following relationships: a curve (referred to as roughness spectrum for convenience) obtained by linking the logarithm values of the individual arithmetical mean roughness WRa (LLL) to WRa (HHH) for the total of 12 frequency components obtained as described above with a line from left to right at least has no folding point in the bandwidth of from LLL to LHL and a folding point in the band of from LHL to HMH, WRa (LLH) is less than 0.04 μm, and WRa (HLH) is less than 0.005 μm.

Based on the arithmetical mean roughness Ra, which is defined in JIS-B0601:2001, of the sub-surface layer of the image bearing member, the arithmetical mean roughnesses in the individual bandwidths separated into the frequency components with regard to the length of one cycle of the convexoconcave portions by the wavelet conversion are represented as follows:

WRa (HHH): Ra in the bandwidth having a cycle length of the convexoconcave of from 0.3 μm to 3 μm

WRa (HHL): Ra in the bandwidth having a cycle length of the convexoconcave of from 1 μm to 6 μm

WRa (HHL): Ra in the bandwidth having a cycle length of the convexoconcave of from 2 μm to 13 μm

WRa (HML): Ra in the bandwidth having a cycle length of the convexoconcave of from 4 μm to 25 μm

WRa (HLH): Ra in the bandwidth having a cycle length of the convexoconcave of from 10 μm to 50 μm

WRa (HLL): Ra in the bandwidth having a cycle length of the convexoconcave of from 24 μm to 99 μm

WRa (LHH): Ra in the bandwidth having a cycle length of the convexoconcave of from 26 μm to 106 μm

WRa (LHL): Ra in the bandwidth having a cycle length of the convexoconcave of from 53 μm to 183 μm

WRa (LMH): Ra in the bandwidth having a cycle length of the convexoconcave of from 106 μm to 318 μm

WRa (LML): Ra in the bandwidth having a cycle length of the convexoconcave of from 214 μm to 551 μm

WRa (LLH): Ra in the bandwidth having a cycle length of the convexoconcave of from 431 μm to 954 μm

WRa (LLL): Ra in the bandwidth having a cycle length of the convexoconcave of from 867 μm to 1,654 μm

In addition, the folding point is a point where the curvature suddenly changes in the surface roughness spectrum.

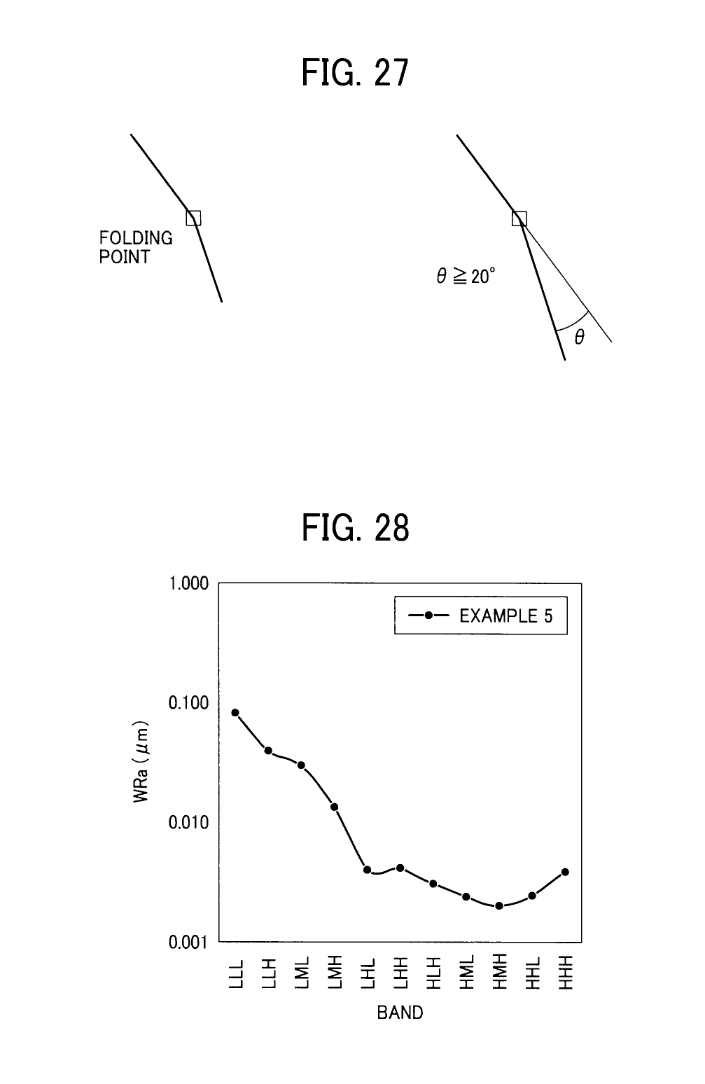

As illustrated in FIG. 27, the point where the curvature suddenly changes is that, in the surface roughness spectrum in the scale of X axis and Y axis in the roughness spectrum, the point has a convex angle θ the apex of which is 20° or greater while a straight line (no apex) is defined to be 0°.

When the form of the sub-surface layer of the image bearing member satisfies the relationships described above, the form has a property in which the circulating material is efficiently applied. The mechanism of this is not clear yet but can be deduced as follows:

When the circulating material is applied to the sub-surface layer of the image bearing member by the application blade to form a circulating surface layer, application is not possible if the application blade dams the circulating material completely. To form a film having a moderate thickness of the circulating material, it is necessary to form a dynamic gap between the application blade and the sub-surface layer to make the circulating material slip through the application blade.

For example, when the circulating material is applied by bringing the application blade made of rubber plate into contact with the image bearing member, the application blade dams the circulating material as described above if the application blade is brought into contact with the image bearing member like a typical cleaning blade, resulting in failure of application.

To apply the circulating material to the surface of the image bearing member, just controlling the contact state between the surface of the image bearing member and the application blade is insufficient to form the dynamic gap. Controlling the abrasion state between the image bearing member and the application blade is also required in addition to controlling the contact state.

The contact state means how the application blade is in contact with the surface of the image bearing member and the abrasion state is how the application blade rubs the surface of the image bearing member.

The conditions under which a uniform film is made by a typical doctor blade are: the gap between a blade to form a wet film having a uniform thickness and the coated surface is constant; the blade is free from vibration; the application speed is constant; the coated surface is clean; and the paint (liquid application) is uniform. The same applies to the film-forming of the circulating material. Making the surface of the image bearing member coarse as described above is considered good for coating. That the application blade is made of rubber also has some good impact.

By making a sub-surface layer of the image bearing member having the form described above, the application property of the circulating material is drastically improved. In addition, by coating the surface of the image bearing member with the circulating material in an amount equal to or less than the amount thereof removed until the end of cleaning by the cleaner, forming a circulating surface layer having a mass layer thickness of from one molecule to less than three molecules with a film deficiency of less than 10% is made possible.

Furthermore, since the circulating material is efficiently applied, the consumption amount of the circulating material is reduced.

To make it possible to have a circulating surface layer as the uppermost layer of the image bearing member installed in the image forming apparatus, it is preferable to use a circulating material which is easily removed from and applied to the sub-surface layer of the image bearing member.

To sustain the circulating surface layer, it is particularly preferable to make the material amount applied to the image bearing member in one cycle equal to the material amount removed therefrom by cleaning.

In addition, it is preferable that the consumption rate of the circulating material is not excessively high. The consumption rate is defined as the input amount (mg/km) of the circulating material against the traveling distance of the image bearing member during image forming process.

Considering the above-mentioned conditions, wax or metal salts of higher aliphatic acid is preferable as the circulating material. Specific examples of the wax include, but are not limited to, plant waxes such as sumac wax, Urushi wax, palm wax, and carnauba wax, animal waxes such as bees wax, spermaceti, Ibota wax, and wool wax, and mineral waxes such as montan wax and paraffin wax.

Most of known generally-used metal salts of higher aliphatic acid are preferable in terms of the properties of the material. A typical compound thereof is zinc stearate, which can take a lamellar structure.

In the lamellar structure, layers in which molecules are regularly folded are laminated and arranged.

In the laminate structure of the lamellar structure, amphiphilic molecules are self-organized so that the crystal is broken up and peeled off along the interface of the layers upon application of a shearing force. This is advantageous to make it possible to circulate the circulating material.

According to the characteristics of the lamellar structure of zinc stearate that uniformly covers the surface of the image bearing member upon application of a shearing force, the surface of the image bearing member is effectively covered by a small amount of the circulating material.

When the circulating material is applied by this method, there are methods of controlling the application state of the circulating material. For example, increasing the contact pressure between a solid circulating material and the application brush or controlling the rotation speed of the application brush is thinkable. Moreover, the number of rotations of the application brush can be controlled depending on the image forming information.

Wax and metal salts of higher aliphatic acid can be used alone or as a binder mixture with other functional materials such as charge transport materials and anti-oxidants.

Since a material which is easily applied to form a film and removed in an image forming apparatus is identified by using such a circulating material, the equivalence of the material amount is easily obtained during the repeated application and removal process of the circulating material. Therefore, the circulating material is applied and removed by a simple module (unit).

In addition, the circulating surface layer can be formed for an extended period of time. Furthermore, the combinational use of the circulating material and the form of the sub-surface layer described above extremely improves the covering capability per image forming cycle, thereby reducing the consumption rate of the circulating material.

Preferred specific examples of the circulating material in the present disclosure include, but are not limited to, metal salts of higher aliphatic acids containing at least one aliphatic acid such as stearic acid, palmitic acid, myristic acid, and oleic acid and at least one metal such as zinc, aluminum, calcium, magnesium, and lithium.

Since zinc stearate is produced at an industry level and used in many fields, zinc stearate is most preferable in terms of cost, quality, stability, and reliability.

In addition, accumulated rich technologies for efficient application of lubricants are easily applied to zinc stearate.

Higher aliphatic acid metal salts generally used in the industry is not necessarily limited to only the single composition represented by the name of the compound. Other similar aliphatic acid metal salts, metal oxides, and isolated aliphatic acid are also included and the metal salts of higher aliphatic acids of the present disclosure follow this practice.

Using such a circulating material, the circulating surface layer is reliably formed with low cost.

In addition, devices to which the accumulated application technology about application of lubricants is easily applied can be conveniently developed.

The application property of the circulating material is drastically improved by the form of the sub-surface layer of the image bearing member described above. To sustain the improved property, it is advantageous to improve the strength of the form of the sub-surface layer. When image bearing member is abraded during the image forming process, the form of the surface thereof changes accordingly. Such a change is seen by the change in the surface roughness. The present inventors confirmed that the surface roughness tended to increase as the abrasion of the image bearing member advanced.

First, film forming by a wet process is suitable to make the form described above. Since the form of the surface is controlled in the magnitude of from micron to mm in the wet process, it is advantageous over mechanical processing in terms of technology and cost. With regard to the viscosity of the paint (liquid application) in the film forming in the wet process, the range of the form control is wide when the viscosity of the liquid application is low. To be specific, the range of from about 0.9 mPa·s to about 10 mPa·s is suitable. The allowable lowest limit of the viscosity of the liquid application is determined by the value asymptotic to the solvent viscosity and the allowable highest limit is determined in terms of the form control. To secure a sub-surface layer having a practically sufficient strength after the film is formed with a liquid application having a low viscosity, it is good to select a reactive-type resin monomer employing a three-dimensional cross-linking structure as the main component of the liquid application.

By using a resin having a three dimensional cross-linking structure for the sub-surface layer of the image bearing member, the sub-surface layer has an excellent abrasion resistance. The mechanism of this is deduced that if part of the chemical bonding forming the resin form is severed but the chemical bonding at other portions still remains, the image bearing member is not directly abraded.

The excellent abrasion resistance directly contributes to the stability of the surface form. As a result, when a resin having a three dimensional cross-linking structure is used for the sub-surface layer, the application property of the circulating material is stabilized.

Among the resins having a three dimensional cross-linking structure, acrylic resins are preferable in terms that the impact on the electrostatic property due to the rough form is small because acrylic resins have a relatively large dielectric constant in comparison with a solid solution of polycarbonates and charge transport materials.

As described above, by using a resin having a three dimensional cross-linking structure in the sub-surface layer, forming the sub-surface layer of the circulating surface layer is made easy, thereby easily improving the application property of the circulating material. In addition, the change in the form of the sub-surface layer is reduced and the application property of the circulating material is stabilized.

When forming the sub-surface layer, the surface is roughened by adding fillers to a liquid application having a relatively low viscosity. Surfaces have a variety of rough forms by controlling the agglomeration state of the filler. Technologies of using a resin having a three dimensional cross-linking structure at the uppermost surface layer of an image bearing member with fillers blended are already known. However, these mainly focus on improving the mechanical strength of the image bearing member in most cases and technologies using filler dispersants in combination are hardly seen.

Furthermore, controlling the surface form of the image bearing member by changing the agglomeration state of the filler by a dispersant is a new concept.

Among the fillers, it is preferable to use metal oxide fillers having a primary average particle diameter in the magnitude of nano meter. Specific examples thereof include, but are not limited to, α-alumina, tin oxide, titania, silica, and ceria.

There are fillers of organic particulates and inorganic particulates which are not easily dispersed and have a surface roughness in the order of micron or higher or prickles, thereby damaging the blade of the application blade and the cleaning blade. The metal oxide fillers are free of such concerns in most cases.

Similarly, the content of the metal oxide is preferably from 1% by weight to 20% by weight of the sub-surface layer. The allowable lowest and highest limits of the content of the metal oxide are determined by the difficulty of controlling the form of the sub-surface layer.

In addition, by using the metal oxide in combination, the mechanical strength is also improved in the present disclosure.

The dispersant of an ester of phosphoric acid improves the stability of the dispersed filler in the liquid application, reduces the size of the filler, and imparts the affinity with the binder resin.

The size reduction of the filler and the affinity to the binder resin are arbitrarily controlled as factors to control the form of the sub-surface layer. For this control, the acid value and the amino value of the dispersant are suitably selected according to the acidity and the basicity of the filler or among the components of the dispersant, components having a high compatibility with the binder resin in the filler are selected. In addition, selecting a filler having a dispersion property stable in the liquid application is preferable when manufacturing an image bearing member. This is achieved by selecting fillers having functional groups adsorbed with fillers or components having a high compatibility with a solvent. The allowable upper limit of the content of the dispersant is normally set to be from 1% by weight to 2% by weight based on the total of the solid portion of the sub-surface layer considering the impact on the electrostatic property of the image bearing member.

As described above, by containing a dispersant of an ester of phosphoric acid and a metal oxide filler, the sub-surface layer of the circulating surface layer is easily formed. The application property of the circulating material is easily improved. In addition, the abrasion resistance of the sub-surface layer is also easily improved.

If the circulating material is not sufficiently applied, it is anticipated that paper dust and toner components are attached to the sub-surface layer of the image bearing member, which may cause filming such as a rice-fish form filming.

If such filming happens, the wettability of the sub-surface layer is modified, which may break up the circulation process of the circulating material. Addition of α-alumina particulates having a spherical form to the sub-surface layer of the image bearing member is good to greatly reduce this filming, which is experimentally confirmed.

The mechanism of this is not clear yet but is deduced as follows: α-alumina has a high hardness, which is a protection from the damage to the sub-surface layer, resulting in reduction of the chance of filming; or even if the circulating material is short, the convexoconcave surface of α-alumina has some effect of stably keeping the abrasion status between the image bearing member and the application blade or the cleaning blade.

In many cases of α-alumina particulates having a spherical form, the filler particle diameter thereof is from 0.01 μm to 2 μm and preferably from 0.03 μm to 1.5 μm. In this range, since extreme convexoconcave forms such as prickles are not easily formed when forming the layer, the form conforming to the conditions (roughness spectrum, etc.) described above is easily made.

As described above, by containing α-alumina particulates having a particle diameter of from 0.01 μm to 2 μm, modification of the surface of the image bearing member is prevented. Therefore, the image bearing member having the circulating surface layer as the uppermost surface layer is stabilized. The average primary particle diameter of α-alumina is particularly preferably from 0.2 μm to 0.5 μm.

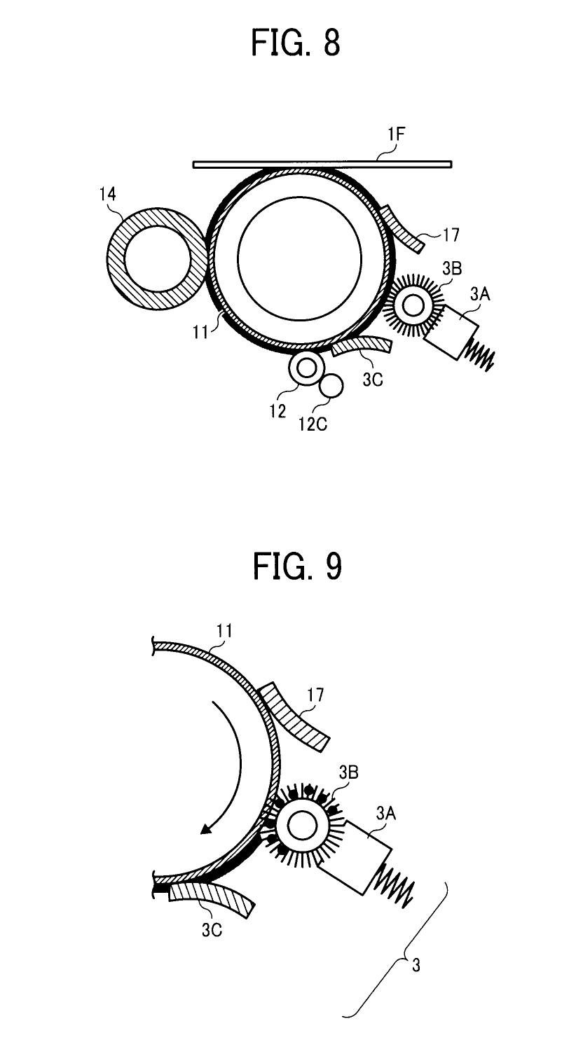

An example of the image forming apparatus using the circulating material is described with reference to FIG. 8. In the device illustrated in FIG. 8, the circulating material 3A is supplied to the surface of the image bearing member 11 by the application brush 3B, regulated by the application blade 3C, removed by the cleaning blade 17, and returned to the application brush 3B. Toner is also input to and output from the surface of the image bearing member 11. Therefore, the circulating material is mixed with the toner thereon.

The charger 12 has a charger cleaner 12C provided in contact with the charger 12 to clean the charger 12.

In the present disclosure, as illustrated in FIG. 7, a system without using an intermediate transfer body is also suitable, in which images are directly transferred from the surface of the image bearing member 11 to a transfer medium by the transfer device 16.

In addition, in the present disclosure, properties such as the attachability of the circulating material when it is supplied (input) to the surface of the image bearing member, the smooth spreading of the circulating material, and the timely removal property of the circulating material discharged outside the image bearing member system are improved to improve the circulation efficiency of the circulating material. For the smooth spreading, the application blade to spread the circulating material is used in most cases.

With regard to the discharging of the circulating material, the cleaning blade is in charge in most cases. Each blade is required to stabilize the abrasion state between the image bearing member and each blade.

For the roughness spectrum described above, the form of the sub-surface layer of the image bearing member which stabilizes the abrasion state of the application blade preferably has at least no folding point in the bandwidth of from LLL to LHL, a folding point in the bandwidth of from LHL to HMH, a WRa (LLH) of less than 0.04 μm, and a WRa (LLH) of less than 0.005 μm to reduce the roughness the blade.

When using a cross-linked resin having an excellent abrasion resistance as the material for the sub-surface layer, the obtained sub-surface layer has an excellent abrasion resistance.

The sustainability of the form of the surface is obtained accordingly. This is because if part of the chemical bonding forming the resin film is severed but the chemical bonding at other portions still remains, the image bearing member is not directly abraded.

Among the resins having a cross-linking structure, acrylic resins are preferable in terms that the impact on the electrostatic property due to the rough form is small because acrylic resins have a relatively large dielectric constant in comparison with a solid solution of polycarbonates and charge transport materials.

It is possible to form a surface having minute convexoconcave portions by adding fillers to the surface layer.

Accordingly, the circulation efficiency of the circulating material is improved. By blending the filler, a soft-feel texture (film) is formed on the surface of the image bearing member. In addition, by blending the filler, the abrasion resistance is further improved, which is furthermore advantageous to the sustainability of the form of the surface. The filler to be blended preferably has an average primary particle diameter in the magnitude of nano scale and is preferably alumina, tin oxide, titania, silica, and ceria.

In particular, α-alumina having a particle diameter of from 0.2 μm to 0.5 μm is preferable.

The filler prevents the surface of the image bearing member from becoming prickly, thereby reducing the damage to members abrading with the image bearing member.

With regard to the image forming apparatus in which the circulating material is supplied to the surface of the image bearing member, it is advantageous to provide a mechanism to scrape the circulating material with a brush and supply (input) the scraped circulating material to the surface of the image bearing member because not only the consumption amount of the circulating material is easily controlled but also the circulating material is supplied to all over the surface of the image bearing member. Furthermore, in addition to the cleaning blade, by providing the application blade downstream from the brush mentioned above and upstream from the cleaning blade relative to the rotation direction of the image bearing member, it is possible to regulate the amount of the circulating material to be supplied to the surface of the image bearing member and promote smooth spreading of the circulating material. These brushes and the application blade are suitable to adjust the circulation of the circulating material. In addition, the application brush is a brush or a sponge roller that is equal to the brush in terms of function.

Next, the multi-resolution analysis of the profile curve of the image bearing member is described.

In the present disclosure, the profile curve defined in JIS B0601 of the surface state of the parts of an image forming apparatus is obtained to obtain a single dimensional data arrangement as the profile curve.

The single dimensional data arrangement as the profile curve can be obtained as digital signals from the surface texture and contour measuring instrument or by A/D converting the analogue outputs from the surface texture and contour measuring instrument.

In the present disclosure, the measuring length of the profile curve to obtain the single dimensional data arrangement is preferably the measuring length defined in JIS and is preferably from 8 mm to 25 mm.

The sampling interval is not greater than 1 μm and preferably from 0.2 μm to 0.5 μm. For example, when the measuring length of 12 mm is measured by the number of samplings of 30,720, the sampling interval is 0.390625 μm, which is suitable to enable the present disclosure.

As described above, this single dimensional data arrangement is subjected to multi-resolution analysis by wavelet conversion (MRA-1) to separate the single dimensional data arrangement into multiple frequency components {e.g., six components of (HHH), (HHL), (HMH), (HML), (HLH), and (HLL)} from the high frequency component (HHH) to the low frequency component (HLL).

Furthermore, a single dimensional data arrangement is obtained by thining-out the obtained lowest frequency component (HLL) and subjected to multi-resolution analysis by wavelet conversion (MRA-2) to separate the single dimensional data arrangement into multiple frequency components {e.g., six components of (LHH), (LHL), (LMH), (LML), (LLH), and (LLL)}. Arithmetical mean roughness is obtained for the thus-obtained 12 frequency components and referred to as WRa. In this specification to distinguish it from the typical Ra.

In the present disclosure, as described above, there is at least a folding point (shoulder) or a local maximum value between WRa (LML) and WRa (LHH).

The arithmetical mean roughness WRa of each frequency component is an arithmetical mean roughness of the single dimensional data arrangement obtained by the multi-resolution analyses (MRA-1) and (MRA-2) described above of separating the single dimensional data arrangement obtained by measuring the convexoconcave form of the surface of the image bearing member by the surface texture and contour measuring instrument into frequency components from the high frequency component to the low frequency component by wavelet conversion.

In the present disclosure, the wavelet conversion in the present disclosure is conducted by using a software product of MATLAB. Since the definition of the bandwidth is a constraint from a software point of view, there is no special meaning for these ranges. In addition, WRa is limited by the definition of the bandwidth described above so that the coefficient changes accordingly as the bandwidth changes.

Individual bandwidths of HML components and HLH components, LHL components and LMH components, LMH components and LML components, LML components and LLH components, and LLH components and LLL components are overlapped. The reason of this overlapping is as follows.

In the wavelet conversion, original signals are decomposed into L (Low-pass components) and H (High-pass components) by the first wavelet conversion (Level 1) and L is further decomposed into LL and HL by wavelet conversion. If the frequency component f contained in the original signal matches the frequency F to be separated, f is a border of the separation so that it is separated into both L and H.

This is inevitable in the multi-resolution analysis. Therefore, it is suitable to set the frequency contained in the original signal so as not for the target frequency bandwidth to be separated at the wavelet conversion as described above.

### Wavelet Conversion (Multi-Resolution Analysis), Symbols of Each Frequency

In the present disclosure, the wavelet conversion is conducted twice. The first wavelet conversion is referred to as wavelet conversion (MRA-1) and the second wavelet conversion is referred to as wavelet conversion (MRA-2). To separate the first conversion from the second conversion, H (first time) or L (second time) is put in front of the abbreviation of each frequency bandwidth for convenience.

Various kinds of wavelet functions can be used as the mother wavelet function for use in the first and the second wavelet conversion. Specific examples thereof include, but are not limited to, Daubecies function, haar function, Meyer function, Symlet function, and Coiflet function. In the present disclosure, haar function is used but the present invention is not limited thereto.

In addition, when multi-resolution analysis is conducted to separate the data arrangement into multiple frequency components from the high frequency component to the low frequency component by wavelet conversion, the number of the components is preferably from 4 to 8 and more preferably 6.

In the present disclosure, by the first wavelet conversion, after separation into the multiple frequency components, the thus-obtained lowest frequency component is thinned out and taken out (sampling) to make a single dimensional data arrangement reflecting the lowest frequency component. The single dimensional data arrangement is subjected to the second wavelet conversion and thereafter, multi-resolution analysis is conducted to separate into the multiple frequency components from the high frequency component to the low frequency component.

In the thinning-out for the lowest frequency component (HLL) obtained from the first wavelet conversion (MRA-1), the number of data arrangement is reduced to 1/10 to 1/100.

By the thinning-out of the data, the frequency of the data is raised (widening the logarithm scale width of X axis). For example, if the number of the arrangement of the single dimensional arrangement obtained from the first wavelet conversion result is 30,000, the number of arrangement becomes 3,000 after 1/10 thinning-out.

If this thinning-out level is excessively small, for example, ⅕, the degree of raising the data frequency is not sufficiently high. The data are not separated well even after multi-resolution analysis by the second wavelet conversion.

If the thinning-out level is excessively large, for example, 1/200, the frequency of the data becomes too high, the data are too concentrated into the high frequency components to be separated even after multi-resolution analysis by the second wavelet conversion.

In the way of thinning data, for example, the thinning-out degree is 1/100, the average of 100 data are obtained, which is the point set as the single representative point.

FIG. 12 is a diagram illustrating an example of the configuration of a surface roughness evaluation device of the image bearing member, which is applied to the present disclosure. In FIG. 12, 41 represents an image bearing member, 42 represents a jig to which a probe is attached to measure the surface roughness, 43 represents a mechanism to move the jig 42 along the measuring target, 44 represents a surface texture and contour measuring instrument, and 45 represents a home computer to analyze signals. In FIG. 12, the home computer 45 calculates the multi-resolution analysis described above. If the image bearing member takes a cylinder form, the surface roughness of the image bearing member is measured along any suitable direction, for example, the circumference direction and the longitudinal direction.

FIG. 12 is just an example for the illustration purpose only and any suitable configuration can be employed in the present disclosure. For example, a dedicated numerical calculation processor can be used for the multi-resolution analysis instead of using the home computer. Moreover, this processing can be conducted by the surface texture and contour measuring instrument itself The result is shown by any suitable method, for example, displayed on a CRT or a liquid display, or printing. In addition, the result can be transmitted as electric signals to another device or stored in a USB memory or a MO disk.

In the measurement, the present inventors use the following devices:

Surface roughness/contour form measuring device: Surfcom 1400 (manufactured by Tokyo Seimitsu Co., Ltd.)

Home computer: home computer manufactured by International Business Machines Corp.

Cable to link Surfcom 1400 and the home computer of IBM: RS-232-C cable

Processing of the surface roughness data transmitted from Surfcom 1400 to the home computer and its multi-resolution analysis calculation are conducted by a software made by the present inventors, etc. based on C language.

Next, the procedure of the multi-resolution analysis for the surface form of the surface of the image bearing member is described with reference to specific examples.

First, the surface form of the image bearing member is measured by Surfcom 1400 (manufactured by Tokyo Seimitsu Co., Ltd.).

Each of the measuring length is 12 mm and the total number of samplings is 30,720. Four points are measured once. The measuring results are taken in the home computer and subjected to the first time wavelet conversion, thinning-out processing of 1/40 for the obtained lowest frequency component, and the second wavelet conversion using the program made by the present inventors, etc.

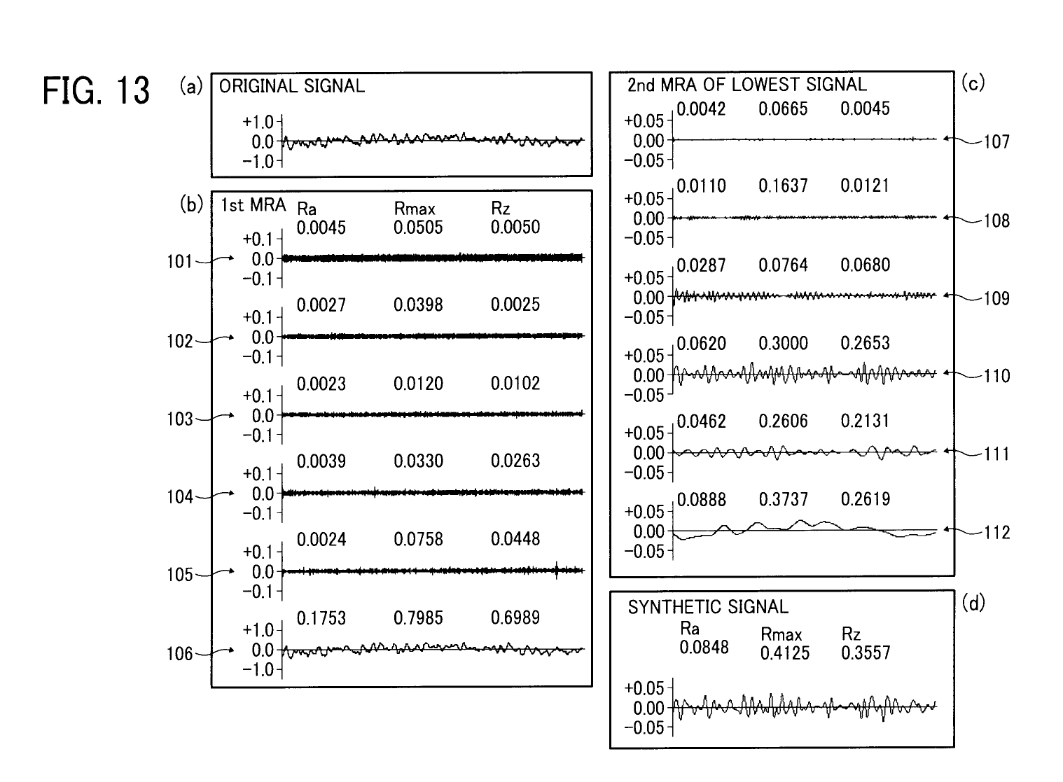

To the results of the multi-resolution analysis for the first time and the second time, the arithmetical mean roughness WRa, the maximum height Rmax, and the ten point height of irregularities Rz are obtained. An example of the calculation results is shown in FIG. 13.

The graph of (a) in FIG. 13 is formed by using the original data obtained by measuring the surface form by Surfcom 1400 and is also referred to as a roughness curve or a profile curve.

There are 14 graphs in FIG. 13 with a Y axis representing the displacement of the surface form with a unit of μm. The X axis represents the length with a measuring length of 12 mm without a scale.

In the typical surface roughness measuring, the arithmetical mean roughness Ra, the maximum height Rmax, Rz, etc. are obtained from (a) of FIG. 13.

In addition, the six graphs in (b) of FIG. 13 are the results of the first multi-resolution analysis (MRA-1). The graph situated at the top is the graph of the highest frequency components (HHH) and the graph situated at the bottom is the graph of the lowest frequency components (HLL).

In (b) of FIG. 13, the graph 101 situated at the top is the highest frequency component of the results of the first multi-resolution analysis and is referred to as HHH in the present disclosure.

In (b) of FIG. 13, the graph 102 is the frequency one below the highest frequency component of the results of the first multi-resolution analysis and is referred to as HHL in the present disclosure.

In (b) of FIG. 13, the graph 103 is the frequency two below the highest frequency component of the results of the first multi-resolution analysis and is referred to as HMH in the present disclosure.

In (b) of FIG. 13, the graph 104 is the frequency three below the highest frequency component of the results of the first multi-resolution analysis and is referred to as HML in the present disclosure.

In (b) of FIG. 13, the graph 105 is the frequency four below the highest frequency component of the results of the first multi-resolution analysis and is referred to as HLH in the present disclosure.

In (b) of FIG. 13, the graph 106 is the lowest frequency component of the results of the first multi-resolution analysis and is referred to as HLL in the present disclosure.

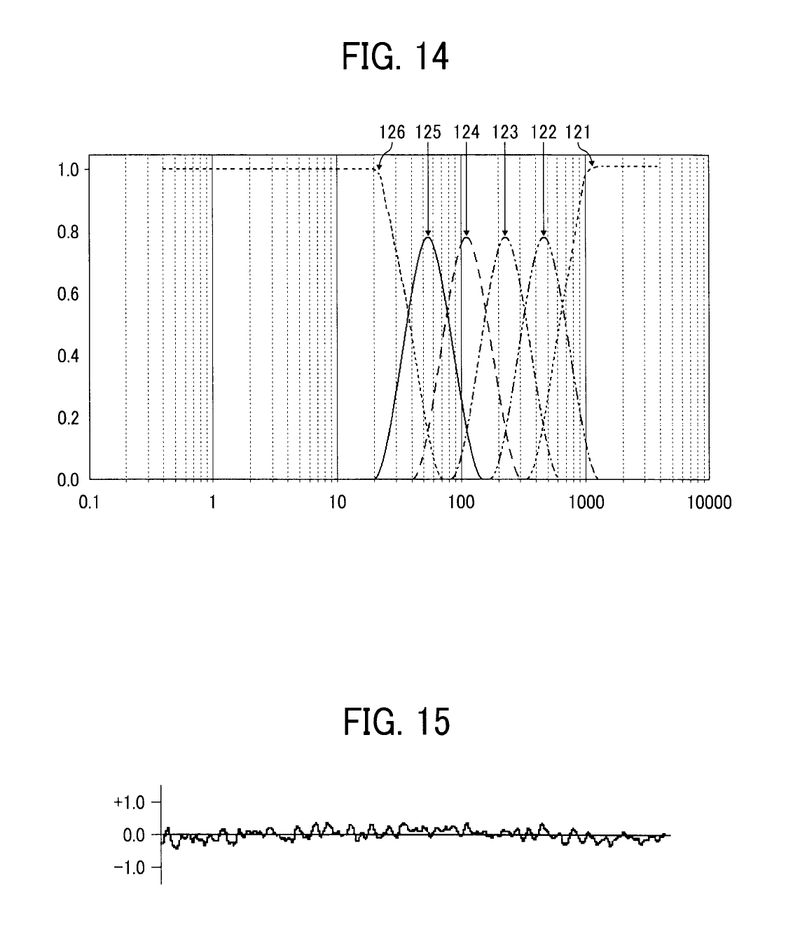

In the present invention, the graph of (a) in FIG. 13 is separated into the six graphs of (b) of FIG. 13 based on the frequency. The state of the frequency separation is illustrated in FIG. 14.

In FIG. 14, the X axis is the number of the convexoconcave portions per mm when the form of the convexoconcave portions is regarded as sine waves. In addition, the Y axis indicates the ratio when separated into each bandwidth.

In FIG. 14, 121 represents the bandwidth of the highest frequency component (HHH) in the first multi-resolution analysis (MRA-1), 122 is the bandwidth of one below the highest frequency component (HHL) in the first multi-resolution analysis, 123 is the bandwidth of two below the highest frequency component (HMH) in the first multi-resolution analysis, 124 is the bandwidth of three below the highest frequency component (HML) in the first multi-resolution analysis, 125 is the bandwidth of four below the highest frequency component (HLH) in the first multi-resolution analysis, and 126 is the bandwidth of the lowest frequency component (HLL) in the first multi-resolution analysis.

FIG. 14 is described in detail. When the number of the convexoconcave portions per mm is 20 or less, all appears in the graph 126. For example, when the number of the convexoconcave portions per mm is 110, it appears most in the graph 124, which corresponds to HML in (b) of FIG. 13. For example, when the number of the convexoconcave portions per mm is 220, it appears most in the graph 123, which corresponds to HMH in (b) of FIG. 13. For example, when the number of the convexoconcave portions per mm is 310, it appears most in the graphs 122 and 123, which correspond to HHL and HMH in (b) of FIG. 13.

Therefore, the place where the wavelet-converted signal components appear in the six graphs of (b) of FIG. 13 is determined depending on the frequency of the surface roughness. In other words, in the surface roughness, fine roughness appears on the graphs situated on the top side in (b) of FIG. 13 and large surface waves appear on the graphs in (b) of FIG. 13.

In the present disclosure, the surface roughness is decomposed by the frequency. This is represented by the graphs of (b) of FIG. 13. The surface roughness in each of the frequency bandwidth is obtained from the graph per this frequency bandwidth. As the surface roughness, the arithmetical mean roughness, the maximum height, and the ten point height of irregularities are calculated.

In (b) of FIG. 13, the values of the arithmetical mean roughness WRa, the maximum height WRma, and the ten point height of irregularities WRz are shown in each graph.

“W” is put in front as in the arithmetical mean roughness WRa, the maximum height WRma, and the ten point height of irregularities WRz of the roughness curve obtained by the wavelet conversion to separate them from the typical representation.

In the present disclosure, as described above, the data measured by the surface texture and contour measuring instrument are separated into multiple data by frequency so that the variance of the convexoconcave portions in each frequency bandwidth is measured.

Furthermore, in the present disclosure, the lowest frequency, i.e., HLL data are thinned out from the separated data as in (b) of FIG. 13 by frequency.

In the present disclosure, how data are thinned out, i.e., taking out from how many pieces of data can be determined by experiments so that the number of data to be thinned out can be optimized. Therefore, the frequency bandwidth separation in the multi-resolution analysis illustrated in FIG. 14 is made optimized, thereby setting the target frequency as the center of the bandwidth.

In FIG. 13, a single datum is left out of 40 pieces of data in this thinning-out.

The results of the thinning-out are shown in FIG. 15. In FIG. 15, the Y axis is the surface roughness with a unit of μm.

The X axis represents the length with a measuring length of 12 mm without a scale.

In the present disclosure, the data in FIG. 15 are further subjected to multi-resolution analysis. That is, the second multi-resolution analysis (MRA-2) is conducted.

The six graphs in (c) of FIG. 13 are the results of the second multi-resolution analysis (MRA-2) and the graph 107 situated at the top is the highest frequency component of the results of the second multi-resolution analysis, which is referred to as LHH.

The graph 108 is the frequency one below the highest frequency component of the results of the second multi-resolution analysis and is referred to as LHL.

The graph 109 is the frequency two below the highest frequency component of the results of the second multi-resolution analysis and is referred to as LMH.

The graph 110 is the frequency three below the highest frequency component of the results of the second multi-resolution analysis and is referred to as LML.

The graph 111 is the frequency four below the highest frequency component of the results of the second multi-resolution analysis and is referred to as LLH.

The graph 112 is the lowest frequency component of the results of the second multi-resolution analysis and is referred to as LLL.

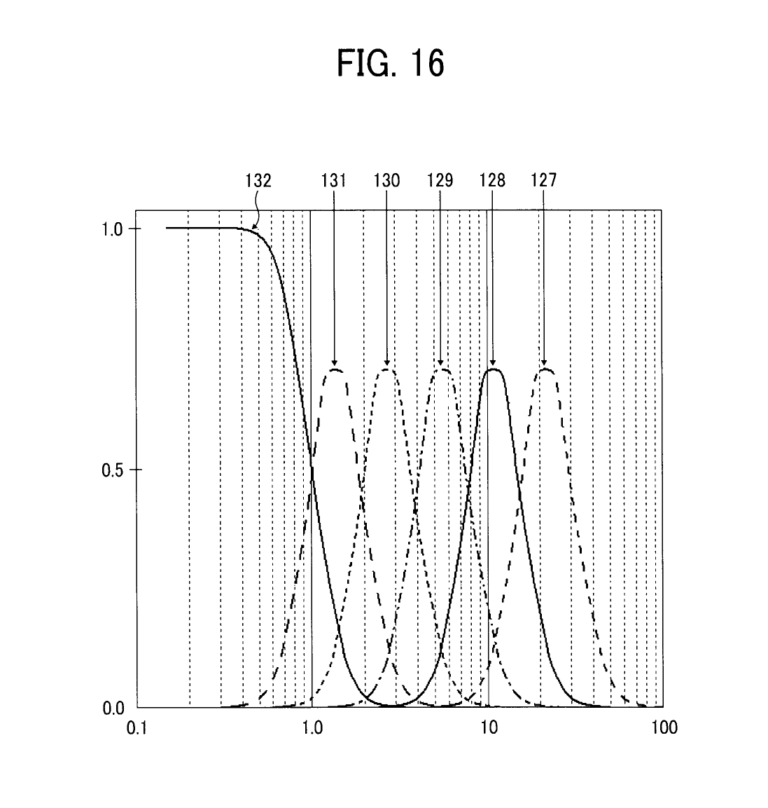

In the present invention, in (c) of FIG. 13, there six graphs by frequency and the state of the frequency separation is illustrated in FIG. 16.

In FIG. 16, the X axis is the number of the convexoconcave portions per mm when the form of the convexoconcave portions is regarded as a sign wave. In addition, the Y axis indicates the ratio when separated into each bandwidth.

In FIG. 16, 127 represents the bandwidth of the highest frequency component (LHH) in the second multi-resolution analysis, 128 is the bandwidth of one below the highest frequency component (LHL) in the second multi-resolution analysis, 129 is the bandwidth of two below the highest frequency component (LMH) in the second multi-resolution analysis, 130 is the bandwidth of three below the highest frequency component (LML) in the second multi-resolution analysis, 131 is the bandwidth of four below the highest frequency component (LLH) in the second multi-resolution analysis, and 132 is the bandwidth of the lowest frequency component (LLL) in the second multi-resolution analysis.

FIG. 16 is described in detail. When the number of the convexoconcave portions per mm is 0.2 or less, all appears in the graph 132.

For example, when the number of the convexoconcave portions per mm is 11, the graph 128 is the highest, meaning the wavelet-converted signal components appears most in the bandwidth of the frequency component one below the highest frequency component in the second multi-resolution analysis, i.e., LML in (c) of FIG. 13.

Therefore, the place where the wavelet-converted signal components appear in the six graphs of (c) of FIG. 13 is determined depending on the frequency of the surface roughness.

In other words, in the surface roughness, fine roughness appears on the graphs situated on the top side in (c) of FIG. 13 and large surface waves appear on the graphs of (c) of FIG. 13.

In the present disclosure, the surface roughness is decomposed by the frequency. This is represented by the graphs of (c) of FIG. 13. The surface roughness in each frequency bandwidth is obtained from the graph per this frequency bandwidth. As the surface roughness, the arithmetical mean roughness RA (WRa), the maximum height Rmax (WRmax), and the ten point height of irregularities RZ (WRz) are calculated.

The single dimensional data arrangement obtained by measuring the convexoconcave portions of the surface of the image bearing member is subjected to the multi-resolution analysis of separating data arrangement into multiple frequency components from the high frequency components to the low frequency components by wavelet conversion, and the lowest frequency component obtained here is thinned-out to obtain another single dimensional data arrangement. This single dimensional data arrangement is furthermore subjected to wavelet conversion to conduct multi-resolution analysis of separating the data arrangement into multiple frequency components from the high frequency components to the low frequency components. For each of the thus-obtained frequency components, the arithmetical mean roughness Ra (WRa), the maximum height Rmax (WRmax), and the ten point height of irregularities Rz (WRz) are calculated. The results are shown in Table 1.

TABLE 1

| | | Surface roughness obtained | | |
|---|---|---|---|---|
| | | from results of multi-resolution | | |
| | | Arithmetical | | Ten point |
| | | mean | Maximum | height of |
| Order of multi- | Signal | roughness Ra | height Rmax | irregularities |
| resolution | name | (WRa) | (WRmax) | Rz (WRz) |
| First time | HHH | 0.0045 | 0.0505 | 0.0050 |
| | HHL | 0.0027 | 0.0398 | 0.0025 |
| | HMH | 0.0023 | 0.0120 | 0.0102 |
| | HML | 0.0039 | 0.0330 | 0.0263 |
| | HLH | 0.0024 | 0.0758 | 0.0448 |
| | HLL | 0.1753 | 0.7985 | 0.6989 |
| Second time | LHH | 0.0042 | 0.0665 | 0.0045 |
| | LHL | 0.0110 | 0.1637 | 0.0121 |
| | LMH | 0.0287 | 0.0764 | 0.0680 |
| | LML | 0.0620 | 0.3000 | 0.2653 |
| | LLH | 0.0462 | 0.2606 | 0.2131 |
| | LLL | 0.0888 | 0.3737 | 0.2619 |

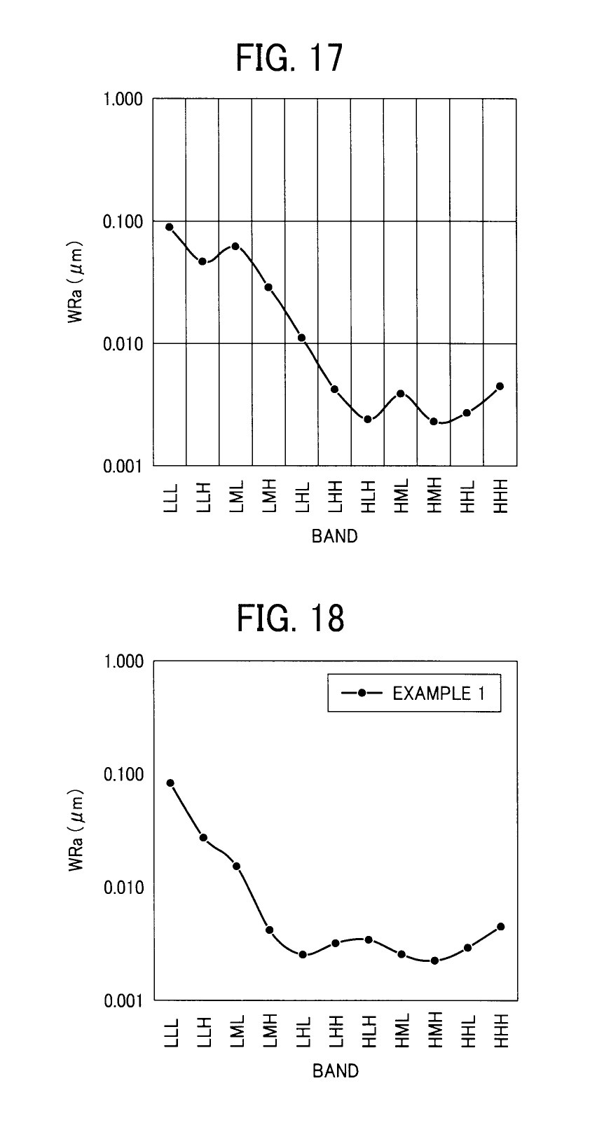

With regard to the profile curve of FIG. 13, the arithmetical mean roughnesses WRa obtained from the results of the multi-resolution analysis are plotted according to the sequence of the signals and linked with lines to obtain a profile (graph) shown in FIG. 17. In this plotting, since HLL component is an arithmetically protruding value, the surface roughness obtained from the results of multi-resolution analysis of this bandwidth is omitted. In the present disclosure, this graph (profile) is referred to as the surface roughness spectrum or the roughness spectrum.

Since the waveforms of from LHH component to LLL component are obtained by wavelet-converting the waveform of HLL component, the characteristics of the HLL component are reflected in the waveforms of from LHH component to LLL component. Therefore, omitting HLL component does not cause problems in the profile.

The image bearing member in the present disclosure is described in detail with reference to accompanying drawings.

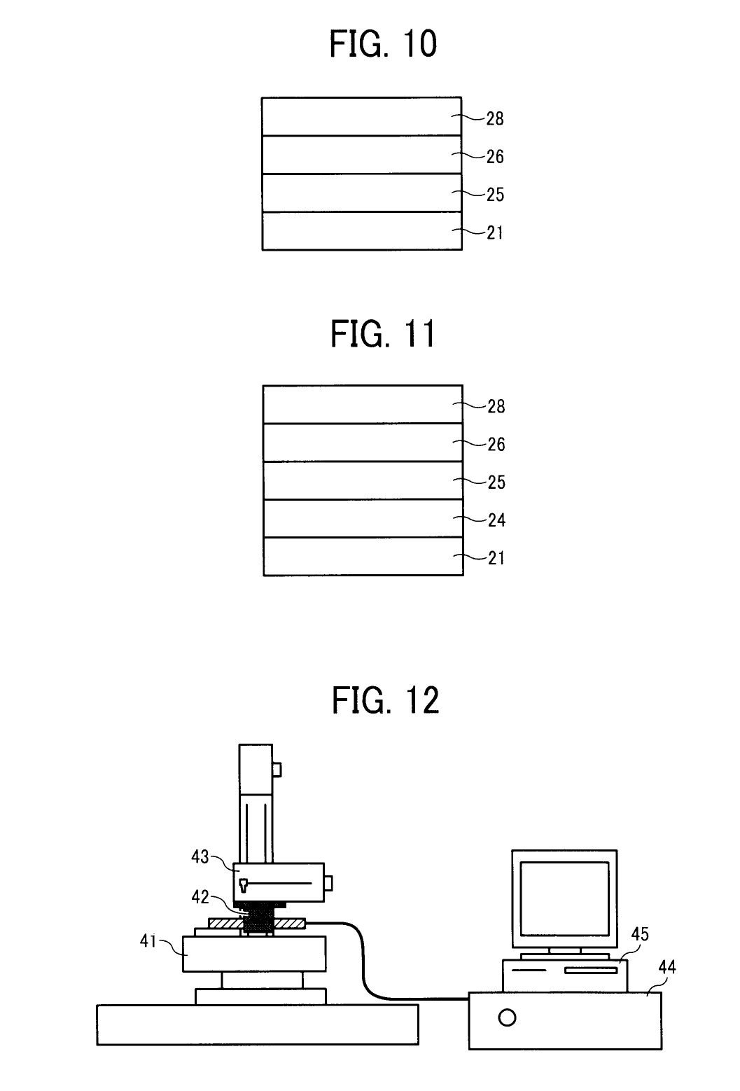

FIG. 10 is a schematic cross section illustrating an example of the image bearing member having a layer structure in the present disclosure which has an electroconductive substrate 21 on which a charge generation layer 25, a charge transport layer 26, and a sub-surface layer 28 are provided.

FIG. 11 is a schematic cross section illustrating an example of the image bearing member having another layer structure in the present disclosure. In this layer structure, an undercoating layer 24 is provided between the electroconductive substrate 21 and the charge generation layer 25 and the charge transport layer 26 and the sub-surface layer 28 are provided on the charge generation layer 25.

### Electroconductive Substrate 21

The electroconductive substrate 21 can be formed by using a material having a volume resistance of not greater than 10¹⁰ Ω·m. For example, there can be used plastic or paper having a film form or cylindrical form covered with metal such as aluminum, nickel, chrome, nichrome, copper, gold, silver, and platinum, or a metal oxide such as tin oxide and indium oxide by depositing or sputtering. Also a board formed of aluminum, an aluminum alloy, nickel, and a stainless metal can be used. Furthermore, a tube which is manufactured from the above-mentioned by a crafting technique such as extruding and extracting and surface-treatment such as cutting, super finishing and grinding is also usable.

### Undercoating Layer 24

For the image bearing member for use in the present invention, the undercoating layer 24 can be provided between the electroconductive substrate 21 and the photosensitive layer (the charge generation layer 25 and the charge transport layer 26 are laminated thereon). The undercoating layer 24 is provided to improve the adhesive property, prevent the occurrence of moiré, improve the coating property of the upper layer, prevent infusion of charges from the electroconductive substrate, etc.

The undercoating layer 24 is normally made of a resin. Typically a photosensitive layer is applied to the undercoating layer, resins for use in the undercoating layer is preferably a thermosetting resin insoluble in an organic solvent. In particular, most of polyurethane, melamine resins, alkyd-melamine resins are preferable because these satisfy the conditions specified above.

A paint (liquid application) can be prepared by suitably diluting the resin in a solvent such as tetrahydrofuran, cyclohexanone, dioxane, dichloroethane, butanone, etc.

In addition, to adjust the conductivity and prevent moire, particulates of metal, metal oxide, etc. can be added to the undercoating layer. Titanium oxide is particularly preferable.

Particulates are dispersed by using a solvent such as tetrahydrofuran, cyclohexanone, dioxane, dichloroethane, butanone, etc. by a ball mill, an attritor, and a sand mill to prepare a paint mixture of liquid dispersion and resin components.

The undercoating layer is formed by applying the thus-prepared liquid application to the electroconductive substrate by a dip coating method, a spray coating method, a bead coating method, etc. Optionally, the layer is cured by heating.

The thickness of the undercoating layer is suitably from about 2 μm to 5 μm in most cases. In the case in which the residual voltage of the image bearing member accumulates and increases, it is good to have an undercoating layer having a thickness less than 3 μm.

In the present disclosure, a laminate type photosensitive layer is preferable which is manufactured by laminating a charge generation layer and a charge transport layer sequentially. A single layered photosensitive layer having a charge transport feature and a charge generating feature is also suitably used in the present disclosure.

### Charge Generation Layer 25

Among the layers of the laminate type image bearing member, the charge generation layer 25 is described.

The charge generation layer represents a part of the laminate type photosensitive layer and has a feature of generating charges (charge generation power) upon exposure to light. This layer is mainly formed of a charge generation material. The charge generation layer optionally contains a binder resin. Inorganic materials and organic materials can be used as the charge generating material.

Specific examples of the inorganic materials include, but are not limited to, crystal selenium, amorphous-selenium, selenium-tellurium-halogen, selenium-arsenic compounds, and amorphous-silicon. With regard to the amorphous-silicon, those in which a dangling-bond is terminated with a hydrogen atom or a halogen atom, and those in which boron atoms or phosphorous atoms are doped are preferably used.

Specific examples of the organic materials include, but are not limited to, metal phthalocyanines such as titanyl phthalocyanine and chlorogalium phthalocyanine, metal-free phthalocyanine, azulenium salt pigments, squaric acid methine pigments, symmetric or asymmetric type azo pigments having a carbazole skeleton, symmetric or asymmetric type azo pigments having a triphenylamine skeleton, symmetric or asymmetric type azo pigments having a fluorenone skeleton, and perylene pigments.

Among these, metal phthalocyanine, symmetric or asymmetric type azo pigments having a fluorenone skeleton, symmetric or asymmetric type azo pigments having a triphenylamine skeleton, and perylene pigments are suitable as the materials for use in the present disclosure because they have excellent quantum efficiency of charge generation. These charge generation materials can be used alone or in combination.

Specific examples of the binder resins for use in the charge generation layer include, but are not limited to, polyamide resins, polyurethane resins, epoxy resins, polyketone resins, polycarbonate resins, polyarylate resins, silicone resins, acrylic resins, polyvinyl butyral resins, polyvinyl formal resins, polyvinyl ketone resins, polystyrene resins, poly-N-vinyl carbazole resins, and polyacrylic amide resins. In addition, the charge transport polymers mentioned below are also usable. Among these, polyvinyl butyral resins are popularly used and useful. These binder resins may be used alone or as a mixture of two or more.

The methods of forming the charge generation layer are largely classified into the vacuum thin layer forming methods and the casting methods from a solution dispersion system.

Specific examples of the vacuum thin layer formation methods include, but are not limited to, a vacuum evaporation method, a glow discharge decomposition method, an ion-plating method, a sputtering method, a reactive sputtering method, or a CVD (chemical vapor deposition) method. A layer of the inorganic material and organic material specified above can be suitably formed.

In the casting method, the above-mentioned inorganic or organic charge generation material is dispersed with an optional binder resin in a solvent, for example, tetrahydrofuran, dioxane, cyclohexanone, dioxsan, ichloroethane, and butanone using, for example, a ball mill, an attritor, and a sand mill. Thereafter, suitably diluted liquid dispersion is applied. Among these solvents, methyl ethyl ketone, tetrahydrofuran, and cyclohexanone are preferable to chlorobenzene, dichloromethane, toluene, and xylene in terms of burden on the environment.

The liquid dispersion can be applied by a dip coating method, a spray coating method, a bead coating method, etc.

The thickness of the charge generation layer provided as described above is suitably from about 0.01 μm to about 5 μm.

When reducing the residual voltage and improving the sensitivity are required, these characteristics are improved by thickening the charge generation layer. However, it may have an adverse impact on the chargeability such as the sustainability of the charge and forming of the space charge.

The thickness of the charge generation layer is preferably from 0.05 μm to 2 μm considering the balance therebetween.

In addition, any known low molecular weight compounds such as plasticizing agents, lubricants, anti-oxidizing agents, and ultraviolet absorbents and leveling agents can be optionally added to the charge generation layer. These compounds can be used alone or as a mixture thereof. In most cases, a combinational use of the low molecular weight compounds and the leveling agent degrades the sensitivity. The content of the low molecular weight compounds is from about 0.1 phr to about 20 phr and preferably from about 0.1 phr to about 10 phr and the content of the leveling agent is from about 0.001 phr to about 0.1 phr.

### Charge Transport Layer 26

The charge transport layer is part of a laminate type photosensitive layer in charge of infusing and transporting the charges produced in the charge generation layer and neutralizing the surface charge (charge transport power) of the image bearing member.

The charge transport component and a binder component to bind the charge transport component are the main components of the charge transport layer.

Electron transport materials and hole transport materials having a low molecular weight and charge transport polymers can be used as the charge transport material.

Specific examples of the electron transport materials include, but are not limited to, electron acceptance materials such as asymmetric diphenoquinone derivatives, fluorenone derivatives, and naphthalimide derivatives. These charge generation materials can be used alone or in combination.

The electron donating materials can be preferably used as the positive hole transport material. Specific examples of the hole transport materials include, but are not limited to, oxazole derivatives, oxadiazole derivatives, imidazole derivatives, triphenyl amine derivatives, butadiene derivatives, 9-(p-diethylaminostyrylanthracene), 1,1-bis-(4-dibenzil aminophenyl)propane, styrylanthracene, styrylpyrazoline, phenyl hydrazones, α-phenyl stilbene derivatives, thiazole derivatives, triazole derivatives, phenazine derivatives, acridine derivatives, benzofuran derivatives, benzimidazole derivatives, and thiophene derivatives. These positive hole transport materials can be used alone or in combination.

In addition, the charge transport polymers specified below are also usable. These are: polymers having a carbazole ring such as poly-N-vinyl carbazole; polymers having a hydrazone structure illustrated in JP-S57-78402-A; polysilylene polymers illustrated in JP-S63-285552-A; and aromatic polycarbonates illustrated in Chemical formulae 1 to 6 illustrated in JP-2001-330973-A. These charge transport polymers can be used alone or in combination. Among these, the illustrated compounds in JP-2001-330973-A are excellent in terms of the electrostatic charging property.

The charge transport polymer is a material suitably laminated on the sub-surface layer because the component forming the charge transport layer does not run into the sub-surface layer in comparison with the low molecular weight type charge transport material, thereby preventing poor curing of the sub-surface layer. Furthermore, since the molecular weight of the charge transport material increases, the charge transport polymer has an excellent heat resistance. Therefore, it is advantageous in terms that degradation of the charge transport layer by the curing heat produced when forming the sub-surface layer does not easily occur.

Specific examples of the binder resins in the charge transport layer include, but are not limited to, thermoplastic resins or thermocuring resins such as polystyrenes, polyesters, polyvinyls, polyarylates, polycarbonates, acrylic resins, silicone resins, fluorine-containing resins, epoxy resins, melamine resins, urethane resins, phenol resins, and alkyd resins. Among these, polystyrenes, polyesters, polyarylates, or polycarbonates are preferably used as the binder resin for the charge transport component because these have good charge mobility. In addition, the charge transport layer is not required to have the same mechanical strength as a typical charge transport layer because the sub-surface layer is laminated on the charge transport layer. Therefore, materials such as polystyrene which have a high transparency with a relatively weak mechanical strength and thus are not easily used in typical cases can be used as the binder component for the charge transport layer.

These charge transport polymers can be used alone or in combination or as copolymers of at least two kinds of raw material monomers or compounds obtained by copolymerization with the charge transport materials.

When electrically inert polymers are used to modify the charge transport layer, it is suitable to use polyesters having a Cardo polymer type with a bulky skeleton such as a fluorene, polyesters such as polyethylene terephthalate and polyethylene naphthalate, polycarbonates in which 3,3′ portion of the phenol component is alkyl-substituted in a bisphenol type polycarbonate such as C type polycarbonate, polycarbonates in which a geminalmethyl group in bisphenol A is substituted with an alkyl group having a long chain having two or more carbon atoms, polycarbonates having a biphenyl or biphenyl ether skeleton, polycaprolactones, polycarbonates having a long chain alkyl skeleton such as polycaprolactone (specified in JP-H7-292095, etc.), acrylic resins, polystyrene resins, and hydrogenated butadiene.

The electrically inert polymers do not contain a chemical structure having a photoconductivity such as triaryl amine structure. When these resins are used as additives in combination with the binder resin, the addition amount thereof is preferably 50% by weight or less based on the total solid portion of the charge transport layer due to the restraint of the optical attenuation sensitivity.

When the low molecular weight charge transport material is used, the content thereof is from about 40 phr to about 200 phr and preferably from about 70 phr to about 100 phr. In addition, when the charge transport polymer is used, it is preferable to use a material in which the resin component is copolymerized in a ratio of from 0 to about 200 parts by weight and preferably from about 80 parts by weight to about 150 parts by weight based on 100 parts by weight of the charge transport component.

In addition, when at least two kinds of the charge transport materials are contained in the charge transport layer, the ionization potential difference between the charge transport materials is preferably small. To be specific, the ionization potential difference is 0.10 eV or less to prevent one charge transport material from becoming charge traps to the other charge transport materials.

This relationship with regard to the ionization potential is also applied to the charge transport material contained in the charge transport layer and the curable charge transport material described later and the difference is suitably 0.10 eV or less.

The ionization potential of the charge transport material in the present disclosure is obtained by a typical method using an atmosphere type ultraviolet photoelectron analyzer (AC-1, manufactured by Riken KeikiI Co., Ltd.).

It is preferable that the blending amount of the charge transport component is 70 phr or more to improve the sensitivity. In addition, a monomer or a dimer of an α-phenyl stilbene compound, a benzidine compound, and a butadiene compound and charge transport polymers having a structure of such a monomer or a dimer in the main structure of a branch chain or are suitable as the charge transport materials because they tend to have a high charge mobility.

Specific examples of the dispersing solvents to prepare the liquid application of the charge transport layer include, but are not limited to, ketone-based solvents such as methylethyl ketone, acetone, methylisobutyl ketone, and cyclohexanone, ether-based solvents such as dioxane, tetrahydrofuran, and ethylcellosolve, aromatic solvents such as toluene and xylene, halogens such as chlorobenzene and dichloromethane, and esters such as ethyl acetate and butyl acetate. Among these solvents, methyl ethyl ketone, tetrahydrofuran, and cyclohexanone are preferable to chlorobenzene, dichloromethane, toluene, and xylene in terms of burden on the environment.

These solvents can be used alone or as a mixture thereof.

The charge transport layer is formed by dissolving or dispersing a mixture or a copolymer containing a charge transport component and a binder component as the main component in a suitable solvent followed by coating and drying. Known methods such as a dip coating method, a spray coating method, a ring coating method, a roll coater method, a gravure coating method, a nozzle coating method, and a screen printing method can be used as the application method.

Since the sub-surface layer is laminated on the charge transport layer, it is not required to increase the thickness of the charge transport layer in this structure considering the film scraping during actual use. The thickness of the charge transport layer is suitably from about 10 μm to about 40 μm and preferably from about 15 μm to about 30 μm to secure sufficient sensitivity and charging power required during actual usage.

In addition, any known low molecular weight compounds such as plasticizing agents, lubricants, anti-oxidizing agents, and ultraviolet absorbents and leveling agents can be optionally added to the charge transport layer. These compounds can be used alone or as a mixture thereof. In most cases, a combinational use of the low molecular weight compounds and the leveling agent degrades the sensitivity. The content of the low molecular weight compounds is from about 0.1 phr to about 20 phr and preferably from about 0.1 phr to about 10 phr and the content of the leveling agent is from about 0.001 phr to about 0.1 phr.

### Sub-Surface Layer 28

The sub-surface layer is a protective layer formed on the surface of the image bearing member. This protective layer is formed by a resin having a cross-linking structure by polycondensation reaction after a liquid application having a resin (monomer) component is applied. Since the resin layer has the cross-linking structure, the sub-surface layer has the highest abrasion resistance among the layers of the image bearing member. Also, since the cross-linked charge transport structure unit is contained in the underlying surface, the sub-surface layer has a charge transport property similar to that of the charge transport layer.

### Roughening Surface

In the present disclosure, the roughness spectrum of the surface of the image bearing member has at least no folding point in the bandwidth from LLL to LHL and a folding point in the bandwidth from LHL to HMH and WRa (LLH) is less than 0.04 μm and WRa (HLH) is less than 0.005 μm.

Therefore, the surface of the image bearing member is required to have a particular rough surface. To be specific, reagents that are expected to control the surface form are added, for example, blending fillers, sol-gel based liquid application, or resin polymers having different glass transition temperature, addition of organic particulates or foaming agents, and a mass amount of addition of silicone oil.

In addition, as controlling of the film-forming conditions of the surface layer, a mass amount of water is added to the paint (liquid application), liquid reagents having different boiling points are added, etc. In addition, it is possible to sprinkle an organic solvent or water to an uncured wet film immediately after coating the sub-surface layer with the liquid application. Furthermore, as an optional additional processing after curing a cross-linking type resin film, the surface can be subjected to sand blast processing or ground by sand paper such a wrapping film.

The cross-linked resin surface layer is formed by curing a binder component of radical polymerizable monomer having three or more functional groups with no charge transport structure. This cross-linked resin film is suitable in terms of the balance between the photosensitivity and the durability of the image bearing member and the easy recycling described above.

The binder resin having three or more functional groups preferably contains caprolactone modified or non-modified dipentaerythritol hexaacrylate, thereby improving the durability or the toughness of the cross-linked layer.

Specific preferred examples of the radical polymerizable monomer having three or more functional groups with no charge transport structure include, but are not limited to, trimethylol propane triacrylate, caprolactone modified dipentaerythritol hexaacrylate, and dipentaerythritol hexaacrylate.

KAYARAD DPCA series, DPHA series, etc. are available from a reagent manufacturer, Nippon Kayaku Co., Ltd. as these agents.

Moreover, it is possible to add an initiator such as IRGACURE 184 manufactured by BASF Group in an amount of from about 5% by weight to about 10% by weight based on the total solid portion to promote and stabilize curing.

Specific examples of the cross-linking charge transport materials include, but are not limited to, chain polymerization compounds having an acryloyloxy group and a styrene group, sequential polymerization compounds having a hydroxyl group, an alkoxy silyl group, or an isocyanate group. Compounds having a charge transport structure with at least one (meth)acryloyloxy group are usable. Furthermore, monomers or oligomers having at least one (meth)acryloyloxy group with no charge transport structure can be used in combination. At least the liquid application containing such compounds are used to form a surface layer followed by application of energy such as heat, light, electron beams, or radial ray such as γ ray for cross-linking and curing to form the sub-surface layer. Specific examples of the charge transport materials include the following charge transport compounds represented by the chemical structure 1.

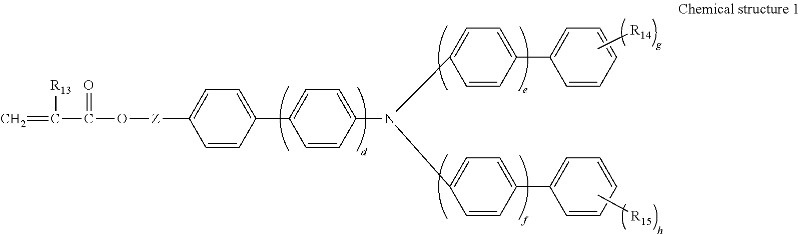

In the chemical structure 1, d, e, and f are independently 0 or 1 and g and h independently represent an integer of from 0 to 3. R₁₃ represents a hydrogen atom or a methyl group, R₁₄ and R₁₅ independently represent alkyl groups having one to six carbon atoms. Z represents a single bond, a methylene group, an ethylene group, or a divalent group represented by the following chemical structures 2 to 4.

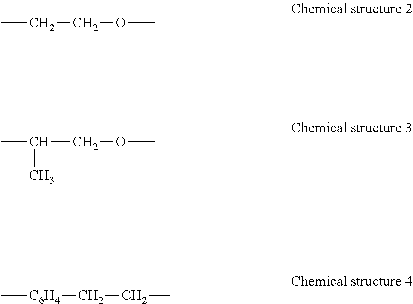

Specific examples thereof include, but are not limited to, the chemical compounds represented by the following chemical structures No. 1 to No. 26.

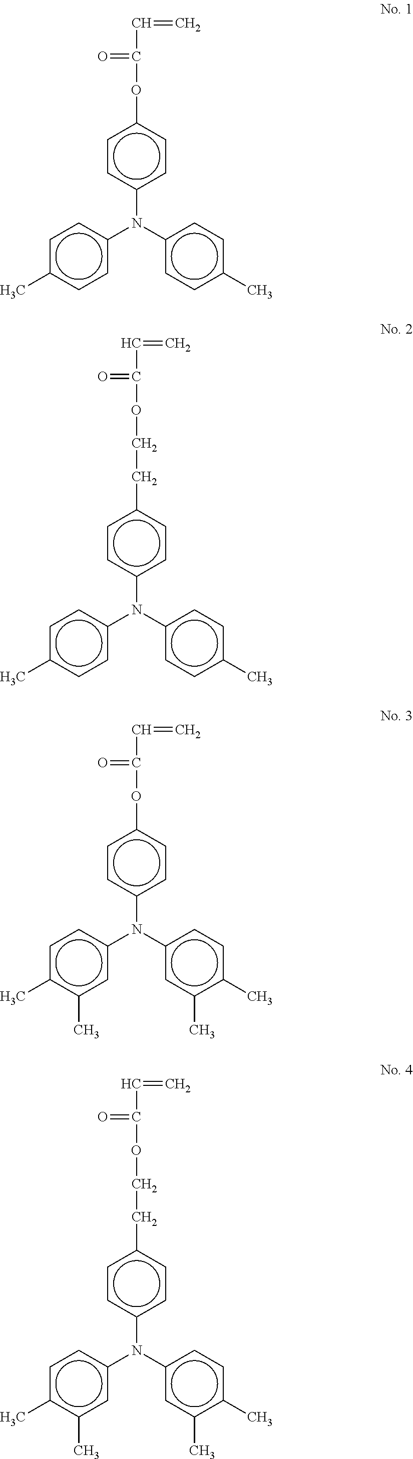

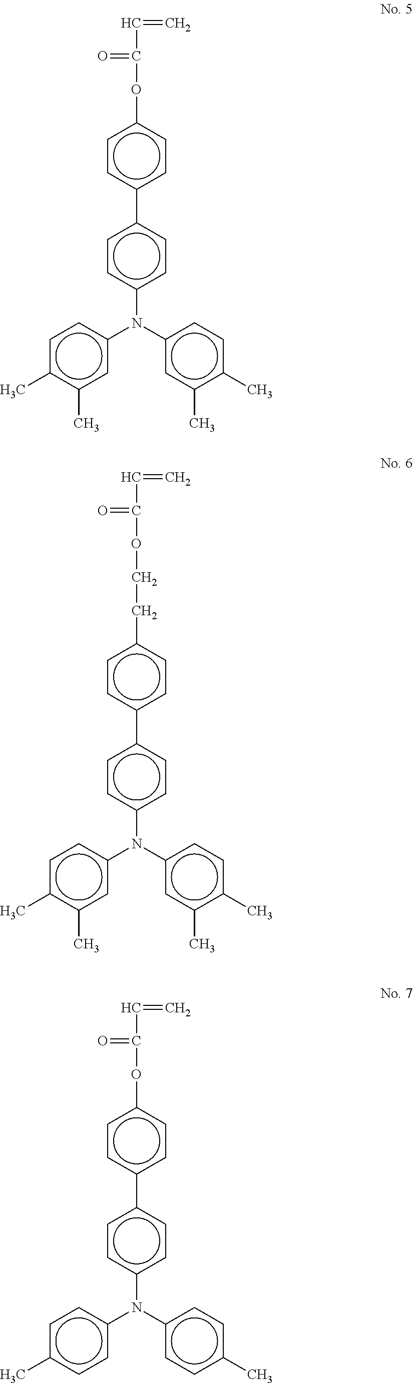

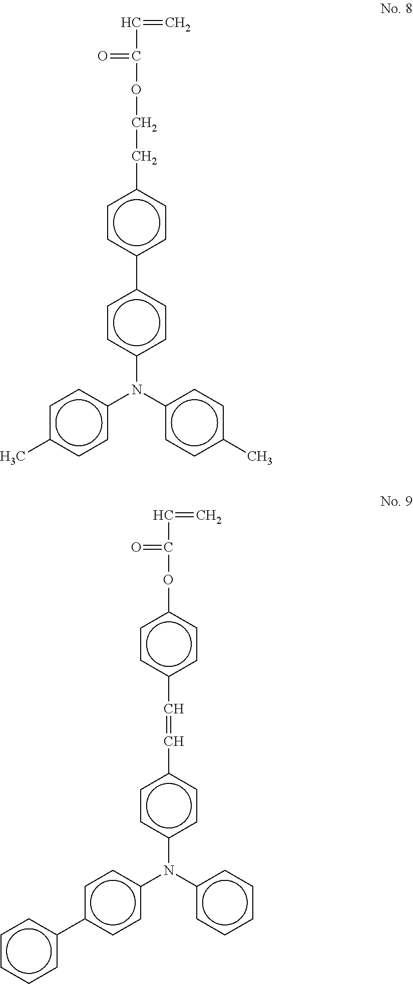

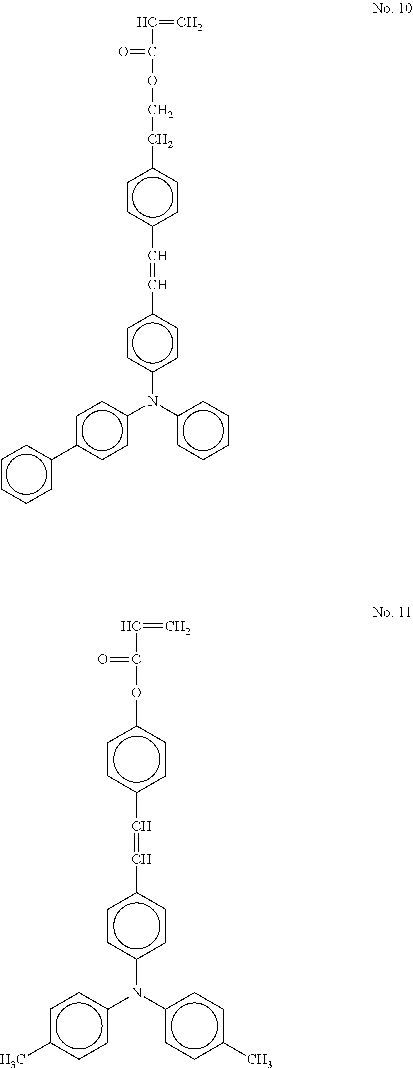

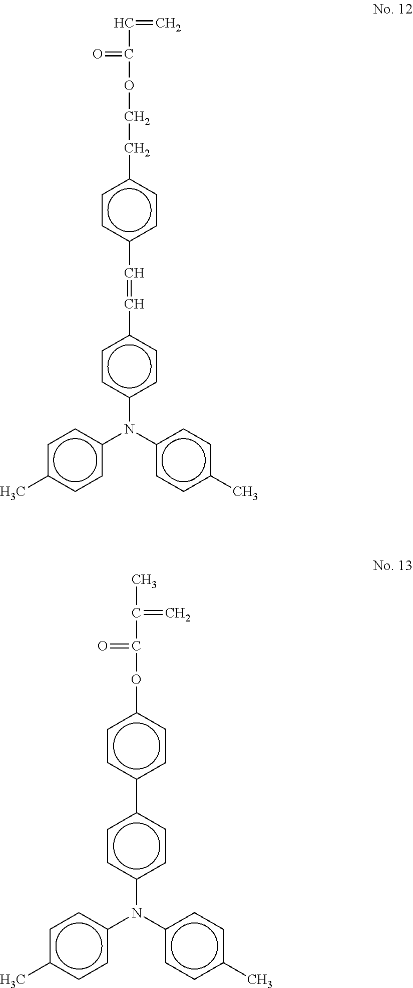

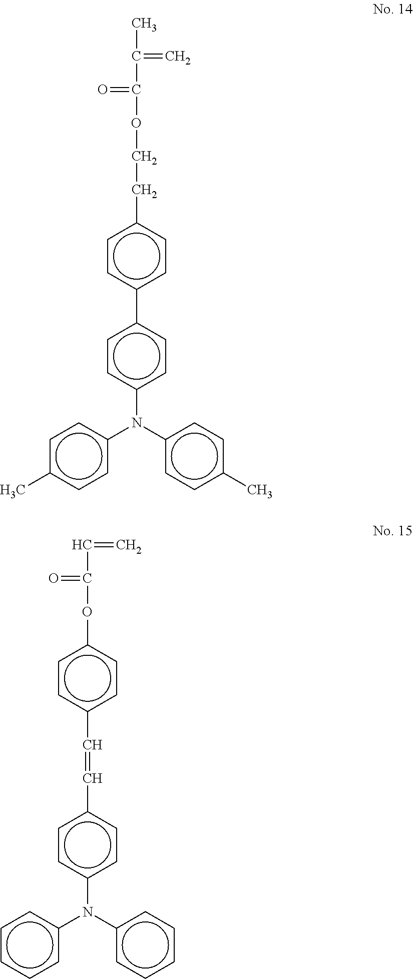

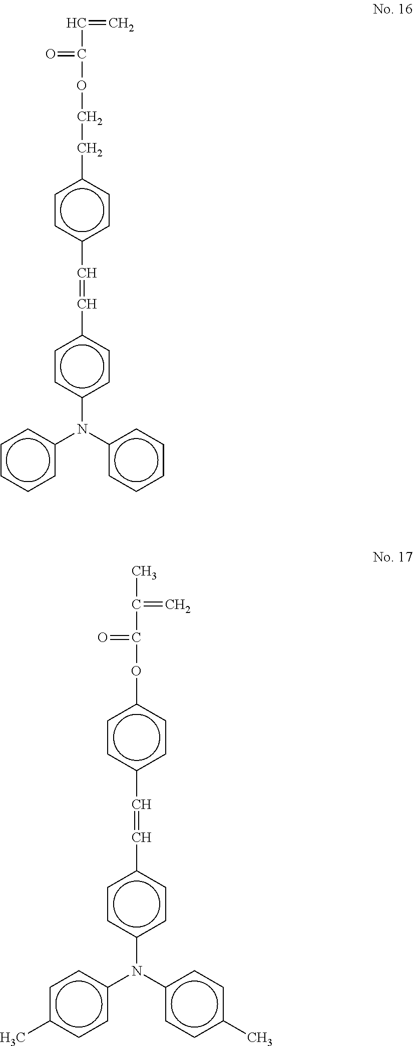

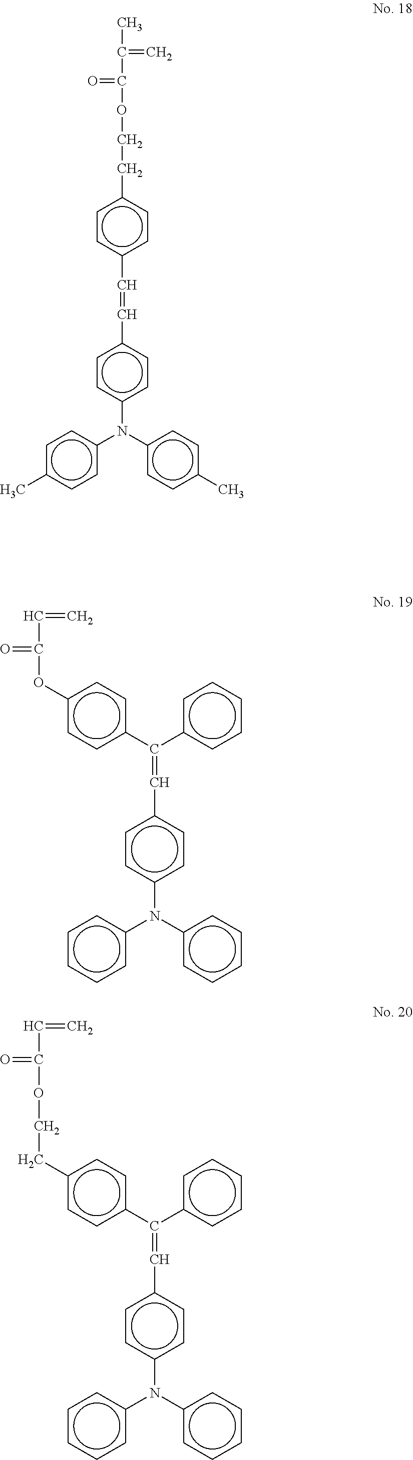

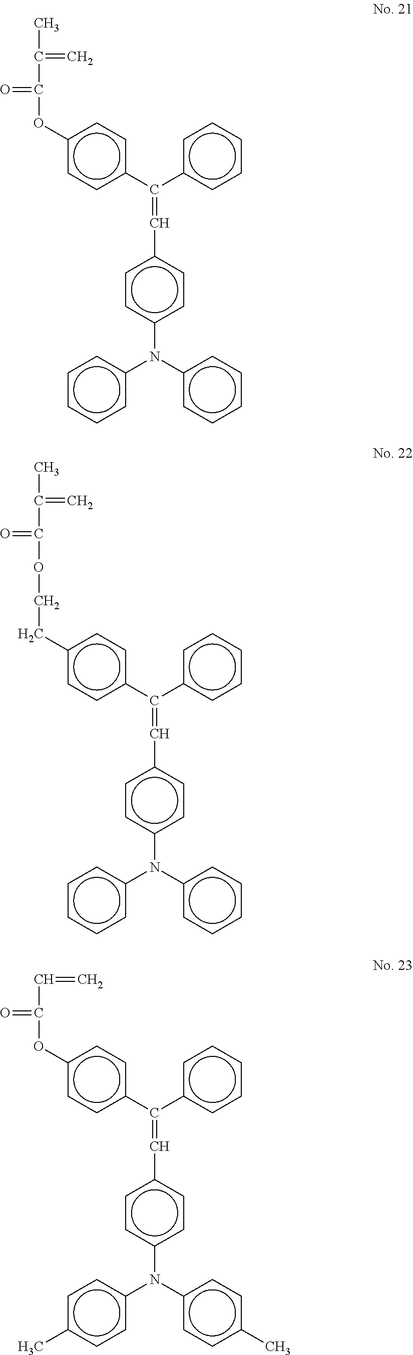

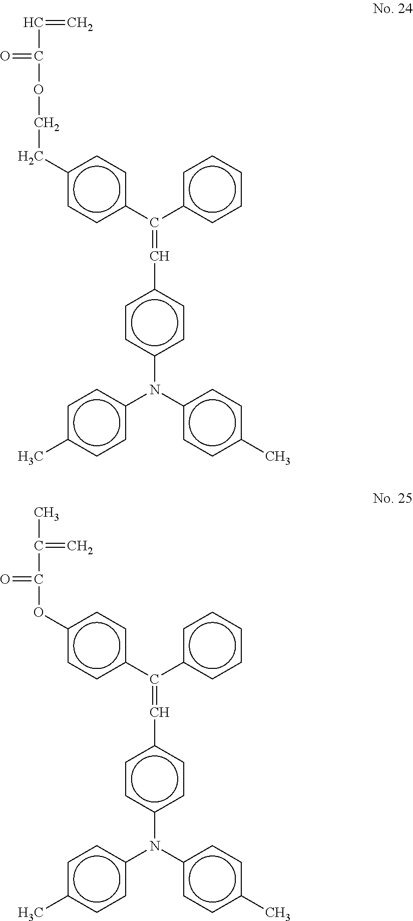

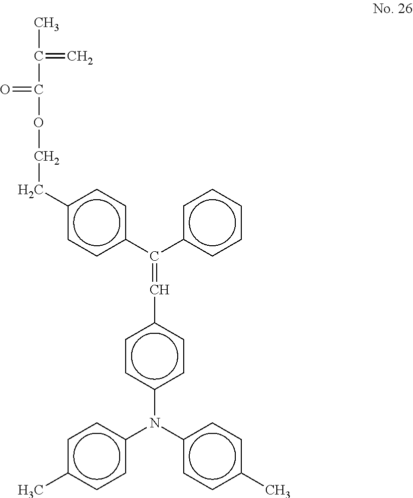

Fillers having a high hardness can be contained to improve the abrasion resistance of the sub-surface layer. Specific examples of the fillers include, but are not limited to, silica, alumina, and ceria. Among these, α-alumina having a hexagonal close packed structure obtained by gas phase polymerization is particularly suitable because it can impart a high hardness at a relatively low cost. Since the filler has a significantly spherical form, the filler prevents the surface of the image bearing member from becoming prickly, thereby reducing the damage to members abrading with the image bearing member. The content of the filler is suitably from 1% by weight to 30% by weight based on the total weight of the solid portion of the sub-surface layer.

Although the voltage at the irradiated portion may rise because of the filler, this rise can be canceled by mixing tin oxide. Since tin oxide has less hardness than α-alumina, the mechanical strength decreases as the ratio of changing the filler to tin oxide increases. The mixing ratio of tin oxide is preferably from 5% by weight to 50% by weight based on the total weight of the filler mixture to strike the balance between the mechanical strength and the voltage at irradiated portion.

It is preferable to select a solvent for dispersion for use in preparing the liquid dispersion of the sub-surface layer which dissolves a monomer sufficiently. Specific examples thereof include, but are not limited to, in addition to the ethers, aromatic compounds, halogens, and esters specified above, cellosolves such as ethoxyethanol and propylene glycols such as 1-methoxy-2-propanol.

Among these solvents, methyl ethyl ketone, tetrahydrofuran, cyclohexanone, and 1-methoxy-2-propanol are preferable to chlorobenzene, dichloromethane, toluene, and xylene in terms of burden on the environment.

These solvents can be used alone or as a mixture thereof.

The liquid application of the sub-surface layer can be applied by methods such as a dip coating method, a spray coating method, a ring coating method, a roll coater method, a gravure coating method, a nozzle coating method, and a screen printing method. In many cases, the liquid application does not have a long pot life so that methods requiring a small amount of liquid application in which just a necessary amount thereof is used are advantageous in terms of the burden on the environment and cost.

Among these, the spray coating method and the ring coating methods are preferable. Furthermore, ink jet systems are suitable to impart a particular form in the present disclosure.

When forming the sub-surface layer, a UV irradiation light source such as a high pressure mercury lamp or a metal halide lamp having a main emission wavelength in the ultraviolet range is used. A visible light source can be used to the absorption wavelength of a compound containing a radical polymerizable monomer and a photopolymerization initiator. The irradiation light amount is preferably from 50 mW/cm² to 1,000 mW/cm². When the irradiation light amount is too small, it takes a long time to complete the curing reaction. An irradiation light amount that is too large tends to prevent a uniform curing reaction, which results in local wrinkling on the surface of the cross-linked charge transport layer and a great number of non-reacted residual groups and reaction terminated ends. In addition, rapid cross-linking increases the internal stress, which leads to cracking and peeling-off of the layer.

In addition, any known low molecular weight compounds such as plasticizing agents, lubricants, anti-oxidizing agents, and ultraviolet absorbents and leveling agents can be optionally added to the sub-surface layer. Furthermore, the polymers specified for the charge transport layer can be also added.

These compounds can be used alone or as a mixture thereof. In most cases, a combinational use of the low molecular weight compounds and the leveling agent degrades the sensitivity. The content of the low molecular weight compounds is from about 0.1% by weight to about 20% by weight and preferably from about 0.1% by weight to about 10% by weight and the content of the leveling agent is from about 0.1% by weight to about 5% by weight.

The thickness of the sub-surface layer is suitably from about 3 μm to about 15 μm. The allowable lowest limit is calculated considering the effect degree to the film-forming cost and the allowable highest limit is set by the electrostatic characteristics such as the charging stability and the optical attenuation sensitivity and the uniformity of the film quality.

### Embodiments of Image Forming Apparatus

The image forming apparatus is described with reference to the accompanying drawings. A device to supply (input) the circulating material to the surface of the image bearing member is provided to the image forming apparatus of the present disclosure. To be simple, this device is described after the description of the image forming apparatus.

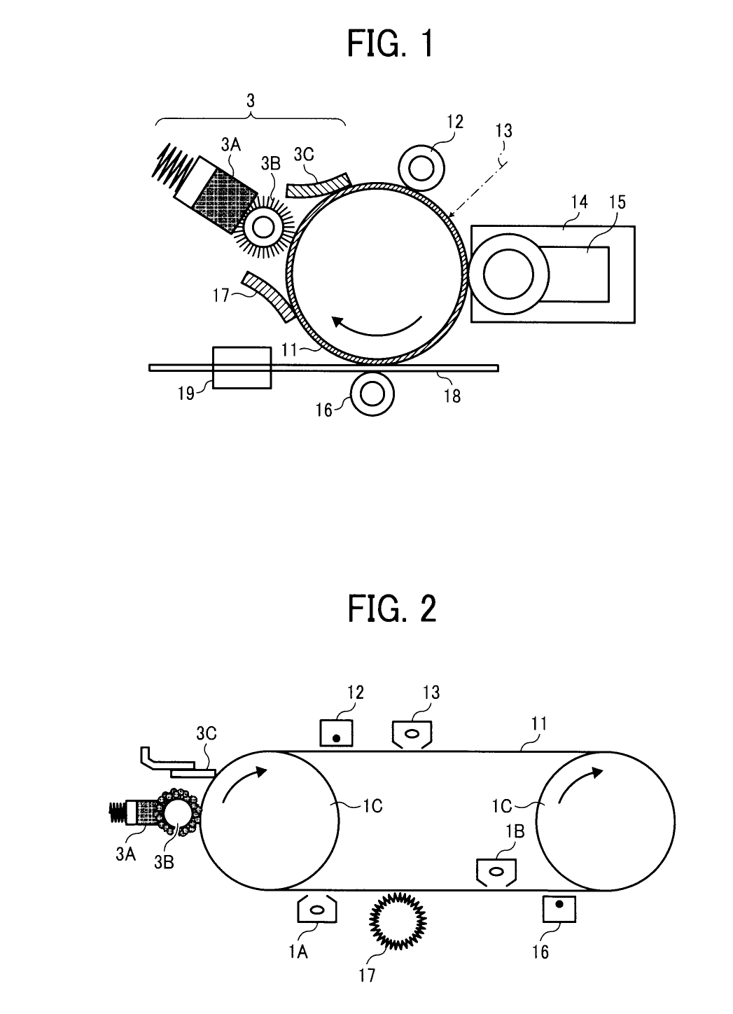

FIG. 1 is a schematic diagram illustrating the image forming apparatus of the present disclosure and the following variant examples are within the scope of the present disclosure.

In FIG. 1, the image bearing member 11 is a photoreceptor in which a sub-surface layer is laminated. Although the image bearing member 11 has a drum form, it may employ a sheet form or an endless belt form.

The charger 12 is a device to uniformly charge the surface of the image bearing member 11. Any known device such as a corotron, scorotoron, a solid state charger, and a charging roller can be used as the charger 12.

In terms of reducing the power consumption, the charger is suitably provided in contact with or in the vicinity of an image bearing member. Among these, to prevent contamination of the charger, it is suitable to arrange a charging mechanism in the vicinity of the image bearing member having a suitable gap between the image bearing member and the surface of the charger is suitable.

Typically, the chargers described above can be generally used as the transfer device 16. A combinational use of the transfer charger and the separation charger is preferable.

Typical illumination devices, for example, a fluorescent lamp, a tungsten lamp, a halogen lamp, a mercury lamp, a sodium lamp, a light emitting diode (LED), a semiconductor laser (LD), and electroluminescence (EL) can be used as the light source for the irradiator 13 or the discharging lamp 1A illustrated in other embodiments. Various kinds of optical filters, for example, a sharp cut filter, a band-pass filter, a near infrared filter, a dichroic filter, a coherent filter, and a color conversion filter, can be used in combination with these light sources to irradiate the image bearing member with beams of light having only a desired wavelength.

A toner 15 transferred to the image bearing member 11 by the development device 14 is transferred to a recording medium 18 such as printing paper or a transparent sheet (for slide) but not all the toner 15 is transferred and part thereof remains on the image bearing member 11. Such residual toner is removed from the image bearing member 11 by the cleaner 17. Brushes such as a rubber cleaning blade, a fur brush, a magfur brush can be used as the cleaner 17.

When the image bearing member 11 is positively (or negatively) charged by the charger 12 and irradiated according to image data by the irradiator 13, a positive (or negative) latent electrostatic image is formed on the surface of the image bearing member 11. When the latent electrostatic image is developed with a negatively (or positively) charged toner (volt-detecting fine particles), a positive image is formed by the development device 14. When the latent electrostatic image is developed using a positively (or negatively) charged toner, a negative image is formed by the development device 14. Any known method can be applied to such a development device and also a discharging device. The toner image developed on the recording medium 18 is transferred from the position opposing the image bearing member 11 and the transfer device 16 to a fixing device 19 where the toner image is fixed on the recording medium 18.

The circulating material 3A and an application blade 3C to apply the circulating material 3A are arranged between the cleaner 17 and the charger 12 as illustrated in FIG. 1 relative to the moving direction of the image bearing member 11.

That is, the circulating material 3A and the application blade 3C are arranged downstream from the cleaner 17 and upstream from the charger 12 relative to the moving direction of the image bearing member 11. The positional relationship is the same in the following embodiments.

FIG. 2 is a diagram illustrating another example of the electrophotographic process in the present disclosure. In FIG. 2, the image bearing member 11 is a photoreceptor in which a sub-surface layer is laminated. Although the image bearing member 11 has a belt form, it may employ a drum form, a sheet form, or an endless belt form. The image bearing member 11 is driven by a driving device 1C, charged by the charger 12, and irradiated by the irradiator 13 to form a latent electrostatic image.

The latent electrostatic image is developed and transferred by the transfer device 16. The image bearing member 11 is irradiated before cleaning by a pre-cleaning irradiator 1B, cleaned by the cleaner 17, and discharged by the discharging lamp 1A. This is repeated each time an image is formed.

The circulating material 3A and an application blade 3C to apply the circulating material 3A are arranged between the cleaner 17 and the charger 12 as illustrated in FIG. 2 relative to the moving direction of the image bearing member 11.

In FIG. 2, the pre-cleaning irradiation is conducted from the supporting member side of the image bearing member 11 (the supporting member is translucent).

These elecrophotography processes are for the illustrated purpose only for the embodiments in the present disclosure and not limited thereto.

For example, in FIG. 2, the pre-cleaning irradiation is conducted from the supporting member side. However, the pre-cleaning irradiation can be conducted from the photosensitive layer side. In addition, image irradiation and discharging irradiation can be conducted from the supporting member side. Although image irradiation, pre-cleaning irradiation, and discharging irradiation are illustrated as the light irradiation processes, other irradiation processes such as pre-transfer irradiation process, pre-image irradiation process, and other known irradiation processes can be provided to irradiate the image bearing member 11.

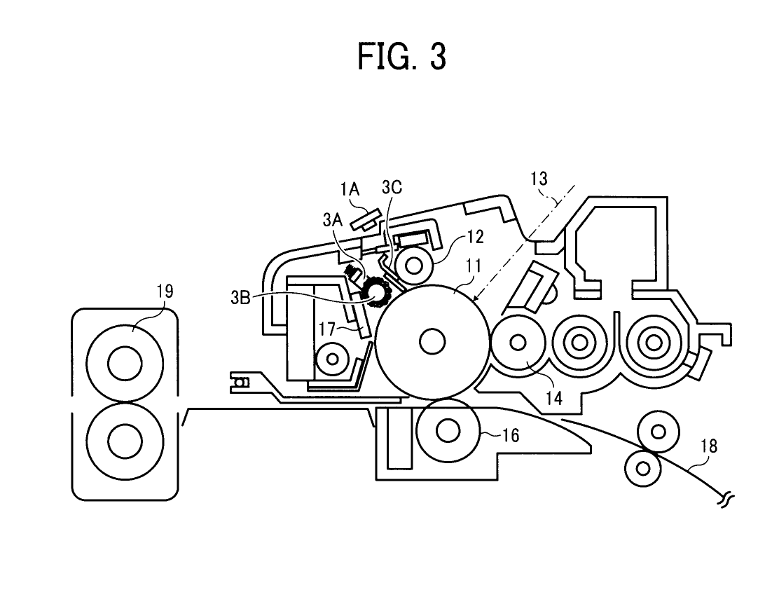

Although the image formation device as described above can be assembled into a photocopier, a facsimile machine, or a printer in a fixed manner, each image formation element can be incorporated into such an apparatus in a form of a process cartridge. There is no specific limit to the form of the process cartridge but a typical form thereof is as illustrated in FIG. 3. Although the image bearing member 11 has a drum form, it may employ a sheet form or an endless belt form.

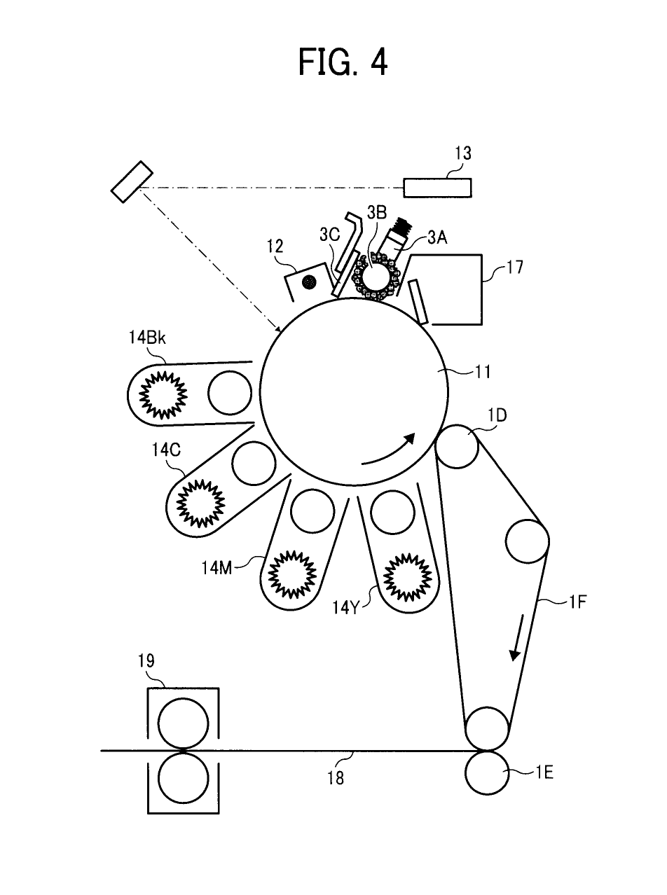

FIG. 4 is a diagram illustrating another example of the image forming apparatus of the present disclosure. In the image forming apparatus, around the image bearing member 11, there are provided the charger 12, the irradiator 13, development devices 14Bk, 14C, 14M, and 14Y) for each color of black (Bk), cyan (C), magenta (M), and yellow (Y), an intermediate transfer belt 1F serving as an intermediate transfer body, and the cleaner 17 sequentially. The symbols of Bk, C, M, and Y illustrated in FIG. 4 correspond to the color of toner. These symbols are attached or omitted on the necessity basis. The image bearing member 11 is a photoreceptor in which the sub-surface layer is laminated. The development devices (14Bk, 14C, 14M, and 14Y) for respective colors are independently controlled and only the development devices for the colors for use in image forming are driven. The toner image formed on the image bearing member 11 is transferred to the intermediate transfer belt 1F by a first transfer device 1D arranged inside the intermediate transfer belt 1F. The first transfer device 1D is arranged in such a manner that it is brought into contact with or separated from the image bearing member 11. Each color image is formed sequentially and is overlapped on the intermediate transfer belt 1F to obtain an overlapped toner image. The overlapped toner image is transferred once from a second transfer device 1E to the recording medium 18 and thereafter fixed thereon by the fixing device 19 to form an image.

The second transfer device 1E is also arranged in such a manner that it is brought into contact with or separated from the intermediate transfer belt 1F. The second transfer device 1E is in contact with the intermediate transfer belt 1F only during transfer operation.

In the image forming apparatus employing a transfer drum system, images cannot be printed on thick paper because each color toner image is sequentially transferred to a recording medium electrostatically attached to a transfer drum. On the other hand, in the image forming apparatus employing the intermediate transfer system as illustrated in FIG. 4, there is no specific limit with regard to the selection of the recording media because each color toner image is overlapped on the intermediate transfer belt 1F.

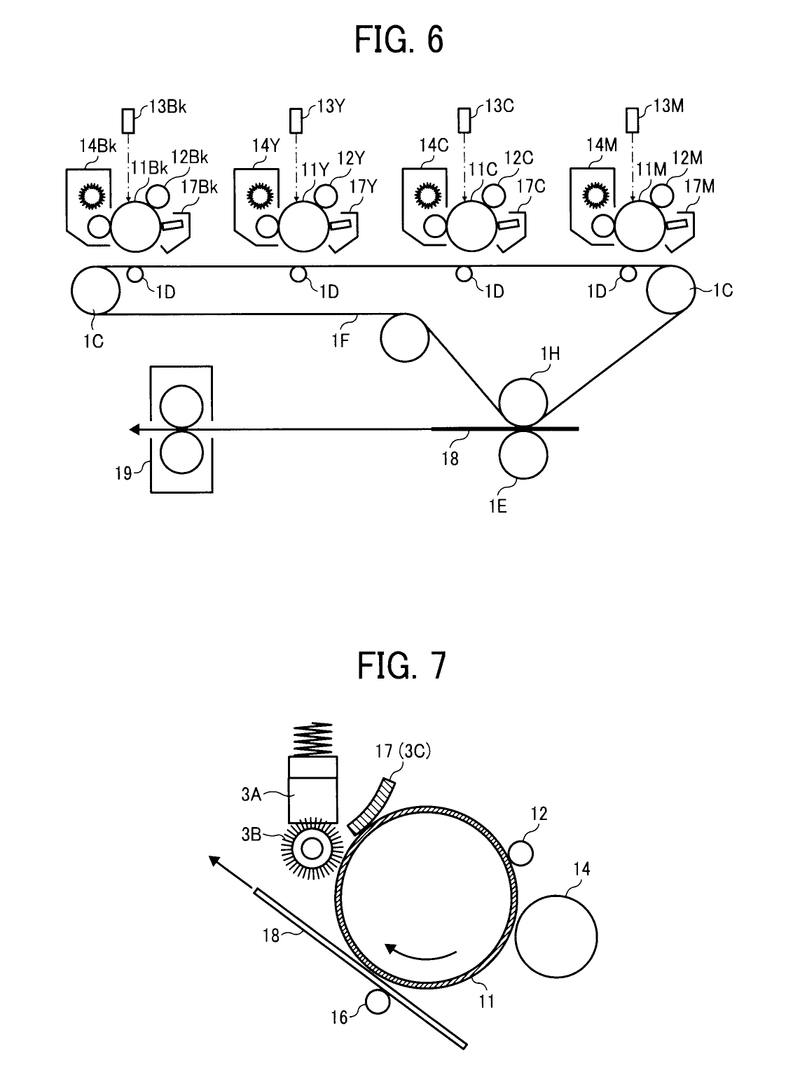

Such an intermediate transfer system can be applied not only to the device as illustrated in FIG. 4 but also to the devices illustrated in FIGS. 1, 2, 3, and 5 (which is described later with a specific example illustrated in FIG. 6).

The circulating material 3A and the application blade 3C to apply the circulating material 3A are arranged between the cleaner 11 and the charger 12 as illustrated in FIG. 4 relative to the moving direction of the image bearing member 11.

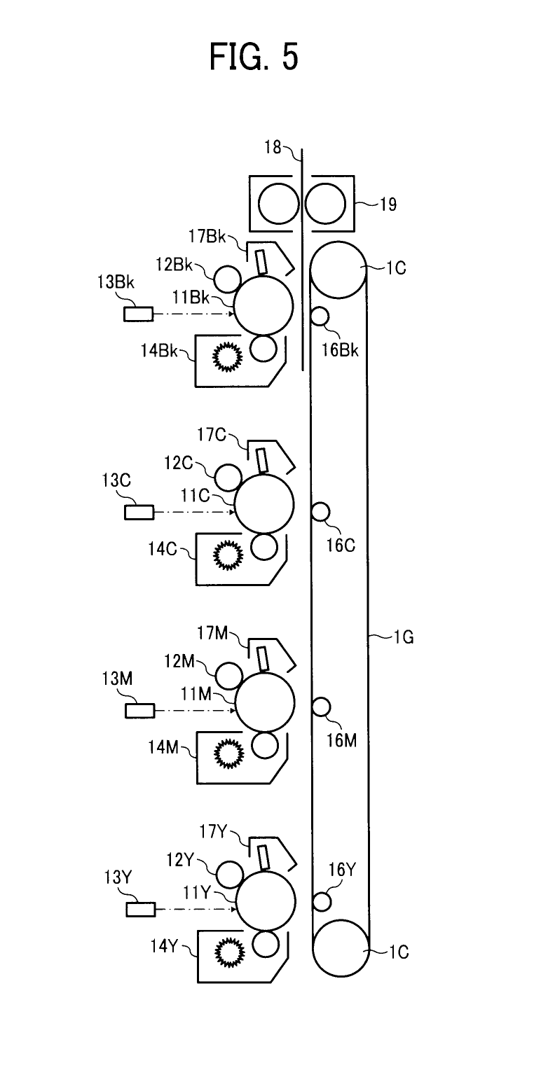

FIG. 5 is a diagram illustrating another example of the image forming apparatus by the present disclosure. This image forming apparatus is a type using toner of four colors of yellow (Y), magenta (M), cyan (C), and black (Bk) and includes the image forming unit for each color. Furthermore, the image bearing members (11Y, 11M, 11C, and 11Bk) are provided for each color.

The sub-surface layer is laminated in the image bearing member 11 for use in this image forming apparatus. Around each of the image bearing members (11Y, 11M, 11C, and 11Bk), there are provided the charger 12, the irradiator 13, the development device 14, the cleaner 17, etc.

In addition, a transfer belt 1G serving as a transfer material bearing member which is configured to be in contact with or separated away from each transfer position of the image bearing members (11Y, 11M, 11C, and 11Bk) arranged in a straight line is suspended over driving devices 1C. The transfer device 16 is provided at the transfer position opposing the image bearing members (11Y, 11M, 11C, and 11Bk) with the transfer belt 1G therebetween. The circulating material 3A and the application blade 3C to apply the circulating material 3A are arranged between the cleaner 11 and the charger 12 relative to the moving direction of the image bearing member 11.

The image forming apparatus employing a tandem system as illustrated in FIG. 5 has the image bearing members (11Y, 11M, 11C, and 11Bk) for respective colors and each color toner image is sequentially transferred to the recording medium 18 borne on the transfer belt 1C. Therefore, in comparison with a full color image forming apparatus having only a single image bearing member, the image forming apparatus employing a tandem system outputs full color images at an extremely high speed.

The toner image developed on the recording medium 18 as a transfer medium is transferred from the position opposing the image bearing member 11Bk and the transfer device 16Bk to the fixing device 19 where the toner image is fixed on the recording medium 18.

In addition to the embodiment illustrated in FIG. 5, another embodiment as illustrated in FIG. 6 is also suitable.

That is, instead of the direct transfer system using the transfer belt 1G illustrated in FIG. 5, another configuration using the intermediate transfer belt 1F illustrated in FIG. 6 is suitable.

In the embodiment illustrated in FIG. 6, the image bearing members (11Y, 11M, 11C, and 11Bk) are provided for respective colors. Each color toner image formed thereon is sequentially transferred to and laminated on the intermediate transfer belt 1F driven by and suspended over driving devices 1C by a primary transfer device 1D to form a full color toner image. Next, the intermediate transfer belt 1F is furthermore driven and the full color toner image borne thereon is transferred to the position between a secondary transfer device 1E and a driven roller 1H arranged opposing the secondary transfer device 1E. The toner image is secondarily transferred to the recording medium 18 by the secondary transfer device 1E to form a desired image.

### Supply of Circulating Material

As illustrated in FIG. 9, as a circulating material supplier to supply the circulating material 3A to the surface of the image bearing member, a circulating material supplier 3 is provided to all of the image forming apparatuses described above. The circulating material supplier 3 has the fur brush 3B as an applicator, the circulating material 3A, a pressing spring to press the circulating material to the direction of the fur brush 3B, and the application blade 3C to apply the circulating material 3A and regulate the thickness thereof.

The circulating material 3A is a circulating material molded to have a bar form. The fur brush 3B is in contact with the surface of the image bearing member 11, scoops up the circulating material 3A by rotating around the axis, and bears, transfers, and applies it to the contact position with the surface of the image bearing member.

In addition, when the circulating material 3A is scraped by the fur brush 3B, thereby shrinking the circulating material 3A, the pressing spring presses the circulating material 3A toward the fur brush 3B with a predetermined pressure in order to keep the circulating material 3A in contact with the fur brush 3B. Therefore, the fur brush 3B constantly and uniformly scoops up even a minute amount of the circulating material 3A.

In addition, it is suitable to provide a circulating material supplier to coat the circulating material to the surface of the image bearing member. This device presses a board like a cleaning blade against the image bearing member in a trailing or counter manner.

Specific examples of the circulating material 3A include, but are not limited to, metal salts of aliphatic acid such as lead oleate, zinc oleate, copper oleate, zinc stearate, cobalt stearate, iron stearate, copper stearate, zinc plamitate, copper palmitate, and zinc linolenate, and fluorine-containing resins such as polytetrafluoroethylene, polychlorotrifluoroethylene, polyvinilidene fluoroide, polytrifluorochloroethylene, dichlorodifluoroethylene, copolymers of tetrafluoroethylene and ethylene, and copolymers of tetrafluoroethylene and oxafluoropropylene. The material taking a lamellar structure is excellent in circulation efficiency and furthermore, zinc stearate is advantageous in terms of cost.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but not limited thereto.

### Example 1

### Manufacturing of Image Forming Apparatus

### Manufacturing of Image Bearing Member

The liquid application of the undercoating layer having the following recipe, the liquid application of the charge generation layer having the following recipe, and the liquid application of the charge transport layer having the following recipe are sequentially applied to an aluminum drum having a thickness of 1 mm, a length of 352 mm, and an outer diameter Φ of 40 mm followed by drying to form an undercoating layer having a thickness of 3.5 μm, a charge generation layer having a thickness of 0.2 μm, and a charge transport layer having a thickness of 22 μm. A liquid application of the sub-surface layer is applied thereto by spray coating. In the spray coating, a spray gun (PC-WIDE 308, manufactured by Olympos Co.), is used with an atomization pressure of 2.5 kgf/cm² with a distance of 50 mm away from the image bearing member. The discharging amount is about 3 cc.

As a result, an image bearing member is obtained which has a sub-surface layer having a thickness of from 3 μm to 4 μm.

The liquid application of the sub-surface layer is prepared by preliminarily placing 100 g of YTZ ball (manufactured by Nikkato Corporation) having a φ of 2 mm in a bin, adding 1.2 g of α-alumina and 10.8 g of a mixture of a dispersant and a solvent (THF), and dispersing the resultant with a vibration strength of 1,600 rpm by a vibration shaker (manufactured by ICA A.G.) for two hours to obtain a mill base followed by addition of a vehicle thereto to obtain the liquid application (paint). Unless otherwise mentioned, the liquid application of the sub-surface layer is prepared in the same manner in the following Examples and Comparative Examples.

### Liquid Application of Undercoating Layer

Alkyd resin solution (Beckolite M6401-50, manufactured by Dainippon Ink and Chemicals, Inc.): 12 parts

Melamine resin (SuperBeckamine G-821-60, manufactured by Dainippon Ink and Chemicals, Inc.): 8.0 parts

Titanium oxide (CR-EL, manufactured by Ishihara Sangyo Kaisha, Ltd.): 40 parts

Methylethylketone: 200 parts

### Liquid Application for Charge Generation Layer

Bisazo pigment (manufactured by Ricoh Co., Ltd.) represented by the following chemical formula 1: 5.0 parts

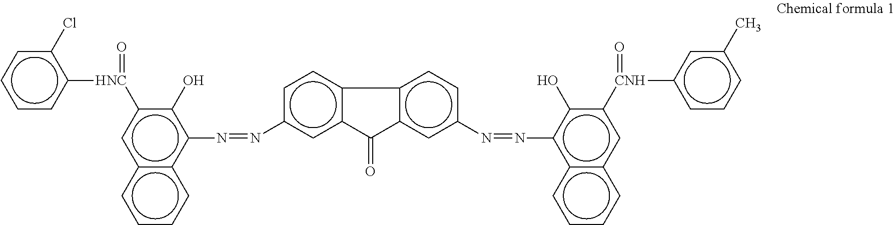

Polyvinyl butyral {XYHL, manufactured by Union Carbide Corporation (UCC)}: 1.0 part

Cyclohexanone: 200 parts

Methylethylketone: 80 parts

### Liquid Application for Charge Transport Layer

Z type polycarbonate (PanLite TS-2050, manufactured by Teijin Chemicals Ltd.): 10 parts

Charge Transport Material represented by the following chemical formula 2: 7.0 parts

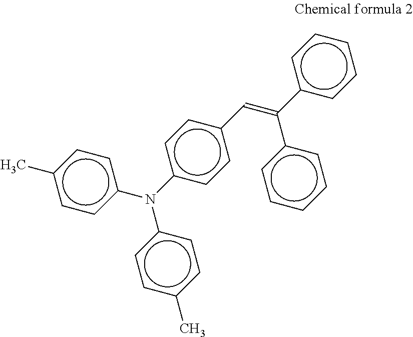

Tetrahydrofuran: 100 parts

Tetrahydrofuran solution of 1% silicone oil (KF-50-100CS, manufactured by Shin-Etsu Chemical Co., Ltd.): 1 part Liquid Application for Sub-surface layer

Charge Transport Material represented by the following chemical formula 3: 43 parts

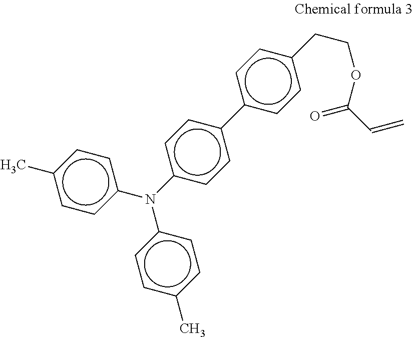

Trimethylol propane triacrylate (KAYARAD TMPTA, manufactured by Nippon Kayaku Corporation): 21 parts

Caprolactone modified dipentaerythritol hexaacrylate (KAYARAD DPCA-120, manufactured by Nippon Kayaku Corporation): 21 parts

Mixture of acrylic group containing polyester modified polydimethyl siloxane and propoxy modified 2-neopentyl glycol diacrylate (BYK-UV 3570, manufactured by BYK Chemie GmbH): 0.1 parts

1-hydroxy-cyclohexy-phenyl-ketone (IRGACURE 184, manufactured by Chiba Specialty Chemicals)}: 4 parts

α-alumina (SUMICORUNDUM AA-03 manufactured by Sumitomo Chemical Co., Ltd.): 10 parts

Dispersant (ED-151, manufactured by Kusumoto Chemicals, Ltd.): 1.0 part Tetrahydrofuran: 566 parts

### Circulating Material

Place zinc stearate (GF200, manufactured by NOF CORPORATION) in a glass container with a lid and stir and melt it by a hot stirrer in which the temperature is controlled from 160° C. to 250° C.

Pour the stirred and melted protective agent into an aluminum die having an inside dimension of 12 mm×8 mm×350 mm preliminarily heated to 150° C. to fill the die. Subsequent to cooling down to 40° C. on a wood board, remove the solid material from the die, and place a weight thereon to prevent it from warping while cooling down to room temperature.

After the cooling down, sever both ends of the solid material in the longitudinal direction and cut the base to obtain a protective bar having a rectangular column form having a dimension of 6 mm×6 mm×322 mm.

Attach a double-faced adhesive tape to the bottom of the protective agent bar to fix it to a metal support.

Circulating material Applicator

The circulating material applicator is attached to the image forming apparatus together with a device to supply the circulating material to the image bearing member and a device to apply the supplied circulating material to the image bearing member.

The device to supply the circulating material presses the application brush with a pressing spring. The pressing spring has a spring constant under which the solid zinc stearate molded to have a rectangular column form to be held by a support is consumed in a predetermined amount. The device scrapes zinc stearate by rotation of the application brush, thereby providing the scraped powder to the image bearing member.

The pressing spring is suitably selected considering the relationship between the spring constant and the consumption amount of the circulating material. A spring is selected which has a spring constant of 0.039 N/mm under the condition that the ratio of the consumption (meaning the decreasing amount of the circulating material, including the amount of loss caused by, for example, scattering and falling from the application brush in addition to the applied amount to the image bearing member) of the circulating material is 125 mg/km.

Movable fins supported by a single point are provided to both sides of the support and the spring is provided therearound to adjust the contact pressure between the application brush and the circulating material by the pulling stress of the spring.

A proper product formed by attaching a fur brush to a metal shaft is used as it is. The application brush rotates counterclockwise relative to the moving direction of the surface of the image bearing member.

The application blade is polyurethane rubber (Shore A hardness: 84, impact resilience: 52%, thickness: 1.3 mm) supported by a blade holder of steel plate which contacts the image bearing member at an angle of 19° in the contact direction thereof.

The image bearing member and the circulating material supplier are installed on the cyan development station of imagio MP C4500 (manufactured by Ricoh Co., Ltd.) as illustrated in FIG. 8. The circulating material supplier is installed in the process cartridge of the image bearing member dedicated for imagio MP C4500 in place of the original circulating material supplier thereto.

The results by preliminary calculation of the application amount of the circulating material to the image bearing member are as follows: 75 mg/km for Examples 1, 2 to 4, Comparative Examples 4, 7, 10, 13, and 16 described later; 15 mg/km for Comparative Examples 1, 3, and 18 to 23; 40 mg/km for Comparative Examples 6, 9, 12, and 15; 115 mg/km for Comparative Examples 2 and 5; and 140 mg/km for Comparative Examples 8, 11, 14, and 17.

### Measuring and Evaluation

### 1. Measuring of Surface Form of Image Bearing Member.

The surface form of the image bearing member is measured by a surface texture and contour measuring instrument (Surfcom 1400D, manufactured by Tokyo Seimitsu Co., Ltd.) under the condition that a pickup (E-DT-S02A) is attached, the measuring length is 12 mm, the number of total sampling is 30,720, and the measuring speed is 0.06 mm/s.

The single dimensional data arrangement of the surface form of the image bearing member obtained by the measuring is subjected to wavelet conversion to conduct multi-resolution analysis (MRA-1) to separate into six frequency components from HHH to HLL. The thus-obtained single dimensional data arrangement of HLL is thinned out in such a manner that the number of data arrangement is reduced to 1/40 to obtain a thinned-out single dimensional data arrangement. The thinned-out single dimensional data arrangement is further subjected to wavelet conversion to conduct multi-resolution analysis (MRA-2) to separate into the six frequency components from LHH to LLL. The arithmetical mean roughness is calculated for each of the thus-obtained 12 frequency components.

This measuring of the surface form is conducted at four places with a gap of 70 mm therebetween for a single image bearing member and the arithmetical mean roughness is calculated for each frequency component for each place.

Wavelet Toolbox of MATLAB (manufactured by The Matworks Inc.) is used as the wavelet conversion. As described above, the wavelet conversion is conducted on two separate occasions in the present disclosure.

The average of the arithmetical mean roughness of each frequency component at the four places is determined as the arithmetical mean roughness WRa of each frequency component of the measuring results.

The measuring results are shown in Table 2. In addition, the surface roughness spectrum is illustrated in FIG. 18.

### 2. Circulation Property Test of Surface of Image Bearing Member.

After conducting continuous printing all the solid image pattern on 1,000 sheets having a size of a length of 296 mm and a width of 210 mm, the image bearing member is taken out of the image forming apparatus. In the test, the charging conditions are set as follows to accelerate damaging the film by charging: DC bias component: −760 V; AC component: Vpp 2.6 kV; AC charging current condition: 1.58 mA.

The deficiency and the thickness of the film of the circulating surface layer are obtained by XPS analysis and XRF analysis for the portion downstream from the application blade and upstream from the development unit when the test of the taken-out image bearing member is complete. XPS analysis is conducted at arbitrary ten points in an area of 10 mm×10 mm by using Quantera SXM. In XRF analysis, preliminarily the standard curve of the zinc analysis value obtained in ICP-AES analysis and XRF analysis value is prepared and the intensity obtained in XRF analysis is compared with the ICP-AES analysis value to obtain the attachment amount.

When the film deficiency is large, the amount of attachment is small so that the layer becomes thin. Therefore, the thickness of the film is not deduced. The value obtained by dividing the mass layer thickness calculated from XRF with the covering ratio calculated by XPS is determined as the average thickness.

ICP-AES analysis is conducted for the sample liquid obtained by decomposition with sulfuric acid and nitric acid by using ICPS-7500 (manufactured by Shimadzu Corporation). XRF analysis is conducted for the film peeled from the surface of the image bearing member with a size of 34 mm×34 mm using ZSX-100e (manufactured by Rigaku Corporation)

Furthermore, the surface corresponding to the portion described above of the image bearing member is observed by a confocal microscope.

The confocal microscope is OPTELICS H1200 (manufactured by Lasertec Corporation) and image data are collected by changing the magnification power of the objective lens to 10 times, 20 times, and 100 times. Among these, the area ratio of foreign object (filming) of the surface of the image bearing member distinguished by observation of an size of 1.776 mm×1.776 mm obtained by the objective lens with a magnifying power of 10 times is calculated by a command of “Analyze particles” of an image analysis software (image J, produced by National Institutes of Health).

The measuring results are shown in Table 3.

### 3. Image Evaluation

Apart from the image forming apparatus for use in 1 and 2, a print test is conducted for another image forming apparatus having the same configuration as in 1 and 2. In the print test, a pattern image in which a band having a width of 34 mm and a length of 210 mm and a band having a width of 34 mm and a length of 105 mm are arranged in parallel to the sheet passing direction is printed with a run length of 100,000.

The test is conducted at the cyan development station.

After the 100,000 sheet printing, a halftone pattern having four dots×four dots in a matrix of eight dots×eight dots with a pixel density of 600 dpi×600 dpi and a blank image pattern are alternately printed on five sheets for each. The background fouling of the blank (white) image is evaluated by naked eyes according to the following criteria. The rough spectrum of the image bearing member is illustrated in FIG. 18. The results are shown in Table 4.

### Criteria

5: Excellent

4: Good

3: Fair

2: Slightly dusky but with no practical problem

1: Dusky

### Comparative Example 1

The image forming apparatus of Comparative Example 1 is manufactured in the same manner as in Example 1 except that a spring is used which has a spring constant of 0.023 N/mm under the condition that the consumption ratio of the circulating material is 75 mg/km. The obtained image forming apparatus is evaluated in the same manner as in Example 1. The evaluation results are shown in Tables 2 to 4.

### Comparative Example 2

The image forming apparatus of Comparative Example 2 is manufactured in the same manner as in Example 1 except that a spring is used which has a spring constant of 0.055 N/mm under the condition that the consumption ratio of the circulating material is 175 mg/km.

The obtained image forming apparatus is evaluated in the same manner as in Example 1. The evaluation results are shown in Tables 2 to 4.

### Example 2

The image forming apparatus of Example 2 is manufactured in the same manner as in Example 1 except that zinc stearate used in the circulating material of Example 1 is changed to zinc oleate (manufactured by Kanto Chemical Co., Inc.).

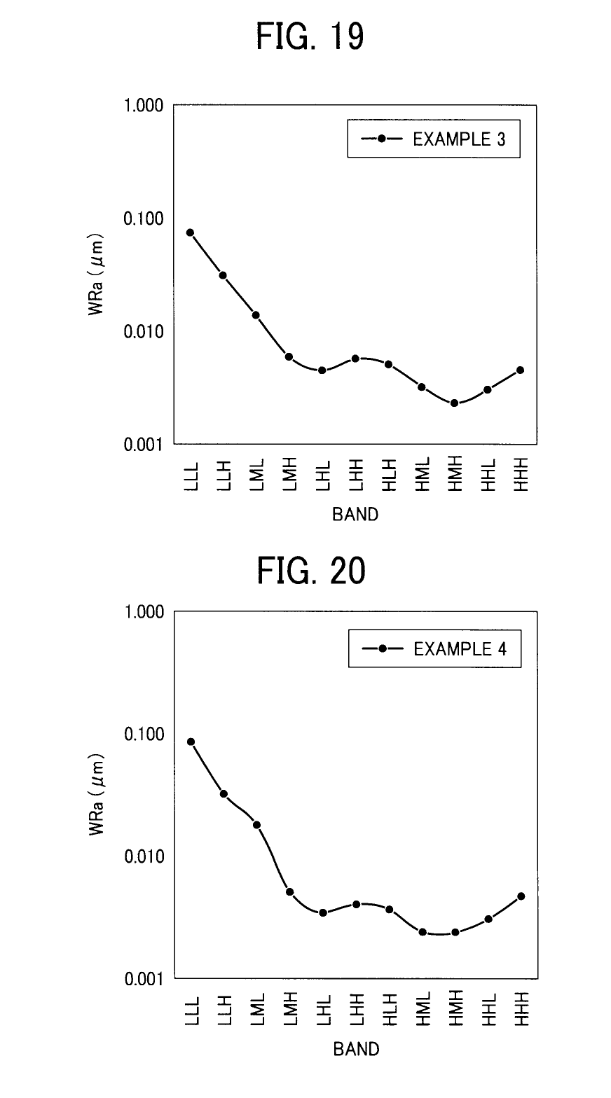

The obtained image forming apparatus is evaluated in the same manner as in Example 1. The rough spectrum of the image bearing member is illustrated in FIG. 19. The evaluation results are shown in Tables 2 to 4.

### Example 3

The image forming apparatus of Example 3 is manufactured in the same manner as in Example 1 except that α-alumina having a primary particle diameter of 0.3 μm for use in the sub-surface layer of the image bearing member of Example 1 is changed to α-alumina having a primary particle diameter of 0.5 μm (AA-05, manufactured by Sumitomo Chemical Co., Ltd.) and a spring is used which has a spring constant of 0.037 N/mm under the condition that the consumption ratio of the circulating material is 125 mg/km.

The obtained image forming apparatus is evaluated in the same manner as in Example 1. The evaluation results are shown in Tables 2 to 4.

### Example 4

The image forming apparatus of Example 1 is manufactured in the same manner as in Example 1 except that the liquid application of the sub-surface layer of the image bearing member is changed to the following liquid application.

The obtained image forming apparatus is evaluated in the same manner as in Example 1. The rough spectrum of the image bearing member is illustrated in FIG. 20. The evaluation results are shown in Tables 2 to 4.

### Liquid Application for Sub-Surface Layer

Charge Transport Material represented by the following chemical formula 4: 43 parts

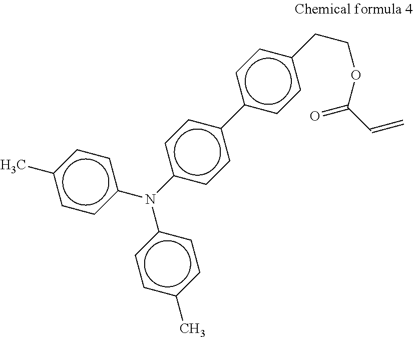

Trimethylol propane triacrylate (KAYARAD TMPTA, manufactured by Nippon Kayaku Corporation): 21 parts

Caprolactone modified dipentaerythritol hexaacrylate (KAYARAD DPCA-120, manufactured by Nippon Kayaku Corporation): 21 parts

Mixture of acrylic group containing polyester modified polydimethyl siloxane and propoxy modified 2-neopentyl glycol diacrylate (BYK-UV 3570, manufactured by BYK Chemie GmbH): 0.1 parts

1-hydroxy-cyclohexy-phenyl-ketone (IRGACURE 184, manufactured by Chiba Specialty Chemicals)}: 4 parts

α-alumina (SUMICORUNDUM AA-03, manufactured by Sumitomo Chemical Co., Ltd.): 9 parts

Dispersant for α-alumina (ED-151, manufactured by Kusumoto Chemicals, Ltd.): 0.9 parts

Tin oxide (NanoTek, SnO₂, manufactured by C. I. Kasei Co., Ltd.): 1 part Dispersant for tin oxide (ED-152, manufactured by Kusumoto Chemicals, Ltd.): 0.1 parts

Tetrahydrofuran: 566 parts

### Comparative Example 3

The image forming apparatus of Comparative Example 3 is manufactured in the same manner as in Example 1 except that α-alumina having a primary particle diameter of 0.3 μm for use in the sub-surface layer of the image bearing member of Example 1 is changed to α-alumina having a primary particle diameter of 0.7 μm (AA-07, manufactured by Sumitomo Chemical Co., Ltd.) and a spring is used which has a spring constant of 0.03 N/mm under the condition that the consumption ratio of the circulating material is 75 mg/km.

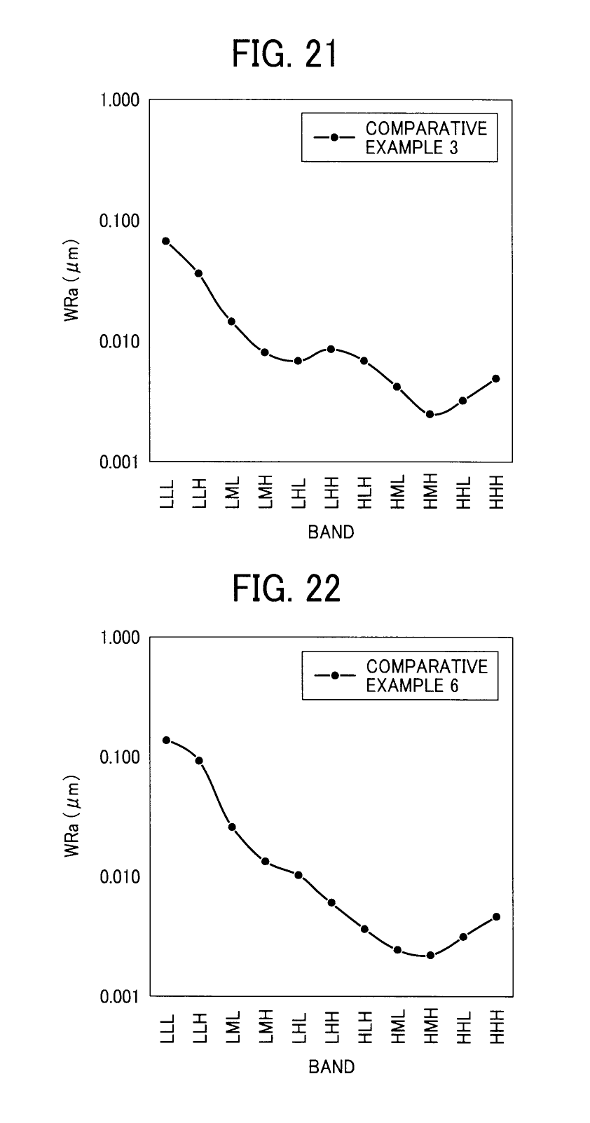

The obtained image forming apparatus is evaluated in the same manner as in Example 1. The rough spectrum of the image bearing member is illustrated in FIG. 21. The evaluation results are shown in Tables 2 to 4.

### Comparative Example 4

The image forming apparatus of Comparative Example 4 is manufactured in the same manner as in Comparative Example 3 except that a spring is used which has a spring constant of 0.05 N/mm under the condition that the consumption ratio of the circulating material is 125 mg/km. The obtained image forming apparatus is evaluated in the same manner as in Example 1. The evaluation results are shown in Tables 2 to 4.

### Comparative Example 5

The image forming apparatus of Comparative Example 5 is manufactured in the same manner as in Comparative Example 3 except that a spring is used which has a spring constant of 0.07 N/mm under the condition that the consumption ratio of the circulating material is 175 mg/km. The obtained image forming apparatus is evaluated in the same manner as in Example 1. The evaluation results are shown in Tables 2 to 4.

### Comparative Example 6

The image forming apparatus of Comparative Example 6 is manufactured in the same manner as in Example 1 except that the liquid application of the sub-surface layer of the image bearing member is changed to the following and a spring is used which has a spring constant of 0.03 N/mm under the condition that the consumption ratio of the circulating material is 75 mg/km.

The obtained image forming apparatus is evaluated in the same manner as in Example 1. The rough spectrum of the image bearing member is illustrated in FIG. 22. The evaluation results are shown in Tables 2 to 4.

### Liquid Application of Sub-Surface Layer

Charge Transport Material represented by the following chemical formula 5: 43 parts

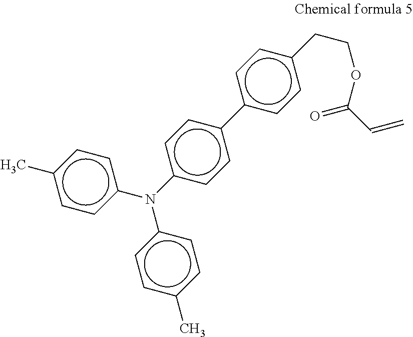

Trimethylol propane triacrylate (KAYARAD TMPTA, manufactured by Nippon Kayaku Corporation): 21 parts

Caprolactone modified dipentaerythritol hexaacrylate (KAYARAD DPCA-120, manufactured by Nippon Kayaku Corporation): 21 parts

Mixture of acrylic group containing polyester modified polydimethyl siloxane and propoxy modified 2-neopentyl glycol diacrylate (BYK-UV 3570, manufactured by BYK Chemie GmbH): 0.1 parts

1-hydroxy-cyclohexy-phenyl-ketone (IRGACURE 184, manufactured by Chiba Specialty Chemicals)}: 4 parts

α-alumina (SUMICORUNDUM AA-03, manufactured by Sumitomo Chemical Co., Ltd.): 7 parts

Dispersant (BYK-P104, manufactured by BYK Chemie GmbH): 0.2 parts

Tetrahydrofuran: 566 parts

### Comparative Example 7

The image forming apparatus of Comparative Example 7 is manufactured in the same manner as in Comparative Example 6 except that a spring is used which has a spring constant of 0.05 N/mm under the condition that the consumption ratio of the circulating material is 125 mg/km. The obtained image forming apparatus is evaluated in the same manner as in Example 1. The evaluation results are shown in Tables 2 to 4.

### Comparative Example 8

The image forming apparatus of Comparative Example 8 is manufactured in the same manner as in Comparative Example 6 except that a spring is used which has a spring constant of 0.07 N/mm under the condition that the consumption ratio of the circulating material is 175 mg/km. The obtained image forming apparatus is evaluated in the same manner as in Example 1. The evaluation results are shown in Tables 2 to 4.

### Comparative Example 9

The image forming apparatus of Comparative Example 9 is manufactured in the same manner as in Example 1 except that the dispersant for use in the sub-surface layer of the image bearing member is changed to DOPA 33 (manufactured by Kyoeisha Chemical Co., Ltd.) and a spring is used which has a spring constant of 0.027 N/mm under the condition that the consumption ratio of the circulating material is 75 mg/km.

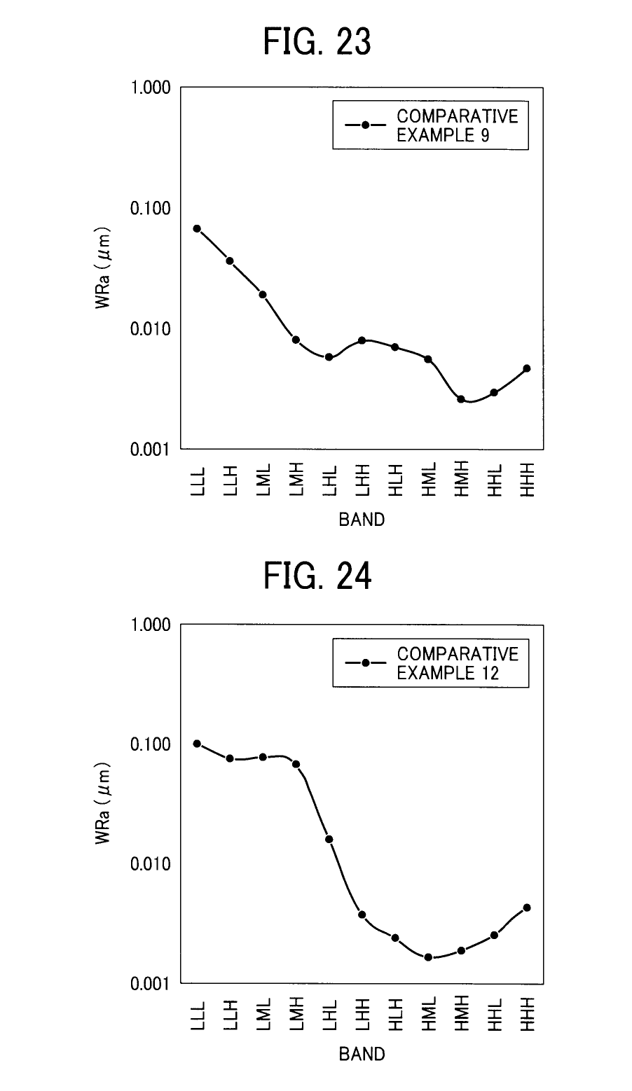

The obtained image forming apparatus is evaluated in the same manner as in Example 1. The rough spectrum of the image bearing member is illustrated in FIG. 23. The evaluation results are shown in Tables 2 to 4.

### Comparative Example 10

The image forming apparatus of Comparative Example 10 is manufactured in the same manner as in Comparative Example 9 except that a spring is used which has a spring constant of 0.045 N/mm under the condition that the consumption ratio of the circulating material is 125 mg/km.

The obtained image forming apparatus is evaluated in the same manner as in Example 1. The evaluation results are shown in Tables 2 to 4.

### Comparative Example 11

The image forming apparatus of Comparative Example 11 is manufactured in the same manner as in Comparative Example 9 except that a spring is used which has a spring constant of 0.063 N/mm under the condition that the consumption ratio of the circulating material is 175 mg/km. The obtained image forming apparatus is evaluated in the same manner as in Example 1. The evaluation results are shown in Tables 2 to 4.

### Comparative Example 12

The image forming apparatus of Comparative Example 12 is manufactured in the same manner as in Example 1 except that α-alumina for use in the sub-surface layer of the image bearing member is changed to organic fillers (functional particulates MP-300, manufactured by Soken Chemical & Engineering Co., Ltd.) and a spring is used which has a spring constant of 0.025 N/mm under the condition that the consumption ratio of the circulating material is 75 mg/km. The obtained image forming apparatus is evaluated in the same manner as in Example 1. The rough spectrum of the image bearing member is illustrated in FIG. 24. The evaluation results are shown in Tables 2 to 4.

### Comparative Example 13

The image forming apparatus of Comparative Example 13 is manufactured in the same manner as in Comparative Example 12 except that a spring is used which has a spring constant of 0.042 N/mm under the condition in which the consumption ratio of the circulating material is 125 mg/km.

The obtained image forming apparatus is evaluated in the same manner as in Example 1. The evaluation results are shown in Tables 2 to 4.

### Comparative Example 14

The image forming apparatus of Comparative Example 14 is manufactured in the same manner as in Comparative Example 12 except that a spring is used which has a spring constant of 0.058 N/mm under the condition that the consumption ratio of the circulating material is 175 mg/km.

The obtained image forming apparatus is evaluated in the same manner as in Example 1. The evaluation results are shown in Tables 2 to 4.

### Comparative Example 15

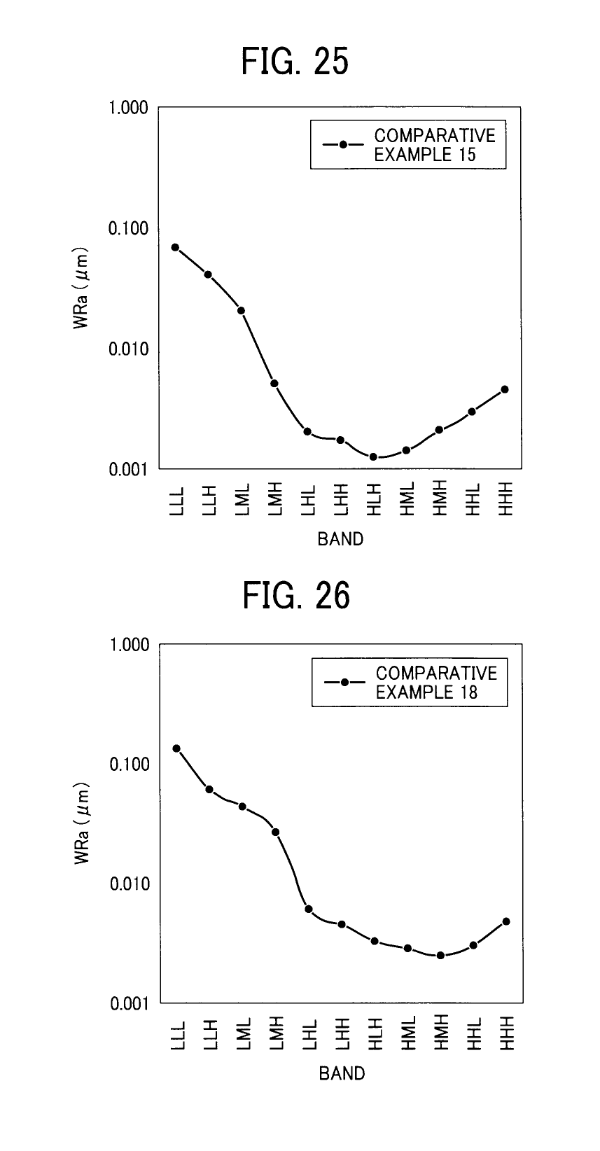

The image forming apparatus of Comparative Example 15 is manufactured in the same manner as in Example 1 except that α-alumina and the dispersant for use in the sub-surface layer of the image bearing member are removed and the content of tetrahydrofuran is changed from 566 parts to 504 parts, and a spring is used which has a spring constant of 0.029 N/mm under the condition that the consumption ratio of the circulating material is 75 mg/km. The obtained image forming apparatus is evaluated in the same manner as in Example 1. The rough spectrum of the image bearing member is illustrated in FIG. 25 and the evaluation results are shown in Tables 2 to 4.

### Comparative Example 16

The image forming apparatus of Comparative Example 16 is manufactured in the same manner as in Comparative Example 15 except that a spring is used which has a spring constant of 0.048 N/mm under the condition that the consumption ratio of the circulating material is 125 mg/km. The obtained image forming apparatus is evaluated in the same manner as in Example 1. The evaluation results are shown in Tables 2 to 4.

### Comparative Example 17

The image forming apparatus of Comparative Example 17 is manufactured in the same manner as in Comparative Example 15 except that a spring is used which has a spring constant of 0.067 N/mm under the condition that the consumption ratio of the circulating material is 175 mg/km. The obtained image forming apparatus is evaluated in the same manner as in Example 1. The evaluation results are shown in Tables 2 to 4.

### Comparative Example 18

The image forming apparatus of Comparative Example 18 is manufactured in the same manner as in Example 1 except that the liquid application of the sub-surface layer of the image bearing member is changed to the following and a spring is used which has a spring constant of 0.021 N/mm under the condition that the consumption ratio of the circulating material is 75 mg/km.

The obtained image forming apparatus is evaluated in the same manner as in Example 1. The evaluation results are shown in Tables 2 to 4. The rough spectrum of the image bearing member is illustrated in FIG. 26.

### Liquid Application of Sub-Surface Layer

Z type polycarbonate (PanLite TS-2050, manufactured by Teijin Chemicals Ltd.): 10 parts

Charge Transport Material represented by the following chemical formula 6: 7 parts

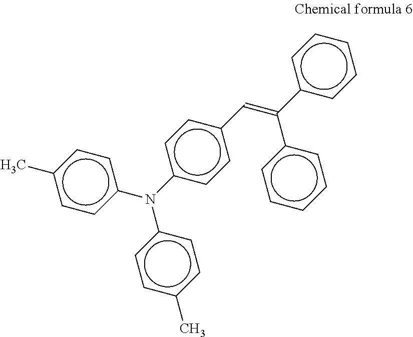

α-alumina (SUMICORUNDUM AA-03 manufactured by Sumitomo Chemical Co., Ltd.): 5.7 parts

Dispersant (BYK-P104, manufactured by BYK Chemie GmbH): 0.014 parts

Tetrahydrofuran: 280 parts

Cyclohexanone: 80 parts

### Comparative Example 19

The image forming apparatus of Comparative Example 19 is manufactured in the same manner as in Comparative Example 18 except that α-alumina and the dispersant for use in the sub-surface layer of the image bearing member is removed and the content of tetrahydrofuran is changed from 566 parts to 504 parts, and a spring is used which has a spring constant of 0.036 N/mm under the condition that the consumption ratio of the circulating material is 125 mg/km.

The obtained image forming apparatus is evaluated in the same manner as in Example 1. The evaluation results are shown in Tables 2 to 4.

### Comparative Example 20

The image forming apparatus of Comparative Example 20 is manufactured in the same manner as in Comparative Example 18 except that a spring is used which has a spring constant of 0.05 N/mm under the condition that the consumption ratio of the circulating material is 175 mg/km. The obtained image forming apparatus is evaluated in the same manner as in Example 1. The evaluation results are shown in Tables 2 to 4.

### Comparative Example 21

The image forming apparatus of Comparative Example 21 is manufactured in the same manner as in Example 1 except that the circulating material applicator is changed to the following device.

The obtained image forming apparatus is evaluated in the same manner as in Example 1. The evaluation results are shown in Tables 2 to 4.

### Circulating Material Applicator

The circulating material applicator is attached to the image forming apparatus together with a device to supply the circulating material to the image bearing member and a device to apply the supplied circulating material to the image bearing member.

The device to supply the circulating material presses the application brush with a pressing spring. The pressing spring has a spring constant under which the solid zinc stearate molded to have a rectangular column form to be held by a support is consumed in a predetermined amount. The device scrapes zinc stearate by rotation of the application brush, thereby providing the scraped powder to the image bearing member.

The pressing spring is suitably selected considering the relationship between the spring constant and the consumption amount of the circulating material. A spring is used which has a spring constant of 0.2 N/mm under the condition that the consumption ratio of the circulating material is 75 mg/km. Compression springs are provided to both sides of the support to adjust the contact pressure between the application brush and the circulating material by the stress of the spring.

A proper product formed by attaching a fur brush to a metal shaft is used as it is. The application brush rotates counterclockwise relative to the moving direction of the surface of the image bearing member.

The application blade is polyurethane rubber (Shore A hardness: 84, impact resilience: 52%, thickness: 1.3 mm) supported by a blade holder of steel plate which contacts the image bearing member at an angle of 19° in the contact direction thereof.

The image bearing member and the circulating material supplier are installed on the cyan development station of imagio NeoC 455 (manufactured by Ricoh Co., Ltd.) illustrated in FIG. 7. The circulating material applicator is arranged upstream from the cleaner. The application blade has the feature of the cleaning blade. The cleaning blade also used as the application blade is a proper product.

### Comparative Example 22

The image forming apparatus of Comparative Example 22 is manufactured in the same manner as in Comparative Example 18 except that a spring is used which has a spring constant of 0.47 N/mm under the condition in which the consumption ratio of the circulating material of Comparative Example 21 is 125 mg/km. The obtained image forming apparatus is evaluated in the same manner as in Example 1. The evaluation results are shown in Tables 2 to 4.

### Comparative Example 23

The image forming apparatus of Comparative Example 23 is manufactured in the same manner as in Comparative Example 22 except that a spring is used which has a spring constant of 0.66 N/mm under the condition in which the consumption ratio of the circulating material of Comparative Example 21 is 175 mg/km. The obtained image forming apparatus is evaluated in the same manner as in Example 1. The evaluation results are shown in Tables 2 to 4.

### Example 5

### Manufacturing of Image Forming Apparatus

### Manufacturing of Image Bearing Member

The liquid application of the undercoating layer having the following recipe, the liquid application of the charge generation layer having the following recipe, and the liquid application of the charge transport layer having the following recipe are sequentially applied to an aluminum drum having a thickness of 1 mm, a length of 352 mm, and an outer diameter φ of 40 mm followed by drying to form an undercoating layer having a thickness of 3.5 μm, a charge generation layer having a thickness of 0.2 μm, and a charge transport layer having a thickness of 22 μm. A liquid application of the sub-surface layer is applied thereto by spray coating. In the spray coating, a spray gun (PC-WIDE 308, manufactured by Olympos Co.), is used with an atomization pressure of 2.5 kgf/cm² with a distance of 50 mm away from the image bearing member. The discharging amount is about 3 cc.

As a result, an image bearing member is obtained which has a sub-surface layer having a thickness of from 3 μm to 4 μm.

The surface form is intentionally controlled by changing the dispersion time of the mill base when preparing the liquid application of the sub-surface layer. The rough spectrum of the image bearing member is illustrated in FIG. 34.

### Liquid Application of Undercoating Layer

Alkyd resin solution (Beckolite M6401-50, manufactured by Dainippon Ink and Chemicals, Inc.): 12 parts

Melamine resin (SuperBeckamine G-821-60, manufactured by Dainippon Ink and Chemicals, Inc.): 8.0 parts

Titanium oxide (CR-EL, manufactured by Ishihara Sangyo Kaisha, Ltd.): 40 parts

Methylethylketone: 200 parts

### Liquid Application of Charge Generation Layer

Bisazo pigment (manufactured by Ricoh Co., Ltd.) represented by the following chemical formula 7: 5.0 parts

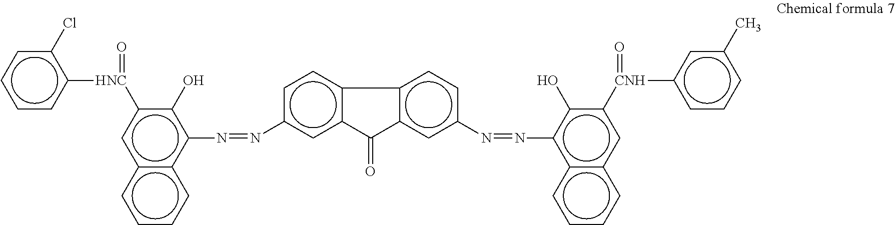

Polyvinyl butyral {XYHL, manufactured by Union Carbide Corporation (UCC)}: 1.0 part

Cyclohexanone: 200 parts

Methylethylketone: 80 parts

### Liquid Application of Charge Transport Layer

Z type polycarbonate (PanLite TS-2050, manufactured by Teijin Chemicals Ltd.): 10 parts

Charge Transport Material represented by the following chemical formula 8: 7.0 parts

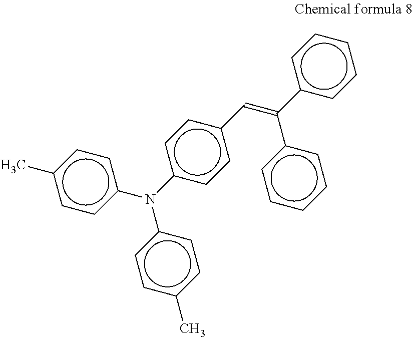

Tetrahydrofuran: 100 parts

Tetrahydrofuran solution of 1% silicone oil (KF-50-100CS, manufactured by Shin-Etsu Chemical Co., Ltd.): 1 part

### Liquid Application of Sub-Surface Layer

Charge Transport Material represented by the following chemical formula 9: 43 parts

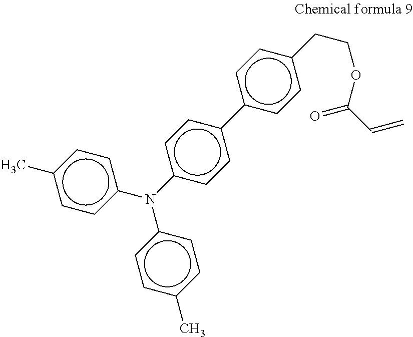

Trimethylol propane triacrylate (KAYARAD TMPTA, manufactured by Nippon Kayaku Corporation): 21 parts

Caprolactone modified dipentaerythritol hexaacrylate (KAYARAD DPCA-120, manufactured by Nippon Kayaku Corporation): 21 parts

Mixture of acrylic group containing polyester modified polydimethyl siloxane and propoxy modified 2-neopentyl glycol diacrylate (BYK-UV3570, manufactured by BYK Chemie GmbH): 0.1 parts

1-hydroxy-cyclohexy-phenyl-ketone (IRGACURE 184, manufactured by Chiba Specialty Chemicals)}: 4 parts

α-alumina (SUMICORUNDUM AA-03 manufactured by Sumitomo Chemical Co., Ltd.): 10 parts

Dispersant (ED-151, manufactured by Kusumoto Chemicals, Ltd.): 1.0 part

Tetrahydrofuran: 566 parts

Circulating Material

Place zinc stearate (GF200, manufactured by NOF CORPORATION) in a glass container with a lid and stir and melt it by a hot stirrer the temperature of which is controlled to be from 160° C. to 250° C.

Pour the stirred and melted protective agent into an aluminum die having an inside dimension of 12 mm×8 mm×350 mm preliminarily heated to 150° C. to fill the die. Subsequent to cooling down to 40° C. on a wood board, remove the solid material from the die and place a weight thereon to prevent it from warping while cooling down to room temperature.

After the cooling down, sever both ends of the solid material in the longitudinal direction and cut the base to obtain a protective bar having a rectangular column form having an dimension of 6 mm×6 mm×322 mm.

Attach a double-faced adhesive tape to the bottom of the protective agent bar to fix it to a metal support.

### Circulating Material Applicator

The circulating material applicator is attached to an image forming apparatus together with a device to supply the circulating material to the image bearing member and a device to apply the supplied circulating material to the image bearing member.

The device to supply the circulating material presses the application brush with a pressing spring. The pressing spring has a spring constant under which the solid zinc stearate molded to have a rectangular column form to be held by a support is consumed in a predetermined amount. The device scrapes zinc stearate by rotation of the application brush, thereby providing the scraped powder to the image bearing member.

The pressing spring is suitably selected considering the relationship between the spring constant and the consumption amount of the circulating material. A spring is selected which has a spring constant of 0.039 N/mm under the condition that the ratio of the consumption (meaning the decreasing amount of the circulating material, including the amount of loss caused by, for example, scattering and falling from the application brush in addition to the applied amount to the image bearing member) of the circulating material is 125 mg/km.

Movable fins supported by a single point are provided to both sides of the support and the spring is provided therearound to adjust the contact pressure between the application brush and the circulating material by the pulling stress of the spring.

A proper product formed by attaching a fur brush with a metal shaft is used as it is. The application brush rotates counterclockwise relative to the moving direction of the surface of the image bearing member.

The application blade is polyurethane rubber (Shore A hardness: 84, impact resilience: 52%, thickness: 1.3 mm) supported by a blade holder of steel plate which contacts the image bearing member at an angle of 19° C. in the contact direction thereof.

The image bearing member and the circulating material supplier are installed on the magenta development station of imagio MP C4500 (manufactured by Ricoh Co., Ltd.) as illustrated in FIG. 8. The circulating material supplier is installed in the process cartridge of the image bearing member dedicated for imagio MP C4500 in place of the original circulating material supplier.

The application amount of the circulating material to the image bearing member is 75 mg/km according to the preliminary calculation.

40% of the consumption amount of the circulating material is collected as powder not supplied to the surface of the image bearing member. This is deduced to be caused by scattering and falling of the circulating material from the application brush.

Furthermore, when the concentration of the circulating material contained in the collected toner is obtained by XRF (X-ray fluorescence), the amount of scattering and falling is found to amount up to an amount of 60% of the consumption amount of the circulating material.

### Measuring and Evaluation

After the print test in which the solid image pattern corresponding to 2,500 rpm and 25,000 rpm of the image bearing drum is printed on the entire of a sheet is conducted using the image bearing members and the image forming apparatuses, the image bearing member is taken out of the image forming apparatus. The number of printouts is 951 sheets having a size of a length of 296 mm and a width of 210 mm for the former and, 9,500, for the latter.

To obtain the attachment amount of the circulating material, the surface of the image bearing member is air-blown by a compressed air of 4 MPa when the test is stopped and thereafter three downstream portions slightly away from the circulating material applied portion when the test is stopped relative to the circumference direction of the image bearing drum are peeled off in the longitudinal direction of the image bearing member in a size of 34 mm×34 mm with an equal gap therebetween.

The mass layer thickness of the peeled-off film is calculated by XRF analysis according to the method described above. The rough spectrum of the image bearing member is illustrated in FIG. 28. The evaluation results are shown in Table 5.

In addition to the above-mentioned, as in Example 1, the form of the surface of the image bearing member is measured, the circulation property on the surface of the image bearing member is tested, and the images are evaluated.

### Example 6

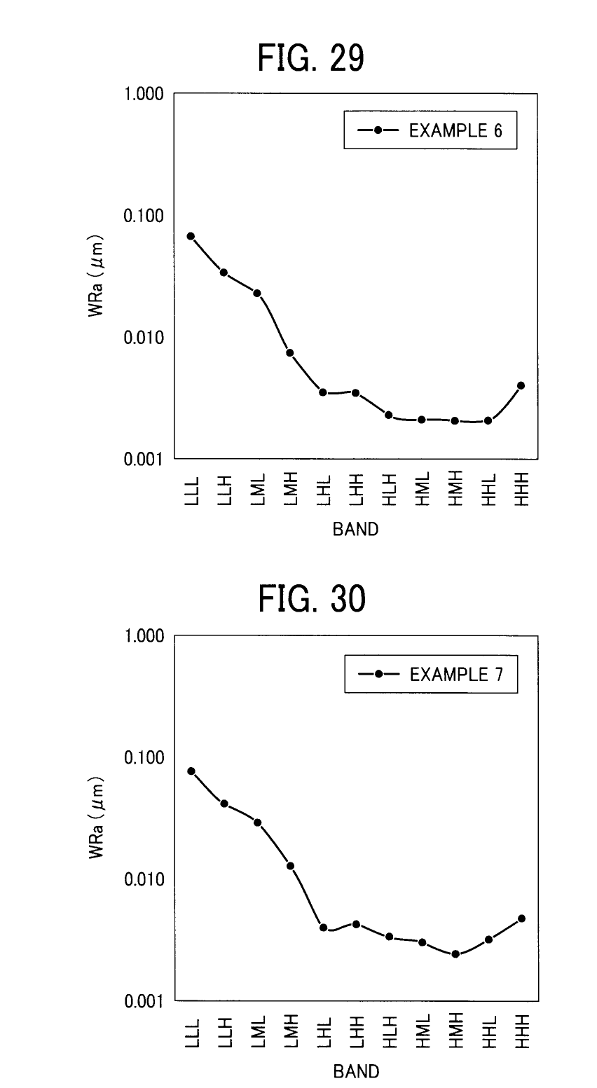

The image bearing member, the circulating material, and the circulating material applicator of Example 6 are manufactured in the same manner as in Example 5 except that 1.0 part of the dispersant (ED-151, manufactured by Kusumoto Chemicals, Ltd.) of the liquid application of the sub-surface layer is changed to 0.35 parts of ED-151 and 0.65 parts of the dispersant (WK-13E, manufactured by Kyoeisha Chemical Co., Ltd.). In addition, the same test as in Example 5 is conducted for Example 6. The rough spectrum of the image bearing member is illustrated in FIG. 29. The evaluation results are shown in Table 5.

### Example 7

The image bearing member, the circulating material, and the circulating material applicator of Example 7 are manufactured in the same manner as in Example 5 except that 1.0 part of the dispersant (ED-151, manufactured by Kusumoto Chemicals, Ltd.) of the liquid application of the sub-surface layer is changed to 1 part of the dispersant (Superdyne V-201, manufactured by Takemoto Oil & Fat Co., Ltd.). In addition, the same test as in Example 5 is conducted for Example 7. The rough spectrum of the image bearing member is illustrated in FIG. 30. The evaluation results are shown in Table 5.

### Comparative Example 24

In Comparative Example 24, the test is conducted in the same manner as in Example 5 except that the image bearing member and the image forming apparatus of Comparative Example 8 are used.

The evaluation results for Examples and Comparative Examples are shown in Tables 2 to 4.

The evaluation results are further shown in Table 5 for Examples 5 to 7 and Comparative Examples 24. In Comparative Example 24, the test is conducted in the same manner as in Example 5 except that the image bearing member and the image forming apparatus of Comparative Example 8 are used.

The evaluation results for Examples and Comparative Examples are shown in Tables 2 to 4.

The evaluation results are further shown in Table 5 for Examples 5 to 7 and Comparative Examples 24.

TABLE 2-1

| | HHH | HHL | HMH | HML | HLH |
|---|---|---|---|---|---|
| Example 1 | 0.004 | 0.003 | 0.002 | 0.003 | 0.003 |
| Example 2 | Same as Example 1 | | | | |
| Example 3 | 0.005 | 0.003 | 0.002 | 0.003 | 0.005 |
| Example 4 | 0.005 | 0.003 | 0.002 | 0.002 | 0.004 |
| Example 5 | 0.004 | 0.002 | 0.002 | 0.002 | 0.003 |
| Example 6 | 0.004 | 0.002 | 0.002 | 0.002 | 0.002 |
| Example 7 | 0.005 | 0.003 | 0.002 | 0.003 | 0.003 |
| Comparative | Same as Example 1 | | | | |
| Example 1 | | | | | |
| Comparative | Same as Example 1 | | | | |
| Example 2 | | | | | |
| Comparative | 0.005 | 0.003 | 0.002 | 0.004 | 0.007 |
| Example 3 | | | | | |
| Comparative | Same as Comparative Example 3 | | | | |
| Example 4 | | | | | |
| Comparative | Same as Comparative Example 3 | | | | |
| Example 5 | | | | | |
| Comparative | 0.005 | 0.003 | 0.002 | 0.002 | 0.004 |
| Example 6 | | | | | |
| Comparative | Same as Comparative Example 6 | | | | |
| Example 7 | | | | | |
| Comparative | Same as Comparative Example 6 | | | | |
| Example 8 | | | | | |
| Comparative | 0.005 | 0.003 | 0.003 | 0.005 | 0.007 |
| Example 9 | | | | | |
| Comparative | Same as Comparative Example 9 | | | | |
| Example 10 | | | | | |
| Comparative | Same as Comparative Example 9 | | | | |
| Example 11 | | | | | |
| Comparative | 0.004 | 0.003 | 0.002 | 0.002 | 0.002 |
| Example 12 | | | | | |
| Comparative | Same as Comparative Example 12 | | | | |
| Example 13 | | | | | |
| Comparative | Same as Comparative Example 12 | | | | |
| Example 14 | | | | | |
| Comparative | 0.005 | 0.003 | 0.002 | 0.001 | 0.001 |
| Example 15 | | | | | |
| Comparative | Same as Comparative Example 15 | | | | |
| Example 16 | | | | | |
| Comparative | Same as Comparative Example 15 | | | | |
| Example 17 | | | | | |
| Comparative | 0.005 | 0.003 | 0.002 | 0.003 | 0.003 |
| Example 18 | | | | | |

| | |
|---|---|
| Comparative | Same as Comparative Example 18 |
| Example 19 | |
| Comparative | Same as Comparative Example 18 |
| Example 20 | |
| Comparative | Same as Example 1 |
| Example 21 | |
| Comparative | Same as Example 1 |
| Example 22 | |
| Comparative | Same as Example 1 |
| Example 23 | |
| Comparative | Same as Comparative Example 6 |
| Example 24 | |

TABLE 2-2

| | LHH | LHL | LMH | LML | LLH | LLL |
|---|---|---|---|---|---|---|
| Example 1 | 0.003 | 0.003 | 0.004 | 0.015 | 0.027 | 0.083 |
| Example 2 | Same as Example 1 | | | | | |
| Example 3 | 0.006 | 0.005 | 0.006 | 0.014 | 0.031 | 0.074 |
| Example 4 | 0.004 | 0.003 | 0.005 | 0.018 | 0.032 | 0.087 |
| Example 5 | 0.004 | 0.004 | 0.012 | 0.028 | 0.038 | 0.078 |
| Example 6 | 0.003 | 0.003 | 0.007 | 0.023 | 0.033 | 0.066 |
| Example 7 | 0.004 | 0.004 | 0.012 | 0.028 | 0.040 | 0.075 |
| Comparative | Same as Example 1 | | | | | |
| Example 1 | | | | | | |
| Comparative | Same as Example 1 | | | | | |
| Example 2 | | | | | | |
| Comparative | 0.008 | 0.007 | 0.008 | 0.014 | 0.035 | 0.066 |
| Example 3 | | | | | | |
| Comparative | Same as Comparative Example 3 | | | | | |
| Example 4 | | | | | | |
| Comparative | Same as Comparative Example 3 | | | | | |
| Example 5 | | | | | | |
| Comparative | 0.006 | 0.010 | 0.013 | 0.026 | 0.092 | 0.135 |
| Example 6 | | | | | | |
| Comparative | Same as Comparative Example 6 | | | | | |
| Example 7 | | | | | | |
| Comparative | Same as Comparative Example 6 | | | | | |
| Example 8 | | | | | | |
| Comparative | 0.008 | 0.006 | 0.008 | 0.019 | 0.036 | 0.070 |
| Example 9 | | | | | | |
| Comparative | Same as Comparative Example 9 | | | | | |
| Example 10 | | | | | | |
| Comparative | Same as Comparative Example 9 | | | | | |
| Example 11 | | | | | | |
| Comparative | 0.004 | 0.016 | 0.068 | 0.078 | 0.074 | 0.102 |
| Example 12 | | | | | | |
| Comparative | Same as Comparative Example 12 | | | | | |
| Example 13 | | | | | | |
| Comparative | Same as Comparative Example 12 | | | | | |
| Example 14 | | | | | | |
| Comparative | 0.002 | 0.002 | 0.005 | 0.020 | 0.041 | 0.069 |
| Example 15 | | | | | | |

| Comparative | Same as Comparative Example 15 | | | | | |
|---|---|---|---|---|---|---|
| Example 16 | | | | | | |
| Comparative | Same as Comparative Example 15 | | | | | |
| Example 17 | | | | | | |
| Comparative | 0.004 | 0.006 | 0.027 | 0.044 | 0.060 | 0.130 |
| Example 18 | | | | | | |

| | |
|---|---|
| Comparative | Same as Comparative Example 18 |
| Example 19 | |
| Comparative | Same as Comparative Example 18 |
| Example 20 | |
| Comparative | Same as Example 1 |
| Example 21 | |
| Comparative | Same as Example 1 |
| Example 22 | |
| Comparative | Same as Example 1 |
| Example 23 | |
| Comparative | Same as Comparative Example 6 |
| Example 24 | |

TABLE 3

| | | Layer thickness | Filming area ratio |
|---|---|---|---|
| | Film deficiency (%) | (molecule) | (%) |
| Example 1 | 8 | 2 | 0.6 |
| Example 2 | 8 | 2 | 0.6 |
| Example 3 | 9 | 2 | 1.1 |
| Example 4 | 9 | 2 | 1.4 |
| Example 5 | 6 | 2 | 0.4 |
| Example 6 | 6 | 2 | 0.3 |
| Example 7 | 9 | 2 | 1.5 |
| Comparative | 16 | 3 | 7.9 |
| Example 1 | | | |
| Comparative | 8 | 3 | 8.8 |
| Example 2 | | | |
| Comparative | 23 | 3 | 10.6 |
| Example 3 | | | |
| Comparative | 20 | 3 | 7.4 |
| Example 4 | | | |
| Comparative | 16 | 3 | 10.4 |
| Example 5 | | | |
| Comparative | 20 | 3 | 7.0 |
| Example 6 | | | |
| Comparative | 16 | 3 | 7.8 |
| Example 7 | | | |
| Comparative | 12 | 2 | 10.4 |
| Example 8 | | | |
| Comparative | 24 | 3 | 9.8 |
| Example 9 | | | |
| Comparative | 21 | 3 | 11.1 |
| Example 10 | | | |
| Comparative | 19 | 3 | 14.7 |
| Example 11 | | | |
| Comparative | 24 | 3 | 9.6 |
| Example 12 | | | |
| Comparative | 21 | 3 | 11.1 |
| Example 13 | | | |
| Comparative | 19 | 3 | 14.7 |
| Example 14 | | | |
| Comparative | 21 | 3 | 8.1 |
| Example 15 | | | |
| Comparative | 17 | 3 | 8.4 |
| Example 16 | | | |
| Comparative | 16 | 3 | 11.1 |
| Example 17 | | | |
| Comparative | 22 | 2 | 10.0 |
| Example 18 | | | |
| Comparative | 18 | 2 | 6.2 |
| Example 19 | | | |
| Comparative | 13 | 3 | 8.7 |
| Example 20 | | | |
| Comparative | 21 | 3 | 9.6 |
| Example 21 | | | |
| Comparative | 18 | 3 | 6.8 |
| Example 22 | | | |
| Comparative | 15 | 3 | 9.9 |
| Example 23 | | | |
| Comparative | 12 | 2 | 10.4 |
| Example 24 | | | |

TABLE 4

| | Image evaluation | Memo |
|---|---|---|
| Example 1 | 5 | Particularly good |
| Example 2 | 5 | Particularly good |
| Example 3 | 5 | Particularly good |
| Example 4 | 5 | Particularly good |
| Example 5 | 5 | Particularly good |
| Example 6 | 5 | Particularly good |
| Example 7 | 4 | Good |
| Comparative | 3 | |
| Example 1 | | |
| Comparative | 3 | Blank observed in |
| Example 2 | | the band image in |
| | | the durability test |
| Comparative | 2 | Image flow having |
| Example 3 | | streak forms |
| | | observed |
| Comparative | 3 | |
| Example 4 | | |
| Comparative | 2 | Significant |
| Example 5 | | contamination of |
| | | the development |
| | | device |
| Comparative | 3 | Image flow having |
| Example 6 | | streak forms |
| | | observed |
| Comparative | 3 | Contamination in |
| Example 7 | | the development |
| | | device |
| Comparative | 2 | Significant |
| Example 8 | | contamination of |
| | | the development |
| | | device |
| Comparative | 2 | Image flow having |
| Example 9 | | streak forms |
| | | observed |
| Comparative | 2 | Contamination of |
| Example 10 | | the development |
| | | device |
| Comparative | 1 | Significant |
| Example 11 | | contamination of |
| | | the development |
| | | device |
| Comparative | 2 | Image flow having |
| Example 12 | | streak forms |
| | | observed |
| Comparative | 2 | Contamination of |
| Example 13 | | the development |
| | | device |
| Comparative | 1 | Significant |
| Example 14 | | contamination of |
| | | the development |
| | | device |
| Comparative | 3 | Image flow having |
| Example 15 | | streak forms |
| | | observed |
| Comparative | 3 | Contamination of |
| Example 16 | | the development |
| | | device |
| Comparative | 2 | Significant |
| Example 17 | | contamination of |
| | | the development |
| | | device |
| Comparative | 2 | Image flow having |
| Example 18 | | streak forms |
| | | observed |
| Comparative | 3 | |
| Example 19 | | |
| Comparative | 3 | Significant |
| Example 20 | | contamination of |
| | | the development |
| | | device |
| Comparative | 2 | Image flow having |
| Example 21 | | streak forms |
| | | observed |
| Comparative | 3 | |
| Example 22 | | |
| Comparative | 2 | Significant |
| Example 23 | | contamination of |
| | | the development |
| | | device |
| Comparative | 2 | Same as |
| Example 24 | | Comparative |
| | | Example 8 |

TABLE 5
Mass layer thickness (Change in the consumption rate of lubricant
due to the abrasion resistance between the form of the image
bearing member and the blade)

| | | | Propor- |
|---|---|---|---|
| | Number of rotation: | Number of rotation: | tionality |
| | 2,500 | 25,000 | factor f |
| Example 5 | 2 molecules < 10.4 nm < | 2 molecules < 10.2 nm < | 0.0 |
| | 3 molecules | 3 molecules | |
| Example 6 | 2 molecules < 11.5 nm < | 2 molecules < 11.5 nm < | 0.0 |
| | 3 molecules | 3 molecules | |
| Example 7 | 2 molecules < 12.3 nm < | 2 molecules < 9.0 nm < | −0.15 |
| | 3 molecules | 3 molecules | |
| Com- | 3 molecules < 15.3 nm | 3 molecules < 19.0 nm | +0.2 |
| parative | | | |
| Exam- | | | |
| ple 24 | | | |

With regard to the image forming apparatus of Example 1, the surface of the image bearing member is maintained after the durability test to a degree as if the image bearing member were a fresh image bearing member. Therefore, it is evaluated that a high quality circulating surface layer is formed on the image bearing member.

The test described in 3. Image Evaluation is repeated ten times for this image forming apparatus without changing nothing but the image bearing member. After the repeat test, the surface of the image bearing member is observed at the same portion as described above by a confocal microscope. The filming area of the surface of the image bearing member is maintained to be less than 1%. The image forming apparatus of Example 1 can be said to be extremely excellent with regard to the reuse performance.

In Example 2, zinc oleate is used instead of the circulating material of Example 1. The same performance is obtained as Example 1.

In Example 3, α-alumina having a primary particle diameter of 0.5 μm is used to form the sub-surface layer of the image bearing member of Example 1.

The mechanical strength is expected to be improved in comparison with Example 1. Although extremely slight filming is observed for the image bearing member after the durability test, the image bearing member is as if it were a fresh image bearing member.

In Example 4, tin oxide is added to the sub-surface layer of the image bearing member of Example 1. By adding tin oxide, the residual voltage property of the image bearing member can be improved. Also in this case, extremely slight filming is observed for the image bearing member after the durability test but the image bearing member is as if it were a fresh image bearing member.

On the other hand, although the apparatus of Comparative Example 1 has a similar configuration to Example 1, the film deficiency surpasses 10% and rice fish filming is observed on the surface of the image bearing member after the durability test. The image bearing member is clearly different from a fresh image bearing member. To reuse the image bearing member, a renewal processing is necessary for the surface of the image bearing member.

The apparatus of Comparative Example 1 has a similar configuration to Example 1 and known lubricants are applied to the image bearing member. In this case, the cleaning property of the image bearing member and the surface of the image bearing member keep low abrasion property. The thickness of the circulating surface layer of the image bearing member corresponds to three molecular thickness of the circulating material. A great number of sand form particles considered as the circulating material are attached to the surface of the image bearing member after the durability test. To reuse the image bearing member, a renewal processing is necessary for the surface of the image bearing member.

The prescriptions used for the sub-surface layers of the image bearing member of Comparative Examples 3 to 20 are different from that of Example 1. Since the insufficiency of the circulation property of the circulating material is common in those Comparative Examples, the surface stability of the image bearing members is not obtained at a high level. It is difficult to maintain the circulating surface layer by increasing or decreasing the consumption of the circulating material. This is ascribable to the surface form of the sub-surface layer of the image bearing member. Therefore, the conformity (fit-in) of the application blade and the surface is incomplete.

With regard to Comparative Examples 3, 4, 6, 9 to 15, 18, and 21, filming streak is observed on the surface of the image bearing member or filming is observed all over the surface of the image bearing member after the durability test.

There is no correlation between the consumption amount of the circulating material and the amount thereof directly attached to the surface of the image bearing member. Therefore, the circulating material is deduced to fail to fully cover the surface of the image bearing member. To reuse the image bearing member, a renewal processing is necessary for the surface of the image bearing members.

Rice fish form filming is observed on the surface of the image bearing member of Comparative Examples 5, 7, 8, 16, 17, 19, 20, 22, and 23 after the durability test. The mechanism of forming the rice fish form filming is not sufficiently clear but insufficient covering of the surface by the circulating material or incomplete conforming (fitting-in) of the application blade and the surface of the image bearing member is deduced to cause such filming. To reuse these image bearing members, a renewal processing is necessary for the surface of the image bearing members.

With regard to the image forming apparatuses of Examples 7 and 9, the mass layer thickness of the circulating material of the surface of the image bearing member varies little. Therefore, the surface of the image bearing member is sustained as fresh as a fresh image bearing member even after the durability test. Among these, Examples 5 and 6 are excellent. To the contrary, with regard to Comparative Example 24, the mass layer thickness of the circulating material increases as the number of rotations increases.

This possibly causes the modification of the surface of the image bearing member and degradation of the print quality.

What is claimed is:

1. An image forming apparatus comprising:
a rotatable image bearing member comprising an electroconductive substrate on which a photosensitive layer, a sub-surface layer, and a circulating surface layer are sequentially laminated, the image bearing member rotatably driven in a predetermined direction;
a charger to charge a surface of the image bearing member;
an irradiator to irradiate the surface of the image bearing member to form a latent electrostatic image thereon;
a development device to develop the latent electrostatic image with a development agent comprising toner to obtain a toner image;
a transfer device to transfer the toner image from the image bearing member to a transfer medium;
a cleaner to clean the surface of the image bearing member after the toner image is transferred to the recording medium; and
an applicator arranged downstream from the cleaner and upstream from the charger relative to a rotation driving direction of the image bearing member and in contact with the image bearing member, the applicator comprising a circulating material, an application brush, and an application blade to apply the circulating material to form the circulating surface layer thereof,
wherein the circulating surface layer of the circulating material has a mass layer thickness of from one molecule to less than three molecules with a film deficiency of the circulating material of less than 10%, and
wherein an application amount of the circulating material by the applicator per cycle of image forming in the image forming apparatus is equal to or less than a removal amount of the circulating material removed from the surface of the image bearing member by the time applicator begins to apply the circulating material in a following image forming.

2. The image forming apparatus according to claim 1, wherein the sub-surface layer of the image bearing member has no folding point in a bandwidth of from LLL to LHL and a folding point in a bandwidth of from LHL to HMH in a curve obtained by:
(I) forming a single dimension data arrangement by measuring the sub-surface layer by a surface texture and contour measuring instrument; (II) conducting a wavelet conversion by multi-resolution analysis for the single dimension data arrangement to make separation into six frequency components from a high frequency component to a low frequency component; (III) thinning out the lowest frequency component among the six frequency components in such a manner that the number of a single dimension data arrangement for the lowest frequency component is reduced to 1/10 to 1/100 to obtain a single dimension data arrangement; (IV) furthermore conducting a wavelet conversion by multi-resolution analysis to make separation into additional six frequency components from a high frequency component to a low frequency component; and (V) linking logarithms of eleven arithmetical mean roughnesses of from WRa (LLL) to WRa (HHH) excluding WRa (HLL) of the frequency components obtained in (II) and (IV), and WRa (LLH) is less than 0.04 μm, and WRa (HLH) is less than 0.005 μm,
where the arithmetical mean roughnesses of the frequency components are:
WRa (HHH): Ra in a bandwidth having a cycle length of convexoconcave of from 0.3 μm to 3 μm,
WRa (HHL): Ra in a bandwidth having a cycle length of convexoconcave of from 1 μm to 6 μm,
WRa (HMH): Ra in a bandwidth having a cycle length of convexoconcave of from 2 μm to 13 μm,
WRa (HML): Ra in a bandwidth having a cycle length of convexoconcave of from 4 μm to 25 μm,
WRa (HLH): Ra in a bandwidth having a cycle length of convexoconcave of from 10 μm to 50 μm,
WRa (HLL): Ra in a bandwidth having a cycle length of convexoconcave of from 24 μm to 99 μm,
WRa (LHH): Ra in a bandwidth having a cycle length of convexoconcave of from 26 μm to 106 μm,
WRa (LHL): Ra in a bandwidth having a cycle length of convexoconcave of from 53 μm to 183 μm,
WRa (LMH): Ra in a bandwidth having a cycle length of convexoconcave of from 106 μm to 318 μm,
WRa (LML): Ra in a bandwidth having a cycle length of convexoconcave of from 214 μm to 551 μm,
WRa (LLH): Ra in a bandwidth having a cycle length of convexoconcave of from 431 μm to 954 μm, and
WRa (LLL): Ra in a bandwidth having a cycle length of convexoconcave of from 867 μm to 1,654 μm.

3. The image forming apparatus according to claim 2, wherein the sub-surface layer comprises a resin having a three dimensional cross-linking structure.

4. The image forming apparatus according to claim 2, wherein the sub-surface layer comprises α-alumina having an average primary particle diameter of from 0.2 μm to 0.5 μm.

5. The image forming apparatus according to claim 1, wherein the circulating surface layer comprises a compound having a lamellar structure.

6. The image forming apparatus according to claim 1, wherein the circulating surface layer comprises zinc stearate.

7. The image forming apparatus according to claim 1, wherein the mass layer thicknesses obtained when the circulating material is applied to the image bearing member 2,500 times and 25,000 times and the number of application times of the circulating material satisfy the following relationship 1:
τ=fα+β Relationship 1
where τ represents the mass layer thickness (nm) of the circulating material, α represents the number of application times of the circulating material, β is an arbitrary constant, and f is a proportionality factor of from −0.1 to 0.

8. An image forming method comprising:
charging a surface of an image bearing member comprising an electroconductive substrate on which a photosensitive layer, a sub-surface layer, and a circulating surface layer are sequentially laminated;
irradiating the surface of the image bearing member with light to form a latent electrostatic image thereon;
developing the latent electrostatic image with a development agent comprising toner to obtain a toner image;
transferring the toner image from the image bearing member to a transfer medium;
cleaning the surface of the image bearing member after the toner image is transferred to the transfer medium; and
applying a circulating material to the surface of the image bearing member after the step of cleaning and before the step of charging to form a circulating surface layer of the circulating material thereon having a mass layer thickness of from a thickness corresponding to one molecule to a thickness corresponding to less than three molecules with a film deficiency of the circulating material of less than 10%, using an applicator comprising the circulating material, an application brush, and an application blade while in contact with the surface of the image bearing member,
wherein an application amount of the circulating material per cycle of image forming in the image forming apparatus is equal to or less than the removal amount of the circulating material removed from the surface of the image bearing member by the time the applicator begins to apply the circulating material in a following image forming.

9. The image forming method according to claim 8, wherein the sub-surface layer of the image bearing member has no folding point in a bandwidth of from LLL to LHL and a folding point in a bandwidth of from LHL to HMH in a curve obtained by:
(I) forming a single dimension data arrangement by measuring the sub-surface layer by a surface texture and contour measuring instrument;
(II) conducting a wavelet conversion by multi-resolution analysis for the single dimension data arrangement to make separation into six frequency components from a high frequency component to a low frequency component;
(III) thinning out the lowest frequency component among the six frequency components in such a manner that the number of a single dimension data arrangement for the lowest frequency component is reduced to 1/10 to 1/100 to obtain a single dimension data arrangement;
(IV) furthermore conducting a wavelet conversion by multi-resolution analysis to make separation into additional six frequency components from a high frequency component to a low frequency component; and
(V) linking logarithms of eleven arithmetical mean roughnesses of from WRa (LLL) to WRa (HHH) excluding WRa (HLL) of the frequency components obtained in (II) and (IV), and WRa (LLH) is less than 0.04 μm, and WRa (HLH) is less than 0.005 μm,
where the arithmetical mean roughnesses of the frequency components are:
WRa (HHH): Ra in a bandwidth having a cycle length of convexoconcave of from 0.3 μm to 3 μm,
WRa (HHL): Ra in a bandwidth having a cycle length of convexoconcave of from 1 μm to 6 μm,
WRa (HMH): Ra in a bandwidth having a cycle length of convexoconcave of from 2 μm to 13 μm,
WRa (HML): Ra in a bandwidth having a cycle length of convexoconcave of from 4 μm to 25 μm,
WRa (HLH): Ra in a bandwidth having a cycle length of convexoconcave of from 10 μm to 50 μm,
WRa (HLL): Ra in a bandwidth having a cycle length of convexoconcave of from 24 μm to 99 μm,
WRa (LHH): Ra in a bandwidth having a cycle length of convexoconcave of from 26 μm to 106 μm,
WRa (LHL): Ra in a bandwidth having a cycle length of convexoconcave of from 53 μm to 183 μm,
WRa (LMH): Ra in a bandwidth having a cycle length of convexoconcave of from 106 μm to 318 μm,
WRa (LML): Ra in a bandwidth having a cycle length of convexoconcave of from 214 μm to 551 μm,
WRa (LLH): Ra in a bandwidth having a cycle length of convexoconcave of from 431 μm to 954 μm, and
WRa (LLL): Ra in a bandwidth having a cycle length of convexoconcave of from 867 μm to 1,654 μm.

10. The image forming method according to claim 9, wherein the sub-surface layer comprises a resin having a three dimensional cross-linking structure.

11. The image forming method according to claim 9, wherein the sub-surface layer comprises α-alumina having an average primary particle diameter of from 0.2 μm to 0.5 μm.

12. The image forming method according to claim 8, wherein the circulating surface layer comprises a compound having a lamellar structure.

13. The image forming method according to claim 8, wherein the circulating surface layer comprises zinc stearate.
